(19) United States
(12) Patent Application Publication
(10) Pub. No.: US 2006/0259390 A1
(43) Pub. Date: Nov. 16, 2006

(54) Multiple account preset parameter method, apparatus and systems for financial transactions and accounts

(76) Inventor: Ronald J. Rosenberger, Newtown, PA (US)

Correspondence Address: RONALD ROSENBERGER, 506 STERLING ST., NEWTOWN, PA, 18940, US

(21) Appl. No.: 11/487,680

(22) Filed: Jul. 17, 2006

Related U.S. Application Data
(63) Continuation-in-part of application No. 10/865,188, filed on Jun. 10, 2004.
(60) Provisional application No. 60/480,022, filed on Jun. 19, 2003.
(60) Provisional application No. 60/700,602, filed on Jul. 19, 2005.
(60) Provisional application No. 60/752,119, filed on Dec. 20, 2005.
(60) Provisional application No. 60/811,977, filed on Jun. 8, 2006.

(51) Int. Cl. G06Q 40/00

(52) U.S. Cl. 705/35; 705/39

(57) ABSTRACT

Methods, apparatus and systems are provided that enables at least one debit for a financial transaction and account management features using at least two financial accounts from which such debits and/or credits can be made from said at least two financial accounts using preset financial account parameters including, but not limited to, at least one ratio, an amount threshold, a remainder threshold, a minimum available account balance, a maximum available account balance, a minimum debit amount, a range of debit amounts, a maximum debit amount, a qualitative or quantitative aspect of at least one said financial accounts, or any combination thereof, and/or other parameters, such as, but not limited to at least one threshold amount and/or remainder amount. The transaction processor also allows account debiting or account crediting parameters to be set in accordance to any merchant identifier information, and permits account balances used for a given transaction to be readjusted after said transaction has been posted. A smart card or personal identification systems embodiment of the transaction processor comprising certain capabilities of the global financial card account embodiment is also provided.

### CROSS REFERENCE TO RELATED APPLICATION

This application is a continuation-in-part of Non-Provisional application Ser. No. 10/865,188, filed Jun. 10, 2004, which is entirely incorporated herein by reference. This application claims priority to each of U.S. Provisional Patent Application Ser. No. 60/480,022, filed Jun. 19, 2003; U.S. Non-Provisional application Ser. No. 10/865,188, filed Jun. 10, 2004; U.S. Provisional Patent Application Ser. No. 60/700,602, filed Jul. 19, 2005; U.S. Provisional Patent Application Ser. No. 60/752,119, filed Dec. 20, 2005; and U.S. Provisional Patent Application Ser. No. 60/811,977, filed Jun. 8, 2006, each of which is entirely incorporated herein by reference.

### FIELD OF THE INVENTION

This invention relates to multiple account debit methods, apparatus and systems for transactions and transaction processors for providing debits and/or credits from multiple accounts according to pre-determined parameters.

### BACKGROUND OF THE INVENTION

Imagine being at a store. Your purchases took longer to gather than you had originally anticipated, and you glide your loaded shopping cart up to a relatively short line at a checkout lane to pay for your purchases. You're in a hurry. The customer at the front of the checkout line just had a raft of purchases rung up, and swipes his debit card. His transaction is rejected. He tries again. Rejected again. He goes fishing in his wallet for his credit card, then recalls out loud that he loaned the credit card to his son the day before, and never got it back. He looks in his wallet for cash, and sees that he only has enough cash for about half of the purchases that were rung up. You're running late. He is busy having the clerk scan items to remove them from his transaction total. You're getting steamed. He realizes that he does have enough money to buy the shaving cream after all, and wants the shaving cream added back in to the transaction total. The clerk is stressed. The customer finally notices the tension all around him. He apologizes to everybody within an eight-foot radius. You're turning red. The store manager happens by to see what all the fuss is about. The customer is embarrassed. You realize that the lines at the other checkout lanes have since gotten longer. You're in a hurry. You're late. You're steamed. You're red. You then yank your loaded shopping cart out of line, strand it in the middle of an aisle, and check your watch half dozen times as you tear out of the store until you leap into your car, grind your transmission from Reverse to Drive, and swerve out of the parking lot, just barely missing the kid riding the bike.

Separate credit card accounts and debit card accounts are well known in the art. Many are single account balance cards that are unusable should the singular account balance become depleted. Some cards access two accounts, such as a credit card account, and a debit card account; however, should the one account chosen to be used be inadequate, the card has to be swiped again, with everybody, from the cashier to the other customers in line at the point-of-sale, bearing witness that the end user was rejected. With regard to credit cards, end users that exceed their credit limit are exposed to varied humiliations, such as rejection of a given point-of-sale transaction, steep credit card over-the-limit fees, etc., whereas with debit cards, end users that exceed their available cash balance for a given point-of-sale transaction are merely rejected . . . in front of everybody.

Prior single balance cards attempted to addressed such issues in the field of credit cards by using an interest bearing cash account that acts as collateral for an overdrawn condition of the credit card account, where the overdrawn condition is remedied by automatically transferring cash from the interest bearing cash account to the credit card account in an amount which is sufficient to reduce the transaction balance below the credit limit at the end of the billing cycle. The interest bearing cash account itself is not used as a demand account for a given transaction, which would be prohibited under Title 12, Part 329, of the Code of Federal Regulations (C.F.R.) that specifies: No bank shall, directly or indirectly, by any device whatsoever, pay interest on any demand deposit (12 C.F.R. section 329.2). Credit card and debit card accounts comprise typical demand accounts that enable purchases to occur at a point of sale; furthermore, the available cash contained in a typical debit card account comprises a demand deposit. As a result, such interest bearing cash accounts are not and cannot be used by themselves as a demand account for transactions.

It is important to note that various known components can be used to transact a purchase at a point-of-sale. The first is an on line transaction using a PIN (personal identification number), which the end user enters on a PIN pad at the point-of-sale. On-line refers to transactions such as those that can optionally use the ACH (automated clearing house) system network or an EFT (electronic fund transfer) system network, or any other suitable and known method. ACH and/or EFT transactions occur in real-time, meaning that the actual funds comprising the end user's available cash balance are debited at the time of a purchase transaction using ACH and/or EFT systems, with the same being true for ATM withdrawals that use of varied EFT system networks. The PIN number represents the end user's way of entering and making use of the varied EFT system networks. PIN numbers are used for approximately 40% of all debit card transactions, and for ATM (automated teller machine) withdrawals. Pin pads are found at only about 25% of merchant locations; however, the trend is for that number to increase being that PIN-based transactions are relatively cheap for the merchant to engage in.

Another way to transact a purchase at a point-of-sale is via a signature based off-line transaction. Such off-line transactions are done on proprietary networks. For example, VISA and MasterCard share a proprietary network, while American Express and Discover Card each have the own proprietary network; furthermore, there is nothing to stop any other well-heeled entities from establishing their own proprietary networks. In these off-line transactions, the end user signs for the transaction without using a PIN. These signature-based transactions are not only used for credit card transactions; VISA and MasterCard have signature based debit cards that are used in approximately 60% of all point-of-sale debit card transactions. During the authorization process in an off line transaction, in the event of an accepted transaction (where the transaction authorization request has not been rejected), the available account balance is frozen or reduced by the amount of the authorized transaction, even though the actual funds are not deployed until the transaction is posted. In certain cases, the transaction date and the posting date of an off-line transaction are different, with the capabilities and activities of the particular transacting merchant being the main factor accounting for the difference. Signature-based transactions require that merchants pay higher fees, which are a percentage of the transaction, versus lower fees that are typical of PIN-based transactions; as a result, signature-based transactions are more costly for merchants to engage in than PIN-based transactions.

### SUMMARY OF THE INVENTION

The present invention provides multiple account, single or multiple parameter methods, systems, apparatus, transaction cards, and the like for use in providing at least one point of sale or financial transaction via access to at least two available financial accounts that can be debited by parameters relating the amount of the debit to the relative balances available in the at least two available financial accounts. The preset parameter(s) and access to at least two financial accounts for at least one point of sale transaction and to provide solutions related to the problem of accessing and managing debit funds for a point of sale transaction without having to go through the delay and difficulties of having specific accounts have insufficient funds for such debits, as well as for providing automatic, preset access instructions for the at least two financial accounts. The present invention further provides automatic, preset or real time adjustment to the balances, credit lines and/or one or more parameters, including different billings cycles and transfers, relating to such at least two financial accounts. Such access and preset parameter(s) allow the financial account user to have automatic access, without the problems associated with the possibility of insufficient accounts or with having to figure out at the time of the point of sale, whether minimum balances or other aspects of the financial account remaining balances are being maintained after the debit is made for the point of sale transaction.

Accordingly, the present invention provides various utilities to the financial account holder, including, but not limited to, being able to access multiple accounts for debiting funds use for a point of sale transaction at a store or other product or service provider, such as internet, telephone, satellite, intranet, and the like.

The present invention further provides the utility of being able to manage financial accounts through preset parameters that can be used to provide, adjust and/or maintain various aspects of the at least two financial accounts, before and after various debit or other financial transactions using such financial accounts, such as, but not limited to, minimum balances, relative balances, debiting using ratios, ranges or relative aspects of the account balances, time related parameters, and other aspects that would be known to one skilled in the relevant arts, e.g., but not limited to finance, banking, business, and the like.

The present invention thus provides at least one multiple account, multiple parameter, method for executing a financial transaction at a point of sale using preset parameters for transferring funds from at least two separate accounts, comprising (a) providing a global financial account comprising at least two financial accounts that can be accessed for debiting of funds for at least one point of sale transaction; and (b) providing a system that supports an external debit from the global financial account, for a point-of-sale transaction, one or more debit amounts from the at least two financial accounts using at least one preset debit amount parameter selected from any a qualitative or quantitative aspect of at least one said financial accounts. Non-limiting examples of such qualitative or quantitative aspects include, but are not limited to, at least one of a ratio, an amount threshold, a remainder threshold, a minimum available account balance, a maximum available account balance, a minimum debit amount, a range of debit amounts, a maximum debit amount, a qualitative or quantitative aspect of at least one said financial accounts, or any combination thereof. The present invention further provides such a method wherein the debiting step is conducted using a transaction card, optionally where the transaction card is a smart card. The present invention also provides such a method wherein the debiting step is conducted using a personal identification system, optionally wherein the personal identification system is selected from or comprises at least one selected from fingerprint, retinal scan, DNA testing, picture recognition, a personal identification number, code or alpha numeric (PIN), or any other known methods, such as, but not limited to biometrics, to voice recognition, radio related protocols used in wands at a point-of-sale (Exxon/Mobile), E-Z Pass, and similar technologies being adapted for cell phones.

One benefit of the present invention is to provide the end user with more options and greater flexibility regarding transactions using at least two available account balances. With a single card swipe, it is possible for an end user to make use of at least two available account balances according to parameters the end user has selected, where the available account balances are coordinated and debited in ways that are hitherto unknown. Also, with a single card swipe, it is possible for a depleted account balance to automatically yield to another available account balance so seamlessly that the depleted account balance condition is absolutely invisible to the varied parties in a public point-of-sale environment, including the end user, thus eliminating varied point-of-sale embarrassments such as having a depleted available account balance reject the transaction, having to swipe the card again to access another account, having to hunt for another card to swipe, etc.

The present invention can be adapted to function both in PIN-based environments, and signature-based environments. Furthermore, it should be understood that the present invention can be adapted to function in environments that use any other system component of security/verification and/or system routing other than PIN-based or signature based environments. For example, it is only a matter of time before retinal scanning, fingerprints, and/or other unique cardholder physical system component are used in a transaction environment, where such system component are employed as a security measure in conjunction with financial cards, much in the same way a PIN, signature, or electronic signature is presently used in conjunction with financial cards. Furthermore, it is possible that someday a retinal scan, fingerprint, and/or other unique cardholder physical system component is used in place of an actual financial card to access a global account. The present invention is meant to be able to work using currently known networks, such as ACH and/or EFT networks, or the varied proprietary card networks, or with any future network. Networks using the Internet, such as CyberCash will no doubt become more and more prevalent as well, especially as security for transactions improve. In any event, the present invention is intended to specifically address how at least two accounts are linked, rather than disclosing limitations that, for example, the overall embodiment can only be PIN-based, signature-based, Internet-based, retinal-based, fingerprint-based, etc.

One aspect of the invention is the use of at least one transaction processor. The transaction processor links together and controls at least two available account balances, and enables parameters to be preset, selected and/or modified with regard to how a given transaction is debited among the at least two available account balances via an interface. The transaction processor facilitates the following:

The transaction processor enables any combination of in-house, or out-of-house available balances to be used.

The transaction processor enables a given transaction to be divided during the transaction among any of the two or more available account balances in accordance with at least one preset ratio.

The transaction processor enables a given transaction to be sorted among any of the two or more available account balances in accordance to at least one preset threshold amount, where transactions up to a specified amount are debited from one available account balance, or from more than one available account balance using any preset ratio, and transactions above the specified amount are debited from a different available account balance, or from more than one available account balance using any preset ratio, with the possibility of employing additional preset threshold or range amounts using any available account balances and/or preset ratios.

The transaction processor enables functions with relation to debiting accounts using remainder amount criteria, split transaction criteria, minimum transaction parameters, various maximum parameters, or criteria based on any merchant identification information.

The transaction processor enables an end user the option to have the transaction processor allow a transaction based on the total of the available account balances, where the transaction processor then debits among the at least two available balances according to set parameters, and compensates for any deficient available account balance(s) using Best Fit criteria that uses at least one other additional available account balance to complete the account debiting.

The transaction processor enables Rescue or Reject criteria that allows an end user the option either to have the transaction processor rescue a given transaction in the event that a specified available account balance is depleted by using at least one other available account balance to complete the transaction; or, to have the transaction processor reject the given transaction in the event of a depleted available account balance.

The transaction processor enables an end user the option to disengage a given available account balance.

The transaction processor enables an end user to readjust or revise how a given transaction or transaction amount is debited among the at least two available account balances after a consummated transaction is posted, either by readjusting global parameters, or by revising actual amounts.

The transaction processor can be realized in two distinct and separate embodiments. The first embodiment is where the transaction processor resides in a global financial account for a given end user, where the global financial account comprises at least two available account balances belonging to the end user. In this case, standard financial cards may be used for transactions, because the ratio and threshold calculations/operations take place within the global financial account, and not from any point-of-sale location.

The second embodiment is where the transaction processor performing the ratio and threshold calculations/operations resides in the microprocessor on an actual smart data card, and the calculations/operations take place within the smart data card at the actual point-of-sale location. While the smart data card embodiment does not have all of the features and capabilities of the global financial account embodiment, it is provided nonetheless given the level of interest and attention that smart data cards have garnered in recent years. Either embodiment presents a new realm of flexibility and versatility for the end user.

The present invention provides in one aspect a method for executing at least one debit for at least point-of-sale financial transaction using at least one preset transaction parameter relating the debit amount of the debit to the relative account balances in at least two separate financial accounts, comprising: (a) providing at least two financial accounts comprising at least two available balances that can be accessed for the debit for the at least one point-of-sale transaction; and (b) debiting the debit amount for the at least point-of-sale transaction from the at least one of the account balances based on at least one of the preset transaction parameters relating the debit amount to the amounts or ratios of each of the account balances in at least two of the available account balances, wherein the preset transaction parameter is at least one selected from a ratio, an amount threshold, a remainder threshold, a minimum available account balance, a maximum available account balance, a minimum debit amount, a range of debit amounts, a maximum debit amount, or any combination thereof.

Such a method is also provided wherein the debit is conducted using a transaction card, e.g., wherein the transaction card is a magnetic stripe card, a smart card, or a personal identification system, e.g., a personal identification number or code (PIN), an electronic signature, a biometric or voice identifier (e.g., but not limited to, a fingerprint, a retinal scan, a DNA test, or face or feature recognition, or any other known feature or method, such as, but not limited to additional biometrics, voice recognition, or any known radio related protocol, e.g., as used in wands at a point-of-sale (e.g., but not limited to, Exxon/Mobile), or other electronic identification/debit or credit account transmitter (e.g., but not limited to, E-Z Pass), and similar technologies, including those being adapted for cell phones.

The present invention also provides a method for executing at least one debit for at least one point-of-sale financial transaction using at least one preset transaction parameter relating the debit amount to the relative account balances in at least two financial accounts, comprising: (a) maintaining the at least two financial accounts comprising at least two available account balances that can be debited remotely via a transaction processor according to at least one preset transaction parameter that relates the debit amount to the relative balances in at least two of the available account balances; (b) processing a request for authorization of the transaction amount against the at least two available account balances, in exchange for goods or services, wherein the transaction amount requested is authorized when at least one selected from (i) the total of the at least two available account balances is greater than or equal to the debit amount; (ii) at least one selected available account balance, as determined by the transaction processor, is greater than or equal to the assigned portion of the debit amount corresponding to the at least one selected available account balance; or (iii) at least one selected available account balance, as determined by the transaction processor, is able to compensate for a deficiency in at least one other selected available account balance that is less than the assigned portion of the debit amount corresponding to the at least one selected available account balance using Rescue or Reject criteria, where the assigned portion is determined by the transaction processor; and wherein the transaction amount is debited from or credited to the at least one available account balances by at least one selected from (i) according to the assigned portion determined by the transaction processor, (ii) according to at least one Best Fit criteria; (iii) according to the assigned portion; and (iv) according to Rescue or Reject criteria.

Such a method can optionally further comprise where the available account balances are accessed from at least one point-of-sale via at least one of an automated clearing house (ACH) network, electronic funds transfer network (EFT), a proprietary network other than an ACH and/or EFT network, or via the Internet.

Such a methods can optionally further comprise where the at least two available account balances comprise at least one of one or more of (i) available in-house cash balances and/or available in-house credit balances, (ii) available out-of-house cash balances and/or available out-of-house credit balances in addition to the available in-house cash balances and/or the available in-house credit balances, (iii) available out-of-house cash balances and/or available out-of-house credit balances.

Such a methods can optionally further comprise where at least one of the at least two available account balances comprise its own account number that enables access via a credit card, debit card, ATM card, draft, and the like, where the account number is distinct from the account number(s) used to access the global account.

Such a methods can optionally further comprise where the available account balances allow a given end user of the account benefits and reward programs that are available to financial card accounts.

The present invention further provides a system for at least one debit for at least point-of-sale financial transaction using at least one preset transaction parameter relating the debit amount to the relative account balances in at least two financial accounts, comprising: (a) a system component for maintaining the at least two financial accounts comprising at least two available account balances that can be debited remotely via a transaction processor according to at least one preset transaction parameter that relates the debit amount to the relative balances in at least two of the available account balances; (b) a system component for processing a request for authorization of the transaction amount against the at least two available account balances, in exchange for goods or services, wherein the transaction amount requested is authorized when at least one selected from (i) the total of the at least two available account balances is greater than or equal to the debit amount; (ii) at least one selected available account balance, as determined by the transaction processor, is greater than or equal to the assigned portion of the debit amount corresponding to the at least one selected available account balance; or (iii) at least one selected available account balance, as determined by the transaction processor, is able to compensate for a deficiency in at least one other selected available account balance that is less than the assigned portion of the debit amount corresponding to the at least one selected available account balance using Rescue or Reject criteria, where the assigned portion is determined by the transaction processor; and wherein the transaction amount is debited or credited from the at least one available account balances by at least one selected from (i) according to the assigned portion determined by the transaction processor (ii) according to at least one Best Fit criteria; (iii) according to the assigned portion; and (iv) according to Rescue or Reject criteria.

Such a system optionally further comprises including where the at least one two available account balances are accessed from a point-of-sale via at least one selected from an ACH and/or EFT network, any proprietary network other than at least one ACH and/or EFT network, or via the Internet.

Such a system optionally further comprises where the at least two available account balances comprises (i) one or more of available in-house cash balances and/or available in-house credit balances; (ii) one or more of available out-of-house cash balances and/or available out-of-house credit balances in addition to the available in-house cash balances or the available in-house credit balances, or (iii) one or more of available out-of-house cash balances and/or available out-of-house credit balances.

Such a system optionally further comprises where at least one of the available account balances comprising the at least two available account balances has its own account number that enables access via a credit card, debit card, ATM card, draft, and the like, where the account number is distinct from the account number(s) used to access the global account. Such a system optionally further comprises where the at least one two available account balances allow a given end user account benefits and reward programs provided by financial card accounts.

The present invention further provides an apparatus comprising a transaction processor that links together and controls at least two available account balances that enable preset transaction parameters to be selected or modified with regard to how a given transaction is debited among at least two available account balances, where the parameters comprise at least one ratio, and where the transaction processor allows file maintenance functions to be performed, where the parameters can be selected or modified, and the file maintenance functions are performed using an interface. Such an apparatus can optionally further comprise where the parameters comprise at least one selected from at least one amount threshold or at least one remainder threshold. Such an apparatus can optionally further comprise where the parameters enable the end user to allow split transactions in a depleted account condition. Such an apparatus can optionally further comprise where the transaction processor enables the end user or the card entity to make changes or modifications to the parameters via the interface using any communicative system component, format, or technology, from any location, wherein the interface comprises any communicative system component, format, or technology. Such an apparatus can optionally further comprise where the transaction processor comprises a special instructions file comprising where specific account debiting parameters are associated with any system component or type of merchant identifier information, or any merchant identifier information contained in the merchant identifier text string. Such an apparatus can optionally further comprise where the special instructions file enables state codes or country codes contained in the merchant identifier information to be set up with specific account debiting parameters. Such an apparatus can optionally further comprise where the parameters enable at least one given available account balance to be disengaged. Such an apparatus can optionally further comprise where the parameters enable minimum available balance parameters to be set. Such an apparatus can optionally further comprise where the parameters enable minimum or maximum allowable transaction amounts to be set.

Such an apparatus can optionally further comprise where the parameters enable limits to be set on the maximum total debiting of the at least two available account balances over any specified timeframe. Such an apparatus can optionally further comprise where the parameters enable account-debiting parameters to be adjusted according to specified timeframes. Such an apparatus can optionally further comprise where the parameters enable limits to be set on the maximum allowable available account balance usage for at least one available account balance comprising the at least two accounts over any specified timeframe; wherein the parameters comprise Best Fit or Rescue and Reject capabilities to deal with any transaction(s) that conflict with the maximum allowable available account balance usage. Such an apparatus can optionally further comprise where the transaction processor enables a transfer of payment amounts from any available cash balance(s) to make any payment(s) due on transaction amounts charged against any available credit balance(s), comprising where the transfer of the payment amounts are set to occur automatically, or where the end user expedites each the transfer individually. Such an apparatus can optionally further comprise where the transaction processor sends E-mail when the available account balances are used. Such an apparatus can optionally further comprise where the transaction processor enables separate parameters for cash withdrawals. Such an apparatus can optionally further comprise where the transaction processor enables separate parameters for check clearance. Such an apparatus can optionally further comprise where the at least two available account balances comprises an available cash account specifically for cash withdrawals. Such an apparatus can optionally further comprise where the at least two available account balances comprises an available cash account specifically for check clearance. Such an apparatus can optionally further comprise where the file maintenance functions enable readjustment or revision with regard to how the given transaction is debited among the at least two available account balances on a post real-time basis after a transaction is posted or otherwise consummated, either by readjusting global parameters, or by revising actual amounts. Such an apparatus can optionally further comprise where the transaction processor records transaction debiting parameters in order to properly credit returned purchases.

Such an apparatus can optionally further comprise where the interface comprises any format or technology, comprising where the interface may be used directly by the end user, or on behalf of the end user, and comprising where access to the interface comprises any format or technology. Such an apparatus can optionally further comprise where the traction comprises the use of a financial card. Such an apparatus can optionally further comprise where the transaction comprises at least one selected from a cash withdrawal, a draft, an electronic or wire payment. Such an apparatus can optionally further comprise where the transaction processor sets up electronic and wire payment instructions so that a given set of the electronic and wire payment instructions has its own set of available balance debiting parameters with regard to ratio, threshold, remainder threshold, etc.

The present invention further provides a method where a checking account provider enables an end user to receive free or reduced fee checking services based on the amount of off-line interchange fee generating activity, where if the end user performs a specified amount total or number of transactions within a specified period using at least one available credit or available cash balance, where the transactions comprise system component that generate interchange fee revenue, then the end user will receive the free or reduced fee checking services. Such a method can optionally further comprise where the checking account provider enables the end user to receive the free or reduced fee checking services based on the amount of on-line transaction fee generating activity, either in addition to, or in place of, the off-line interchange fee generating activity, where if the end user performs a specified amount total or number of transactions within a specified period using at least one available credit or available cash balance, where the transactions comprise system component that generate transaction fee revenue, then the end user will receive the free or reduced fee checking services.

The present invention further provides an apparatus comprising a transaction processor that resides on a smart data card that links together and controls at least two available account balances, where the smart data card enables a given transaction to be debited from the at least two available account balances from a point-of-sale terminal according to parameters, where the parameters comprise at least one ratio, and where the parameters can be selected or modified using a smart data card interface, and where the at least two available account balances comprises any combination of in-house or out-of-house available account balances. Such an apparatus can optionally further comprise where the parameters comprise at least one amount threshold or at least one remainder threshold. Such an apparatus can optionally further comprise where the parameters enable at least one given available account balance to be disengaged, minimum available balance parameters to be set, minimum or maximum allowable transaction amounts to be set, or Best Fit or Rescue or Reject criteria to be used. Such an apparatus can optionally further comprise where the smart data card interface is part of, is at the site of, or is away from the site of the point-of-sale terminal.

Debit from Preselected Parameter Relating to at Least Two Financial Accounts

The invention provides, in one aspect, a method for executing at least one debit for at least one financial transaction using at least one transaction parameter for relating the debit amount of said debit to the relative account balances in at least two financial accounts, comprising: providing at least two financial accounts comprising at least two available account balances that can be accessed for said debit for said at least one financial transaction; and debiting said debit amount for said at least one financial transaction from said at least one of said account balances based on at least one of said transaction parameters relating said debit amount to the amounts or ratios of each of said account balances in at least two of said available account balances.

The invention further provides a method wherein said transaction parameter is selected from at least one of a ratio, an amount threshold, a remainder threshold, a minimum available account balance, a maximum available account balance, a minimum debit amount, a range of debit amounts, or a maximum debit amount. The invention further provides wherein said debit for said financial transaction on said at least one transaction parameter is based on at least one selected from:
(a) the total of said at least two available account balances is greater than or equal to said debit amount;
(b) at least one selected available account balance is greater than or equal to said assigned portion of said debit amount corresponding to said at least one selected available account balance; or
(c) at least one selected available account balance, as determined by said transaction processor, that is able to compensate for a deficiency in at least one other selected available account balance that is less than the assigned portion of said debit amount corresponding to said at least one selected available account balance, where said assigned portion is determined by said transaction processor.

The invention provides an aspect further comprising where said available account balance is accessed from a point-of-sale via at least one automated financial network. The invention provides an aspect wherein said available account balance is accessed from a point-of-sale via a proprietary network or ACH and/or EFT network. The invention provides an aspect further comprising where said available account balance is accessed from a point-of-sale via the Internet. The invention provides an aspect further comprising where said at least two available account balances are selected from at least one available in-house cash balance and/or at least one available in-house credit balance. The invention provides an aspect further comprising where said at least two available account balances are selected from at least one available out-of-house cash balances and/or available out-of-house credit balances in addition to at least one available in-house cash balances and/or the available in-house credit balances. The invention provides an aspect further comprising where said at least two available account balances are selected from at least one available out-of-house cash balance and/or at least one available out-of-house credit balance. The invention provides an aspect further comprising where said at least one of the available account balances is accessible via an account number selected from at least one of a credit card, a debit card, an ATM card, an financial services account, a bank account, a credit account, where said account number is distinct from the account number(s) used to access said global account. The invention provides an aspect further comprising where said available account balances allow a given end user of said account benefits and reward programs that are available to financial card accounts.

The invention provides an aspect wherein said benefits and rewards programs are selected from at least one of cash back or interest earned. The invention provides an aspect wherein said debit is conducted using a transaction card, a smart card, or a magnetic strip card. The invention provides an aspect wherein said preset transaction parameter is a time period or a later billing cycle. The invention provides an aspect wherein said transaction parameter is at least one selected from at least one of a ratio, an amount threshold, a remainder threshold, a minimum available account balance, a maximum available account balance, a minimum debit amount, a range of debit amounts, or a maximum debit amount. The invention provides an aspect wherein said debit is conducted using a personal identification system. The invention provides an aspect wherein said personal identification system comprises at least one selected from at least one of personal identification number (PIN), a signature, an electronic signature, a fingerprint, a retinal scan, a DNA test, voice recognition, and face or feature recognition.

The invention further provides a system for executing at least one debit for at least one financial transaction using at least one transaction parameter for relating the debit amount of said debit to the relative account balances in at least two financial accounts, comprising:
(a) a system component for providing at least two financial accounts comprising at least two available account balances that can be accessed for said debit for said at least one financial transaction; and
(b) a system component for debiting said debit amount for said at least one financial transaction from said at least one of said account balances based on at least one of said transaction parameters relating said debit amount to the amounts or ratios of each of said account balances in at least two of said available account balances.

The invention provides an aspect wherein said transaction parameter is selected from at least one of a ratio, an amount threshold, a remainder threshold, a minimum available account balance, a maximum available account balance, a minimum debit amount, a range of debit amounts, or a maximum debit amount. The invention provides an aspect wherein said debit for said financial transaction on said at least one transaction parameter is based on at least one selected from: the total of said at least two available account balances is greater than or equal to said debit amount; at least one selected available account balance is greater than or equal to said assigned portion of said debit amount corresponding to said at least one selected available account balance; or at least one selected available account balance, as determined by said transaction processor, that is able to compensate for a deficiency in at least one other selected available account balance that is less than the assigned portion of said debit amount corresponding to said at least one selected available account balance, where said assigned portion is determined by said transaction processor. The invention provides an aspect further comprising where said available account balance is accessed from a point-of-sale via at least one automated financial network. The invention provides an aspect wherein said available account balance is accessed from a point-of-sale via a proprietary network or ACH and/or EFT network. The invention provides an aspect further comprising where said available account balance is accessed from a point-of-sale via the Internet. The invention provides an aspect further comprising where said at least two available account balances are selected from at least one available in-house cash balance and/or at least one available in-house credit balance. The invention provides an aspect further comprising where said at least two available account balances are selected from at least one available out-of-house cash balances and/or available out-of-house credit balances in addition to at least one available in-house cash balances and/or the available in-house credit balances. The invention provides an aspect further comprising where said at least two available account balances are selected from at least one available out-of-house cash balance and/or at least one available out-of-house credit balance. The invention provides an aspect further comprising where said at least one of the available account balances is accessible via an account number selected from at least one of a credit card, a debit card, an ATM card, an financial services account, a bank account, a credit account, where said account number is distinct from the account number(s) used to access said global account. The invention provides an aspect further comprising where said available account balances allow a given end user of said account benefits and reward programs that are available to financial card accounts. The invention provides an aspect wherein said benefits and rewards programs are selected from at least one of cash back or interest earned. The invention provides an aspect wherein said debit is conducted using a transaction card, a smart card, or a magnetic strip card. The invention provides an aspect wherein said preset transaction parameter is a time period or a later billing cycle. The invention provides an aspect wherein said transaction parameter is at least one selected from at least one of a ratio, an amount threshold, a remainder threshold, a minimum available account balance, a maximum available account balance, a minimum debit amount, a range of debit amounts, or a maximum debit amount. The invention provides an aspect wherein said debit is conducted using a personal identification system. The invention provides an aspect wherein said personal identification system comprises at least one selected from at least one of personal identification number (PIN), a signature, an electronic signature, a fingerprint, a retinal scan, a DNA test, voice recognition, and face or feature recognition.

Management and Post Transaction Management of at Least Two Financial Accounts for Financial Transaction and Account Management Using Preset Parameters that Can be Modified in Real Time, Including Zeroing Balance Due, Account Splitting or Recombining, Billing Cycle Moving or Adjustment

The invention further provides a method for managing at least two financial accounts, comprising:
(a) providing at least two financial accounts comprising at least two available account balances that can be accessed for at least one debit for at least one financial transaction using at least one transaction processor; and
(b) accessing at least one said financial accounts to provide selected or modified transaction parameters or account maintenance functions related to at least one of the available account balances of said at least two financial accounts.

The invention provides an aspect wherein said transaction parameter is selected from at least one of a ratio, an amount threshold, a remainder threshold, a minimum available account balance, a maximum available account balance, a minimum debit amount, a range of debit amounts, or a maximum debit amount. The invention provides an aspect wherein said parameters enable said end user to allow split transactions in a depleted account condition. The invention provides an aspect wherein said transaction processor enables said end user or said card entity to make changes or modifications to said parameters via said interface using a communicative system component, format, or technology, from any location, wherein said interface comprises any communicative system component, format, or technology. The invention provides an aspect wherein said transaction processor comprises a special instructions file comprising where specific account debiting parameters are associated with any system component or type of merchant identifier information, or any merchant identifier information contained in the merchant identifier text string. The invention further provides an aspect wherein said special instructions file enables state codes or country codes contained in said merchant identifier information to be set up with specific account debiting parameters. The invention provides an aspect wherein said parameters enable at least one given available account balance to be disengaged. The invention provides an aspect wherein said parameters enable minimum available balance parameters to be set. The invention provides an aspect wherein said parameters enable minimum or maximum allowable transaction amounts to be set. The invention provides an aspect wherein said parameters enable limits to be set on the maximum total debiting of said at least two available account balances over any specified timeframe. The invention provides an aspect wherein said parameters enable account-debiting parameters to be adjusted according to specified timeframes. The invention provides an aspect wherein said parameters enable limits to be set on the maximum allowable available account balance usage for at least one available account balance comprising said at least two accounts over any specified timeframe; wherein said parameters comprise Best Fit or Rescue and Reject capabilities to deal with any transaction(s) that conflict with said maximum allowable available account balance usage. The invention provides an aspect wherein said transaction processor enables a transfer of payment amounts from any available cash balance(s) to make any payment(s) due on transaction amounts charged against any available credit balance(s), comprising where said transfer of said payment amounts are set to occur automatically, or where the end user expedites each said transfer individually. The invention provides an aspect wherein said transaction processor sends E-mail when said available account balances are used. The invention provides an aspect wherein said transaction processor enables separate parameters for cash withdrawals. The invention provides an aspect wherein said transaction processor enables separate parameters for check clearance. The invention further provides an aspect wherein said at least two available account balances comprises an available cash account specifically for cash withdrawals. The invention further provides an aspect wherein said at least two available account balances comprises an available cash account specifically for check clearance. The invention provides an aspect wherein said file maintenance functions enable readjustment or revision with regard to how said given transaction is debited among said at least two available account balances on a post real-time basis after a transaction is posted or otherwise consummated, either by readjusting global parameters, or by revising actual amounts. The invention further provides an aspect wherein said file maintenance functions enable readjustment or revision with regard to how said given transaction is debited among said at least two available account balances on a post real-time basis after a transaction is posted or otherwise consummated, either by readjusting global parameters, by revising actual amounts, or by specifying an amount to be readjusted, where said readjustment comprises a full or partial amount of said given transaction. The invention further provides such a method wherein said given transaction debiting an initial available credit balance readjusts to debit at least one available cash balance, and/or at least one additional available credit balance, thereby crediting or restoring said initial available credit balance. The invention provides an aspect wherein said restoring of said initial available credit balance is by use of funds from said cash balance. The invention provides an aspect wherein said initial available credit balance is restored to a pretransaction amount. The invention provides an aspect wherein said given transaction debiting an initial available cash balance readjusts to debit at least one available credit balance, and/or at least one additional available cash balance, thereby crediting or restoring said initial available cash balance, whereby said readjustment to said initial available cash balance offers a benefit for the issuer of the global account by increasing the risk of default for said global account by the end user, whereby said issuer can charge higher transaction or account fees. The invention provides an aspect wherein said readjustment comprises transaction specific readjustments and/or amount specific readjustments. The invention provides an aspect wherein an end user may make any number of said readjustment(s) comprising said transaction specific adjustments and/or said amount specific readjustments back and forth between any of the said at least two available balances. The invention provides an aspect wherein said readjustment comprising transaction specific readjustments and/or amount specific readjustments comprise an enhancement to accounts that use a singular available balance, such as debit card accounts, ATM card accounts, checking accounts, and the like that comprise a singular available cash balance; and, credit card accounts, lines of credit, and the like that comprise a singular available credit balance. The invention provides an aspect wherein said readjustment comprising transaction specific readjustments and/or amount specific readjustments can be utilized to remedy overdraft conditions. The invention provides an aspect wherein said transaction processor enables a plurality of differing point-of-sale identifiers to trigger differing transaction parameter account-debiting instructions. The invention provides an aspect wherein said transaction processor records transaction debiting parameters in order to properly credit returned purchases. The invention provides an aspect comprising where said interface comprises any format or technology, comprising where said interface may be used directly by the end user, or on behalf of said end user, and comprising where access to said interface comprises any format or technology. The invention provides an aspect wherein said transaction comprises the use of a financial card. The invention provides an aspect wherein said transaction comprises a cash withdrawal. The invention provides an aspect wherein said transaction comprises the use of a draft. The invention provides an aspect wherein said transaction comprises the use of an electronic or wire payment. The invention further provides a method wherein said transaction processor sets up electronic and wire payment instructions so that a given set of said electronic and wire payment instructions has its own set of available balance debiting parameters with regard to a ratio, an amount threshold, a remainder threshold, a minimum available account balance, a maximum available account balance, a minimum debit amount, a range of debit amounts, a different billing cycle, or a maximum debit amount.

The invention further provides wherein said preset transaction parameter is a time period or a later billing cycle which can be readjusted between at least one of a new or different account or a new or different billing cycle.

The invention provides a system for managing at least two financial accounts, comprising:
(i) a system component for providing at least two financial accounts comprising at least two available account balances that can be accessed for at least one debit for at least one financial transaction using at least one transaction processor; and
(ii) a system component for accessing at least one said financial accounts to provide selected or modified transaction parameters or account maintenance functions related to at least one of the available account balances of said at least two financial accounts.

The invention provides an aspect wherein said transaction parameter is selected from at least one of a ratio, an amount threshold, a remainder threshold, a minimum available account balance, a maximum available account balance, a minimum debit amount, a range of debit amounts, or a maximum debit amount. The invention provides an aspect wherein said parameters enable said end user to allow split transactions in a depleted account condition. The invention provides an aspect wherein said transaction processor enables said end user or said card entity to make changes or modifications to said parameters via said interface using a communicative system component, format, or technology, from any location, wherein said interface comprises any communicative system component, format, or technology. The invention provides an aspect wherein said transaction processor comprises a special instructions file comprising where specific account debiting parameters are associated with any system component or type of merchant identifier information, or any merchant identifier information contained in the merchant identifier text string. The invention further provides an aspect wherein said special instructions file enables state codes or country codes contained in said merchant identifier information to be set up with specific account debiting parameters. The invention provides an aspect wherein said parameters enable at least one given available account balance to be disengaged. The invention provides an aspect wherein said parameters enable minimum available balance parameters to be set. The invention provides an aspect wherein said parameters enable minimum or maximum allowable transaction amounts to be set. The invention provides an aspect wherein said parameters enable limits to be set on the maximum total debiting of said at least two available account balances over any specified timeframe. The invention provides an aspect wherein said parameters enable account-debiting parameters to be adjusted according to specified timeframes. The invention provides an aspect wherein said parameters enable limits to be set on the maximum allowable available account balance usage for at least one available account balance comprising said at least two accounts over any specified timeframe; wherein said parameters comprise Best Fit or Rescue and Reject capabilities to deal with any transaction(s) that conflict with said maximum allowable available account balance usage. The invention provides an aspect wherein said transaction processor enables a transfer of payment amounts from any available cash balance(s) to make any payment(s) due on transaction amounts charged against any available credit balance(s), comprising where said transfer of said payment amounts are set to occur automatically, or where the end user expedites each said transfer individually. The invention provides an aspect wherein said transaction processor sends E-mail when said available account balances are used. The invention provides an aspect wherein said transaction processor enables separate parameters for cash withdrawals. The invention provides an aspect wherein said transaction processor enables separate parameters for check clearance. The invention provides an aspect wherein said at least two available account balances comprises an available cash account specifically for cash withdrawals. The invention provides an aspect wherein said at least two available account balances comprises an available cash account specifically for check clearance. The invention provides an aspect wherein said file maintenance functions enable readjustment or revision with regard to how said given transaction is debited among said at least two available account balances on a post real-time basis after a transaction is posted or otherwise consummated, either by readjusting global parameters, or by revising actual amounts. The invention provides an aspect wherein said file maintenance functions enable readjustment or revision with regard to how said given transaction is debited among said at least two available account balances on a post real-time basis after a transaction is posted or otherwise consummated, either by readjusting global parameters, by revising actual amounts, or by specifying an amount to be readjusted, where said readjustment comprises a full or partial amount of said given transaction. The invention provides an aspect wherein said given transaction debiting an initial available credit balance readjusts to debit at least one available cash balance, and/or at least one additional available credit balance, thereby crediting or restoring said initial available credit balance. The invention provides an aspect wherein said restoring of said initial available credit balance is by use of finds from said cash balance. The invention provides an aspect wherein said initial available credit balance is restored to a pretransaction amount. The invention provides an aspect wherein said given transaction debiting an initial available cash balance readjusts to debit at least one available credit balance, and/or at least one additional available cash balance, thereby crediting or restoring said initial available cash balance, whereby said readjustment to said initial available cash balance offers a benefit for the issuer of the global account by increasing the risk of default for said global account by the end user, whereby said issuer can charge higher transaction or account fees.

The invention provides an aspect wherein said readjustment comprises transaction specific readjustments and/or amount specific readjustments. The invention provides an aspect wherein an end user may make any number of said readjustment(s) comprising said transaction specific adjustments and/or said amount specific readjustments back and forth between any of the said at least two available balances. The invention provides an aspect wherein said readjustment comprising transaction specific readjustments and/or amount specific readjustments comprise an enhancement to accounts that use a singular available balance, such as debit card accounts, ATM card accounts, checking accounts, and the like that comprise a singular available cash balance; and, credit card accounts, lines of credit, and the like that comprise a singular available credit balance. The invention provides an aspect wherein said readjustment comprising transaction specific readjustments and/or amount specific readjustments can be utilized to remedy overdraft conditions. The invention provides an aspect wherein said transaction processor enables a plurality of differing point-of-sale identifiers to trigger differing transaction parameter account-debiting instructions. The invention provides an aspect wherein said transaction processor records transaction debiting parameters in order to properly credit returned purchases.

The invention provides an aspect comprising where said interface comprises any format or technology, comprising where said interface may be used directly by the end user, or on behalf of said end user, and comprising where access to said interface comprises any format or technology. The invention provides an aspect wherein said transaction comprises the use of a financial card. The invention provides an aspect wherein said transaction comprises a cash withdrawal. The invention provides an aspect wherein said transaction comprises the use of a draft. The invention provides an aspect wherein said transaction comprises the use of an electronic or wire payment. The invention provides an aspect wherein said transaction processor sets up electronic and wire payment instructions so that a given set of said electronic and wire payment instructions has its own set of available balance debiting parameters with regard to a ratio, an amount threshold, a remainder threshold, a minimum available account balance, a maximum available account balance, a minimum debit amount, a range of debit amounts, a different billing cycle, or a maximum debit amount. The invention provides an aspect wherein said preset transaction parameter is a time period or a later billing cycle which can be readjusted between at least one of a new or different account or a new or different billing cycle.

Method of Fee or Reduced Fee Checking Based on Off-Line Interchange Fee Activity

The invention further provides a method for providing an end user free or reduced fee financial account services in exchange for fee based account interchange activity conducted, comprising providing using a transaction processor a free or reduced fee financial account services for at least one financial account to said end user when said end user performs a specified amount or total number of fee based inter account financial transactions within a specified period using at least one available credit or available cash balance.

The invention provides an aspect wherein said reduced fee or free financial account services are in the form of a rebate, a credit, a gift or earned interest. The invention provides an aspect wherein said at least one financial account is selected from a checking account, a savings account, a debit account, a credit account, a line of credit, an line of equity, a stock account, a mutual fund account, or a money market account. The invention provides an aspect wherein said at least one financial account can have one or more billing cycles that can be adjusted by the end user. The invention provides an aspect wherein said fee based inter account financial transaction involves the transfer of at least one credit or transferred billing cycle between at least two of said at least one financial accounts. The invention provides an aspect wherein said transaction processor sets up electronic or wire payment instructions so that a given set of said electronic and wire payment instructions has its own set of available balance debiting parameters with regard to a time period or a later billing cycle of said at least one financial accounts. The invention provides an aspect wherein said fee based inter account financial transaction is conducted using a personal identification system. The invention provides an aspect wherein said personal identification system comprises at least one selected from at least one of personal identification number (PIN), a signature, an electronic signature, a fingerprint, a retinal scan, a DNA test, voice recognition, and face or feature recognition.

The invention further provides a system for providing an end user free or reduced fee financial account services in exchange for fee based account interchange activity conducted, comprising a system component for providing using a transaction processor a free or reduced fee financial account services for at least one financial account to said end user when said end user performs a specified amount or total number of fee based inter account financial transactions within a specified period using at least one available credit or available cash balance. The invention provides an aspect wherein said reduced fee or free financial account services are in the form of a rebate, a credit, a gift or earned interest. The invention provides an aspect wherein said at least one financial account is selected from a checking account, a savings account, a debit account, a credit account, a line of credit, an line of equity, a stock account, a mutual fund account, or a money market account. The invention provides an aspect wherein said at least one financial account can have one or more billing cycles that can be adjusted by the end user. The invention provides an aspect wherein said fee based inter account financial transaction involves the transfer of at least one credit or transferred billing cycle between at least two of said at least one financial accounts. The invention provides an aspect wherein said transaction processor sets up electronic or wire payment instructions so that a given set of said electronic and wire payment instructions has its own set of available balance debiting parameters with regard to a time period or a later billing cycle of said at least one financial accounts. The invention provides an aspect wherein said fee based inter account financial transaction is conducted using a personal identification system. The invention provides an aspect wherein said personal identification system comprises at least one selected from at least one of personal identification number (PIN), a signature, an electronic signature, a fingerprint, a retinal scan, a DNA test, voice recognition, and face or feature recognition.

Smart Data Card Using Method of Debit from Preselected Parameter Related at Least Two Financial Accounts

The invention further provides wherein said transaction processor that resides on a smart data card. The invention provides an aspect wherein said parameters enable at least one given available account balance to be disengaged. The invention provides an aspect wherein said parameters enable minimum available balance parameters to be set. The invention provides an aspect wherein said parameters enable minimum or maximum allowable transaction amounts to be set. The invention provides an aspect wherein said parameters enable Best Fit or Rescue or Reject criteria. The invention provides an aspect further comprising where said smart data card interface is part of, is at the site of, or is away from the site of said point-of-sale terminal. The invention provides an aspect wherein said parameters enable an account with a time period or a later billing cycle. The invention provides an aspect wherein said debit is conducted using a personal identification system. The invention provides an aspect wherein said personal identification system comprises at least one selected from at least one of personal identification number (PIN), a signature, an electronic signature, a fingerprint, a retinal scan, a DNA test, voice recognition, and face or feature recognition.

The invention further provides a system wherein said transaction processor that resides on a smart data card. The invention provides an aspect wherein said parameters enable at least one given available account balance to be disengaged. The invention provides an aspect wherein said parameters enable minimum available balance parameters to be set. The invention provides an aspect wherein said parameters enable minimum or maximum allowable transaction amounts to be set. The invention provides an aspect wherein said parameters enable Best Fit or Rescue or Reject criteria. The invention provides an aspect further comprising where said smart data card interface is part of, is at the site of, or is away from the site of said point-of-sale terminal. The invention provides an aspect wherein said parameters enable an account with a time period or a later billing cycle. The invention provides an aspect wherein said debit is conducted using a personal identification system. The invention provides an aspect wherein said personal identification system comprises at least one selected from at least one of personal identification number (PIN), a signature, an electronic signature, a fingerprint, a retinal scan, a DNA test, voice recognition, and face or feature recognition.

Post Transaction Management Using Preset Parameters of at Least Two Financial Accounts for Financial Transaction and Account Management Using Preset Parameters that Can be Modified in Real Time

The invention further provides a method for managing at least two financial accounts, comprising providing at least two financial accounts comprising at least two available account balances that can be accessed for at least one debit for at least one financial transaction using at least one transaction processor; and accessing at least one said financial accounts to provide selected or modified transaction parameters or account maintenance functions related to at least one of the available account balances of said at least two financial accounts, wherein said file maintenance functions enable readjustment or revision with regard to how said given transaction is debited among said at least two available account balances on a post real-time basis after a transaction is posted or otherwise consummated, either by readjusting global parameters, by revising actual amounts, or by specifying an amount to be readjusted, where said readjustment comprises a full or partial amount of said given transaction, wherein said readjustment or revision is made using preset thresholds, ratios, or amounts in at least one of said accounts.

The invention provides an aspect wherein said account includes a credit account related to a cash account. The invention provides an aspect wherein said account includes a first credit account related to a second credit account. The invention provides an aspect wherein said account includes a first cash account related to a second cash account. The invention provides an aspect wherein said credit account acts as an overdraft account for said cash account. The invention provides an aspect wherein said cash account acts as an overdraft account for said credit account. The invention provides an aspect wherein said first credit account acts as an overdraft account for said second credit account. The invention provides an aspect wherein said second credit account acts as an overdraft account for said first credit account. The invention provides an aspect wherein said first cash account acts as an overdraft account for said second cash account. The invention provides an aspect wherein said second cash account acts as an overdraft account for said first cash account.

The invention further provides a system for managing at least two financial accounts, comprising: a system component for providing at least two financial accounts comprising at least two available account balances that can be accessed for at least one debit for at least one financial transaction using at least one transaction processor; and a system component for accessing at least one said financial accounts to provide selected or modified transaction parameters or account maintenance functions related to at least one of the available account balances of said at least two financial accounts, wherein said file maintenance functions enable readjustment or revision with regard to how said given transaction is debited among said at least two available account balances on a post real-time basis after a transaction is posted or otherwise consummated, either by readjusting global parameters, by revising actual amounts, or by specifying an amount to be readjusted, where said readjustment comprises a full or partial amount of said given transaction, wherein said readjustment or revision is made using preset thresholds, ratios, or amounts in at least one of said accounts.

The invention provides an aspect wherein said account includes a credit account related to a cash account. The invention provides an aspect wherein said account includes a first credit account related to a second credit account. The invention provides an aspect wherein said account includes a first cash account related to a second cash account. The invention provides an aspect wherein said credit account acts as an overdraft account for said cash account. The invention provides an aspect wherein said cash account acts as an overdraft account for said credit account. The invention provides an aspect wherein said first credit account acts as an overdraft account for said second credit account. The invention provides an aspect wherein said second credit account acts as an overdraft account for said first credit account. The invention provides an aspect wherein said first cash account acts as an overdraft account for said second cash account. The invention provides an aspect wherein said second cash account acts as an overdraft account for said first cash account.

Real Time and Post Transaction of Debit from Preselected Parameter Related at Least Two Financial Accounts

The invention further provides wherein said transaction parameter can be modified by the end user in a real time basis. The invention further provides wherein said transaction parameter can be modified by the end user after the transaction has occurred or posted. The invention provides an aspect, wherein said transaction parameter is a time period or a later billing cycle. The invention provides an aspect wherein said transaction parameter is at least one selected from at least one of a ratio, an amount threshold, a remainder threshold, a minimum available account balance, a maximum available account balance, a minimum debit amount, a range of debit amounts, or a maximum debit amount. The invention provides an aspect, wherein said transaction parameter is at least one selected from at least one of a ratio, an amount threshold, a remainder threshold, a minimum available account balance, a maximum available account balance, a minimum debit amount, a range of debit amounts, or a maximum debit amount. The invention provides an aspect wherein at least part of the transaction amount of said at least one point of sale transaction can be moved to a different account of at least one of said credit or cash accounts that has a different timeframe or billing cycle. The invention provides an aspect, wherein said different timeframe or billing cycle is a later timeframe or billing cycle.

The invention further provides a system wherein said transaction parameter can be modified by the end user in a real time basis. The invention further provides a system wherein said transaction parameter can be modified by the end user after the transaction has occurred or posted. The invention provides an aspect wherein said transaction parameter is a time period or a later billing cycle. The invention provides an aspect wherein said transaction parameter is at least one selected from at least one of a ratio, an amount threshold, a remainder threshold, a minimum available account balance, a maximum available account balance, a minimum debit amount, a range of debit amounts, or a maximum debit amount. The invention provides an aspect wherein said transaction parameter is at least one selected from at least one of a ratio, an amount threshold, a remainder threshold, a minimum available account balance, a maximum available account balance, a minimum debit amount, a range of debit amounts, or a maximum debit amount. The invention provides an aspect wherein at least part of the transaction amount of said at least one point of sale transaction can be moved to a different account of at least one of said credit or cash accounts that has a different timeframe or billing cycle. The invention provides an aspect wherein said different timeframe or billing cycle is a later timeframe or billing cycle.

Readjustment of Parameters or Amounts in at Least Two Accounts

The invention further provides a method for readjustment or revision of the allocation of available balances to cover at least one transaction debited from at least one first financial account, after said debited transaction is posted or otherwise consummated, comprising accessing said at least one first financial account from which said transaction was debited; and readjusting or revising said allocation of available balances to cover said debited transaction using at least one preset parameter or at least one other parameter relating said at least one first financial account to at least one other available account balance from at least one other second financial account by at least one step selected from readjusting at least one parameter relating the amounts in at least one of said first and second financial accounts to cover said debited transaction amount; revising at least one of said actual amounts in at least one of said first and second financial accounts to cover said debited transaction amount; or specifying at least one amount in at least one of said at least one first and second financial accounts to be readjusted to cover said debited transaction amount; wherein said readjustment or revision comprises at least a partial amount of said transaction debited from said first available financial account.

The invention provides an aspect wherein said given transaction debiting an initial available credit balance readjusts to debit at least one available cash balance, and/or at least one additional available credit balance, thereby crediting or restoring said initial available credit balance. The invention provides an aspect wherein said given transaction debiting an initial available cash balance readjusts to debit at least one available credit balance, and/or at least one additional available cash balance, thereby crediting or restoring said initial available cash balance, whereby said readjustment to said initial available cash balance offers an unexpected result and benefit for the issuer of the global account by increasing the risk of default for said global account by the end user, thus enabling said issuer to justify and charge higher fees. The invention provides an aspect wherein said readjustment comprises transaction specific readjustments and/or amount specific readjustments. The invention provides an aspect wherein an end user may make any number of said readjustment(s) comprising said transaction specific adjustments and/or said amount specific readjustments back and forth between any of the said at least two available balances. The invention provides an aspect wherein said readjustment comprising transaction specific readjustments and/or amount specific readjustments comprise an enhancement to old and well known embodiments of accounts that use a singular available balance, such as debit card accounts, ATM card accounts, checking accounts, and the like that comprise a singular available cash balance; and, credit card accounts, lines of credit, and the like that comprise a singular available credit balance. The invention provides an aspect wherein said readjustment comprising transaction specific readjustments and/or amount specific readjustments can be utilized to remedy overdraft conditions. The invention provides an aspect wherein said transaction processor enables a plurality of differing point-of-sale identifiers to trigger differing transaction parameter account-debiting instructions. The invention provides an aspect wherein said transaction processor records transaction debiting parameters in order to properly credit returned purchases. The invention provides an aspect comprising where said interface comprises any format or technology, comprising where said interface may be used directly by the end user, or on behalf of said end user, and comprising where access to said interface comprises any format or technology. The invention provides an aspect wherein said transaction comprises the use of a financial card. The invention provides an aspect wherein said transaction comprises a cash withdrawal. The invention provides an aspect wherein said transaction comprises the use of a draft. The invention provides an aspect wherein said transaction comprises the use of an electronic or wire payment. The invention provides an aspect wherein said transaction processor sets up electronic and wire payment instructions so that a given set of said electronic and wire payment instructions has its own set of available balance debiting parameters with regard to a ratio, an amount threshold, a remainder threshold, a minimum available account balance, a maximum available account balance, a minimum debit amount, a range of debit amounts, a different billing cycle, or a maximum debit amount.

The invention further provides a system for readjustment or revision of the allocation of available balances to cover at least one transaction debited from at least one first financial account, after said debited transaction is posted or otherwise consummated, comprising a system component for accessing said at least one first financial account from which said transaction was debited; and a system component for readjusting or revising said allocation of available balances to cover said debited transaction using at least one preset parameter or at least one other parameter relating said at least one first financial account to at least one other available account balance from at least one other second financial account by at least one system component selected from a system component for readjusting at least one parameter relating the amounts in at least one of said first and second financial accounts to cover said debited transaction amount; a system component for revising at least one of said actual amounts in at least one of said first and second financial accounts to cover said debited transaction amount; or a system component for specifying at least one amount in at least one of said at least one first and second financial accounts to be readjusted to cover said debited transaction amount; wherein said readjustment or revision comprises at least a partial amount of said transaction debited from said first available financial account.

The invention provides an aspect wherein said given transaction debiting an initial available credit balance readjusts to debit at least one available cash balance, and/or at least one additional available credit balance, thereby crediting or restoring said initial available credit balance. The invention provides an aspect wherein said given transaction debiting an initial available cash balance readjusts to debit at least one available credit balance, and/or at least one additional available cash balance, thereby crediting or restoring said initial available cash balance, whereby said readjustment to said initial available cash balance offers an unexpected result and benefit for the issuer of the global account by increasing the risk of default for said global account by the end user, thus enabling said issuer to justify and charge higher fees.

The invention provides an aspect wherein said readjustment comprises transaction specific readjustments and/or amount specific readjustments. The invention provides an aspect wherein an end user may make any number of said readjustment(s) comprising transaction specific adjustments and/or said amount specific readjustments back and forth between any of the said at least two available balances. The invention provides an aspect wherein said readjustment comprising transaction specific readjustments and/or amount specific readjustments comprise an enhancement to old and well known embodiments of accounts that use a singular available balance, such as debit card accounts, ATM card accounts, checking accounts, and the like that comprise a singular available cash balance; and, credit card accounts, lines of credit, and the like that comprise a singular available credit balance. The invention provides an aspect wherein said readjustment comprising transaction specific readjustments and/or amount specific readjustments can be utilized to remedy overdraft conditions. The invention provides an aspect wherein said transaction processor enables a plurality of differing point-of-sale identifiers to trigger differing transaction parameter account-debiting instructions. The invention provides an aspect wherein said transaction processor records transaction debiting parameters in order to properly credit returned purchases. The invention provides an aspect comprising where said interface comprises any format or technology, comprising where said interface may be used directly by the end user, or on behalf of said end user, and comprising where access to said interface comprises any format or technology. The invention provides an aspect wherein said transaction comprises the use of a financial card. The invention provides an aspect wherein said transaction comprises a cash withdrawal. The invention provides an aspect wherein said transaction comprises the use of a draft. The invention provides an aspect wherein said transaction comprises the use of an electronic or wire payment. The invention provides an aspect wherein said transaction processor sets up electronic and wire payment instructions so that a given set of said electronic and wire payment instructions has its own set of available balance debiting parameters with regard to a ratio, an amount threshold, a remainder threshold, a minimum available account balance, a maximum available account balance, a minimum debit amount, a range of debit amounts, a different billing cycle, or a maximum debit amount.

Authorization Methods and Systems

The invention further provides a method for authorizing at least one debit for at least one financial transaction using at least one transaction parameter for relating the debit amount of said debit to the relative account balances in at least two financial accounts, comprising: providing at least two financial accounts comprising at least one available account balance that can be accessed for said debit for said at least one financial transaction; and authorizing said debit amount for said at least one financial transaction from said at least one of said account balances based on at least one of said transaction parameters relating said debit amount to the amounts or ratios of each of said account balances in at least two of said available account balances.

The invention provides an aspect wherein said transaction parameter is selected from at least one of a ratio, an amount threshold, a remainder threshold, a minimum available account balance, a maximum available account balance, a minimum debit amount, a range of debit amounts, or a maximum debit amount. The invention provides an aspect, wherein said debit for said financial transaction based on said at least one transaction parameter is based on at least one selected from: the total of said at least two available account balances is greater than or equal to said debit amount; at least one selected available account balance is greater than or equal to said assigned portion of said debit amount corresponding to said at least one selected available account balance; or at least one selected available account balance, as determined by said transaction processor, that is able to compensate for a deficiency in at least one other selected available account balance that is less than the assigned portion of said debit amount corresponding to said at least one selected available account balance, where said assigned portion is determined by said transaction processor.

The invention provides an aspect further comprising where said available account balance is accessed from a point-of-sale via at least one automated financial network. The invention provides an aspect wherein said available account balance is accessed from a point-of-sale via a proprietary network or an ACH and/or EFT network. The invention provides an aspect further comprising where said available account balance is accessed from a point-of-sale via the Internet. The invention provides an aspect further comprising where said at least two available account balances are selected from at least one available in-house cash balance and/or at least one available in-house credit balance. The invention provides an aspect further comprising where said at least two available account balances are selected from at least one available out-of-house cash balances and/or available out-of-house credit balances in addition to at least one available in-house cash balances and/or the available in-house credit balances. The invention provides an aspect further comprising where said at least two available account balances are selected from at least one available out-of-house cash balance and/or at least one available out-of-house credit balance. The invention provides an aspect further comprising where said at least one of the available account balances is accessible via an account number selected from at least one of a credit card, a debit card, an ATM card, an financial services account, a bank account, a credit account, where said account number is distinct from the account number(s) used to access said global account. The invention provides an aspect further comprising where said available account balances allow a given end user of said account benefits and reward programs that are available to financial card accounts. The invention provides an aspect wherein said benefits and rewards programs are selected from at least one of cash back or interest earned. The invention provides an aspect wherein said debit is conducted using a transaction card, a smart card, or a magnetic strip card. The invention provides an aspect wherein said preset transaction parameter is a time period or a later billing cycle. The invention provides an aspect wherein said transaction parameter is at least one selected from at least one of a ratio, an amount threshold, a remainder threshold, a minimum available account balance, a maximum available account balance, a minimum debit amount, a range of debit amounts, or a maximum debit amount. The invention provides an aspect wherein said debit is conducted using a personal identification system. The invention provides an aspect wherein said personal identification system comprises at least one selected from at least one of personal identification number (PIN), a signature, an electronic signature, a fingerprint, a retinal scan, a DNA test, voice recognition, and face or feature recognition.

The invention further provides a system for authorizing at least one debit for at least one financial transaction using at least one transaction parameter for relating the debit amount of said debit to the relative account balances in at least two financial accounts, comprising: a system component for providing at least two financial accounts comprising at least one available account balance that can be accessed for said debit for said at least one financial transaction; and a system component for authorizing said debit amount for said at least one financial transaction from said at least one of said account balances based on at least one of said transaction parameters relating said debit amount to the amounts or ratios of each of said account balances in at least two of said available account balances.

The invention provides an aspect wherein said transaction parameter is selected from at least one of a ratio, an amount threshold, a remainder threshold, a minimum available account balance, a maximum available account balance, a minimum debit amount, a range of debit amounts, or a maximum debit amount. The invention provides an aspect wherein said debit for said financial transaction based on said at least one transaction parameter is based on at least one selected from: the total of said at least two available account balances is greater than or equal to said debit amount; at least one selected available account balance is greater than or equal to said assigned portion of said debit amount corresponding to said at least one selected available account balance; or at least one selected available account balance, as determined by said transaction processor, that is able to compensate for a deficiency in at least one other selected available account balance that is less than the assigned portion of said debit amount corresponding to said at least one selected available account balance, where said assigned portion is determined by said transaction processor.

The invention provides an aspect further comprising where said available account balance is accessed from a point-of-sale via at least one automated financial network. The invention provides an aspect wherein said available account balance is accessed from a point-of-sale via a proprietary network or an ACH and/or EFT network. The invention provides an aspect further comprising where said available account balance is accessed from a point-of-sale via the Internet. The invention provides an aspect further comprising where said at least two available account balances are selected from at least one available in-house cash balance and/or at least one available in-house credit balance. The invention provides an aspect further comprising where said at least two available account balances are selected from at least one available out-of-house cash balances and/or available out-of-house credit balances in addition to at least one available in-house cash balances and/or the available in-house credit balances. The invention provides an aspect further comprising where said at least two available account balances are selected from at least one available out-of-house cash balance and/or at least one available out-of-house credit balance. The invention provides an aspect further comprising where said at least one of the available account balances is accessible via an account number selected from at least one of a credit card, a debit card, an ATM card, an financial services account, a bank account, a credit account, where said account number is distinct from the account number(s) used to access said global account. The invention provides an aspect further comprising where said available account balances allow a given end user of said account benefits and reward programs that are available to financial card accounts. The invention provides an aspect further comprising where said benefits and rewards programs are selected from at least one of cash back or interest earned. The invention provides an aspect wherein said debit is conducted using a transaction card, a smart card, or a magnetic strip card. The invention provides an aspect wherein said preset transaction parameter is a time period or a later billing cycle. The invention provides an aspect wherein said transaction parameter is at least one selected from at least one of a ratio, an amount threshold, a remainder threshold, a minimum available account balance, a maximum available account balance, a minimum debit amount, a range of debit amounts, or a maximum debit amount. The invention provides an aspect wherein said debit is conducted using a personal identification system. The invention provides an aspect wherein said personal identification system comprises at least one selected from at least one of personal identification number (PIN), a signature, an electronic signature, a fingerprint, a retinal scan, a DNA test, voice recognition, and face or feature recognition.

The present invention is further described by the following description and examples, which do not limit the scope of the present invention, but are representative of the particular aspects of the invention.

### BRIEF DESCRIPTION OF THE DRAWINGS

The above and other features and advantages of the present invention are hereinafter described in the following detailed description of illustrative embodiments to be read in conjunction with the accompanying drawings and figures, wherein like reference numerals are used to identify the same or similar system parts and/or method steps in the similar views, and:

FIG. 1 is a schematic illustration of exemplary interfaces and networks in communication with a transaction processor of the present invention;

FIG. 2 is a schematic corresponding to a transaction processor in communication with an external card service and not internal card service configuration in accordance with an exemplary embodiment;

FIG. 3 is a schematic corresponding to a multiple account provider with an internal transaction processor configured for internal card service in accordance with an exemplary embodiment; and

FIG. 4 is a more detailed schematic of exemplary components of the multiple account transaction processor.

Other aspects and features of the present invention will be more fully apparent from the detailed description that follows.

### DETAILED DESCRIPTION OF THE INVENTION

The present invention provides global account, multiple account, multiple parameter methods, systems, apparatus, transaction cards, and the like for use in providing, managing or adjusting balances relating to at least one financial transaction via access to at least one global account or at least two available financial accounts that can be debited by preset parameters relating the amount of the debit to the relative balances available in the two available financial accounts, which balances or relative debit amounts can be modified, adjusted or preset according to specific parameters. The parameter(s) and access to a global account or at least two financial accounts for at least one transaction provide solutions related to the problem of accessing and managing debit funds for at least one transaction without having to go through the delay and difficulties of having specific accounts have insufficient funds for such debits, as well as for providing automatic, preset access instructions for at least one global account or at least one or at least two financial accounts. Such access and parameter(s) allow the financial account user to have predetermined, preset or adjustable account access, without the problems associated with the possibility of insufficient accounts or with having to figure out at the time of the transaction, whether minimum balances or other aspects of the financial account remaining balances are being maintained after the debit is made for the point of sale transaction.

“Debit” can mean in the present invention any deduction from any financial account by any known method. The terms debit, debits, debiting, debited, etc. as used throughout this invention, can also optionally be used in the traditional accounting sense mainly as verbs, as defined in Webster's Revised Unabridged Dictionary, © 1996, 1998 MICRA, Inc.: deb-it \Debit\, v. t. [imp. & p. p. Debited; p. pr. & vb. n. Debiting.] 1. To charge with debt;—the opposite of, and correlative to, credit; as, to debit a purchaser for the goods sold. For example, to debit an available cash balance is to have cash or cash equivalents removed from the available cash balance to pay for a debt, which in many cases pertains to purchases that have been made. On the other hand, to debit an available credit balance for, say, a purchase, is to reduce the available credit balance by the purchase amount, where the reduction reflects a consumption of the available credit balance. Relating with the above Webster's debit definition: To charge with debt, this debiting (consumption) of the available credit balance acts to charge the end user with a debt that must be repaid at a later time. For instance, if an end user uses an available credit balance to make a $100 purchase, the available credit balance is debited for the $100 amount, resulting in basically a $100 debt that is owed. Ultimately, the end user will eventually pay off this $100 debt amount sometime in the future.

Also in the invention, the verb “credit”, in its varied forms, is used according to any known or described method. Such a credit can mean any addition of funds to any financial account either from another account, a cash deposit or transfer or any other known method for adding funds to an account. As a non-limiting example, in the event that a purchase is returned to a merchant by an end user, the merchant credits the balance(s) originally used for the purchase. When the merchant credits an end user's available cash balance, cash pertaining to the purchase amount is restored (returned) to the available cash balance. When the merchant credits an end user's available credit balance, the total consumption of the available credit balance is reduced by the amount of the returned purchase transaction as credited by the merchant. What this basically means is that the total amount of the debt that must be repaid at a later time due to total credit balance consumption by the end user is reduced by the amount of the returned purchase transaction. For example, if an end user has total credit balance usage of $500, and then makes a $100 return to a merchant, once the return gets credited by the merchant, the end user will have to repay the debt based only on the revised total available credit balance consumption of $400.

The present invention provides methods and uses of financial cards (or other identity based systems, herein after referred to as financial cards) to charge financial transactions such as, but not limited to, point of sale amounts from one or more accounts, as a global account, in a single transaction or connected set of transactions, such that the end user or the financial institution providing the financial card or other identity based system can preset single or multiple parameters for the point of sale transaction to access alternative accounts to provide funds to cover the point of sale transaction, where the account access is other than a demand account that merely covers the amount of insufficient funds in a single account.

The financial card in question can be a regular magnetic stripe card well known to the art. Some card issuers feature magnetic stripe cards with an on-board smart chip; however, in many cases, especially in the United States, the actual chip has seen little, if any use in purchase transactions, as there is a tendency to make use of the smart card's magnetic stripe instead. In any event, magnetic stripe cards with an on-board smart chip may also be employed, although such a card will be used basically for its magnetic stripe capability. It is foreseeable that the actual smart chip could ultimately be useful in facilitating certain transaction aspects, especially with regards to security issues; however, for the time being, any card comprising a standardized magnetic stripe can be used in conjunction with the global account.

Key to this embodiment is the financial card global account belonging to the end user. In terms of present, widely used technology, the global account can be oriented as being PIN-based (on-line using a PIN at the point-of-sale), or signature based (off-line requiring an end-user signature at the point-of-sale), or any other known methods, such as, but not limited to biometrics, to voice recognition, radio related protocols used in wands at a point-of-sale (Exxon/Mobile), E-Z Pass, and similar technologies being adapted for cell phones, or any combination thereof. As mentioned earlier, it is important to understand that the present invention is not intended to be limited to only PIN-based or signature-based accounts, but may be adapted to use any other kind of security/verification and/or system routing other than PIN-based or signature based embodiments, comprising retinal scanning, fingerprints, and/or other unique cardholder physical characteristics, with or without employing a financial card, either using currently known networks, any future network, or the Internet. While banks considering the present invention would tend to favor PIN-based embodiments, and card issuers would tend to favor signature-based embodiments, such is merely an observation, and not a limitation. The global account comprises at least two available account balances. Available account balances fall under two general headings: an available cash balance, and an available credit balance.

With regard to cash balances, is important that all of the cash balances earmarked for actual financial card purchase transactions are legally able to be used as a demand account according to 12 C.F.R (Code of Federal Regulations) section 329.2 mentioned earlier, which is repeated as follows: “No bank shall, directly or indirectly, by any device whatsoever, pay interest on any demand deposit.” An example of an account that pays interest, and is precluded from being used for financial card purchase transactions according to 12 C.F.R. section 329.2, is a savings account. The plurality of available cash balances includes any type of available cash balance, such as a checking account balance; or cash equivalent balance that can be used for purchases, such as a money market fund, where one unit or share of a money market fund equals, say, one U.S. dollar. Furthermore, should federal regulations somehow change to where interest bearing accounts are permitted to be used as demand accounts, or methods emerge that legally enable interest bearing accounts to be manipulated and used in demand account situations, then such accounts would be deemed usable for purposes of this disclosure as available cash balances.

A very important distinction should be made at this time. Just because an interest-bearing savings account cannot be used for financial card purchase transactions does not necessarily mean that the financial card global account cannot comprise an interest-bearing savings account to good effect. The disclosed financial card global account can comprise at least one interest-bearing non-demand account to enable ATM (automated teller machine) withdrawals. ATM cash withdrawals on interest-bearing savings accounts have absolutely no implications with regard to 12 C.F.R. section 329.2; however, debit card transactions that debit interest-bearing savings accounts are prohibited under 12 C.F.R. section 329.2.

A kind of point-of-sale that is readily apparent is at a store, where the end user swipes his financial card in the presence of a merchant or service provider. The term point-of-sale, as it is used in this invention, is meant to encompass all manners and physical locations that are the origin for the debiting of the global account. Furthermore, the end user does not actually have to be present at the merchant location for the transaction to be considered, for purposes of this invention, as a point-of-sale transaction. For example, should an end user enter his financial card account number on the website for a given merchant, it is considered a point-of-sale transaction, even if the end user is making the purchase on a computer in the end user's house. Should an end user phone in a card account number from his home to a merchant; it is considered a point-of-sale transaction. Should a merchant or service provider automatically debit the global financial account, such as in the case of an automatic monthly payment to the merchant or service provider, it is still considered to be a point-of-sale transaction for purposes of this invention.

With regard to available credit balances, available credit balances comprise three general categories: The first is the revolving credit balance that is used in credit cards, in which an end user pays interest on balances not paid in full after the close of the billing cycle. The second is the charge balance used in charge cards, in which an end user is expected to pay balances in full after the close of the billing cycle. The third is a line of credit, which some banks offer to some end users of checking accounts and/or debit cards. Unlike a revolving credit balance or even a charge balance, typical lines of credit tend to not allow interest-free grace periods for purchase transactions. Also, lines of credit tend not to offer the myriad of credit card type benefits, such as reward programs, purchase protection programs, limited fraud liability, etc. It is envisioned as desirable for embodiments of this invention that make use of at least one available credit balance to avail end users to benefits normally associated with credit card offerings; nonetheless, lines of credit should be considered as extremely usable for embodiments of the present invention that are PIN-based. Furthermore, there are real no obstacles other than costs that prevent an entity that offers a PIN-based embodiment to offer features and benefits to end users of a line of credit that in some or many ways resemble end-user features and benefits of typical of signature-based credit card embodiments. Finally, an available credit balance is meant to include any manner or embodiment of an available credit balance for purposes of this invention, and is not intended to be limited only to a revolving credit balance, charge balance, or line of credit.

The at least two available account balances may comprise any combination of available account balances belonging to an end user. For example, if the plurality comprises two available account balances, the two available account balances can comprise two available cash balances, two available credit balances, or one available cash balance, and one available credit balance. Likewise, if the plurality comprises three or more available account balances, the three or more available account balances can comprise any combination of available cash balances, and/or available credit balances, with the plurality possibly comprising at least one available balance that is specifically used for ATM cash withdrawals that may or may not pay interest.

The at least two available account balances is intended to function under the aegis of the global account; nonetheless, it may be desirable to be able to access a particular available account balance for whatever reason. Therefore, it is possible for at least one of the available account balances comprising the global account to have its own account number that enables access via a credit card, debit card, ATM card, draft, etc., that is distinct from the account number(s) used to access the global account.

A relatively simple and especially effective combination is where the at least two available account balances comprises two available account balances, where one available balance is an available cash balance, and the other is an available credit balance. The chart examples that will be provided later will focus mainly on a global account comprising one available cash balance and one available credit balance. As a side note, it is possible for an end user to open a global account with one available cash balance, and one available credit balance, and begin to use the account without having the cash account funded by just using the available credit balance. Then, as the end user becomes more comfortable with the workings of the account, or has the ability to fund the available cash balance, the end user can then fund the available cash balance and begin to take advantage of the global account's true flexibility. For the sake of semantics, it is possible for the present invention comprising a plurality of account balances to not be seen or considered in terms of comprising a “global account”; on the other hand, it is possible for the present invention to be seen in any other equivalent or similar terms that resemble the term “global account”.

A vital element to the disclosed global account belonging to an end user is the transaction processor. The transaction processor links together and controls the at least two available account balances. What is especially salient is that the transaction processor enables a given incoming transaction to be debited among the at least two available account balances in accordance with preset parameters. A note about the location of the available account balances is in order. While it is envisioned as being most efficient overall with regards to implementation and costs for the at least two account balances to be maintained at the same financial institution as the global account comprising the transaction processor, where all the available account balances are in-house, it is possible for at least one out-of-house available account balance to be linked to the transaction processor that is part of the global account comprising at least one in-house available account balance. Furthermore, it is disclosed that it is possible to have an embodiment of the transaction processor that works only with out-of-house available account balances, where said embodiment does not comprise any in-house available account balances whatsoever.

System and Network Configuration

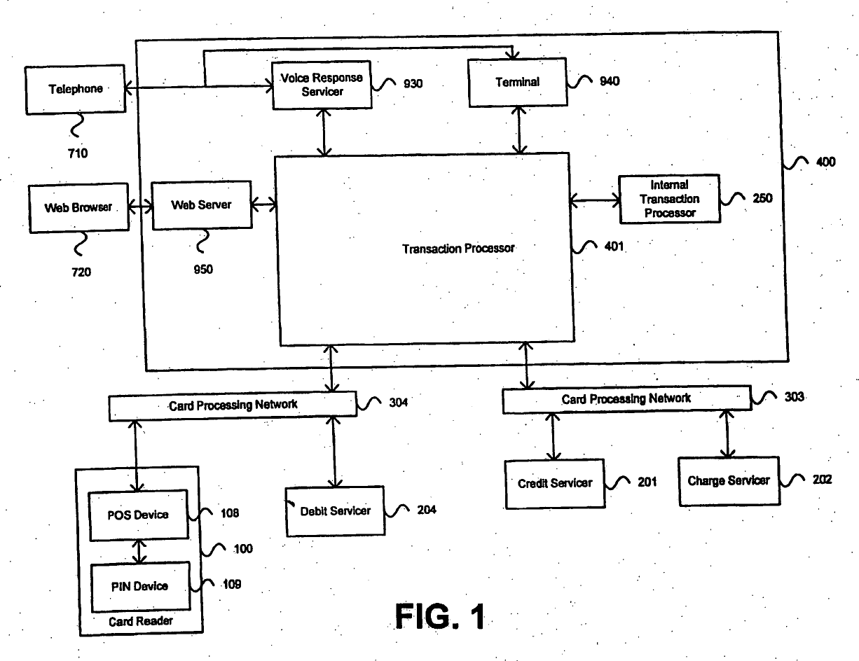

As shown in FIG. 1, an exemplary system and network configuration of the present invention includes a multiple account provider 400 comprising a multiple account transaction processor 400 (and optionally an internal transaction processor 250), one or more user interface systems, e.g., web server 950, voice response servicer 930; and/or a customer service terminal 940; one or more card processing networks 303 or 304; a credit servicer 201; charge servicer 202; debit servicer 204; and/or the like; and a card reader 100, which generally includes a POS device 108 and/or a PIN device 109.

In one embodiment, the cardholder may associate various transaction, global or cash accounts with the card number online. Examples of such elements, as shown in FIG. 1 are a web browser 720 connected to a web server 950 that provides forms for maintenance of multiple account associations and/or a telephone 710 connected to a voice response unit 930 that is capable of decoding spoken or DTMF touchpad tones that the cardholder enters in response to questions that support the maintenance of multiple account associations. Another example is a terminal, such as a computer workstation, or IBM 3270 style terminal, or any other type of display and input device, with which a multiple account provider service representative can perform maintenance of multiple account associations, presumably in response to verbal or written correspondence with the cardholder, as might occur over the telephone at an inbound call processing center. Any combination of elements can be used to create, maintain, and/or delete available account balance associations.

Various exemplary embodiments are contemplated by this invention. In one exemplary embodiment, as depicted in FIG. 1, the invention includes appropriate gateways to communicate with external transaction servicers via a card processing network 303 or 304 to service, for example debit, charge, or credit card accounts. Additionally, an internal transaction processor 250 is disclosed, wherein the internal processor 250 is part of the multiple account provider system and is configured to process card transactions internally.

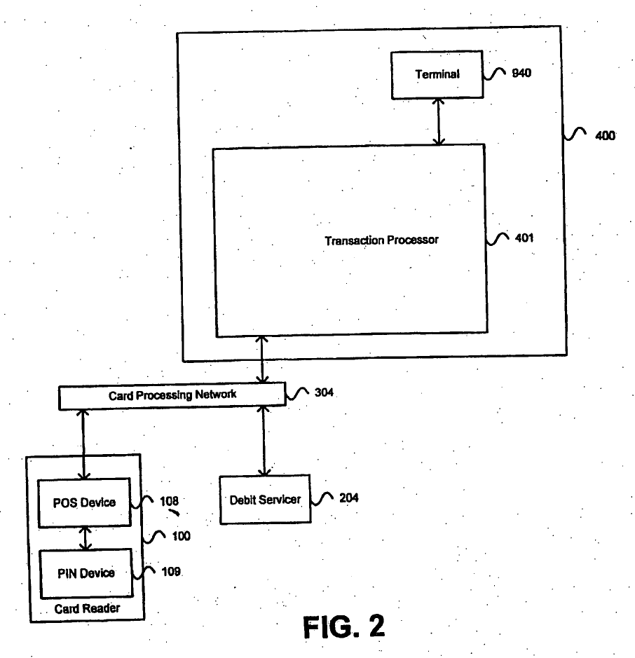

In the exemplary embodiment depicted in FIG. 2, the multiple account system is shown without the internal transaction processor shown in FIGS. 1, 3 and 4, and is configured specifically to support external transaction accounts, i.e., those not maintained and hosted by the multiple account provider. As such, one or more debit servicers 204 may facilitate the processing of transaction accounts not provided by the multiple account provider.

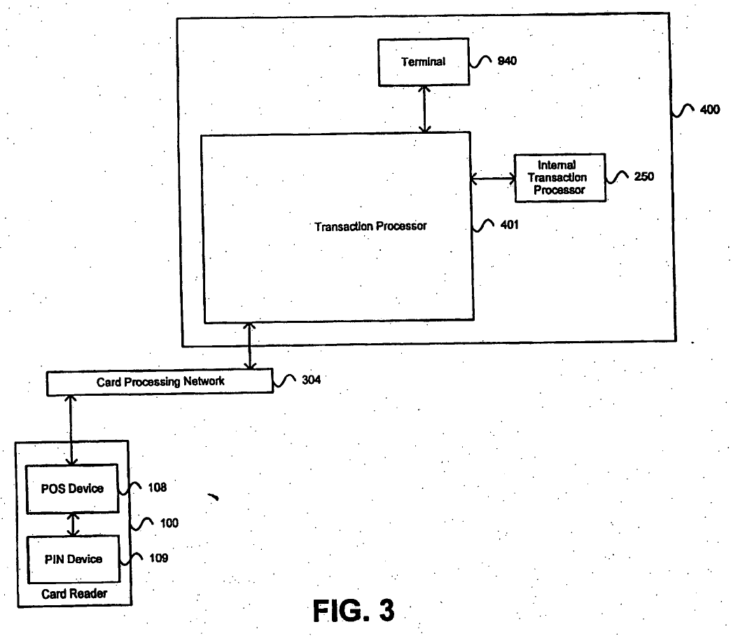

In another exemplary embodiment, where the multiple account number 10 is associated with two or more transaction accounts that are serviced by the subsystems that are internally accessible within the multiple account provider 400, an internal transaction processor 250 is utilized. As such, the architecture shown in FIG. 3 depicts an internal transaction processor 250. In this embodiment, two or more transaction accounts are associated with a cardholder's multiple account number 10. One or more internal transaction processors 250 service the transaction accounts. Transaction processors 250 may facilitate credit transactions, charge transactions, debit transactions, or other kinds of transactions from at least two of the multiple accounts.

In light of the above descriptions, a more detailed description of exemplary components and processes of the present invention is now described, wherein steps for enrolling cardholders, associating transaction accounts to PIN or other identification numbers, and using the multiple account to facilitate transaction events is contemplated.

Enrollment in the multiple account system and subsequent maintenance of the multiple accounts generally comprises elements to facilitate the creation, modification, and deletion of the associations of the multiple account card 5 to two or more transaction accounts. Enrollment establishes a multiple account, account for a cardholder and results in her possession of a multiple account 5 that is ready for card use. In an exemplary embodiment, a cardholder applies for the multiple account 5 using one or more of a variety of mechanisms, such as submission of an on-line form, mail of a paper form, telephone conversation with cardholder service representative, and/or telephone interaction with voice response unit.

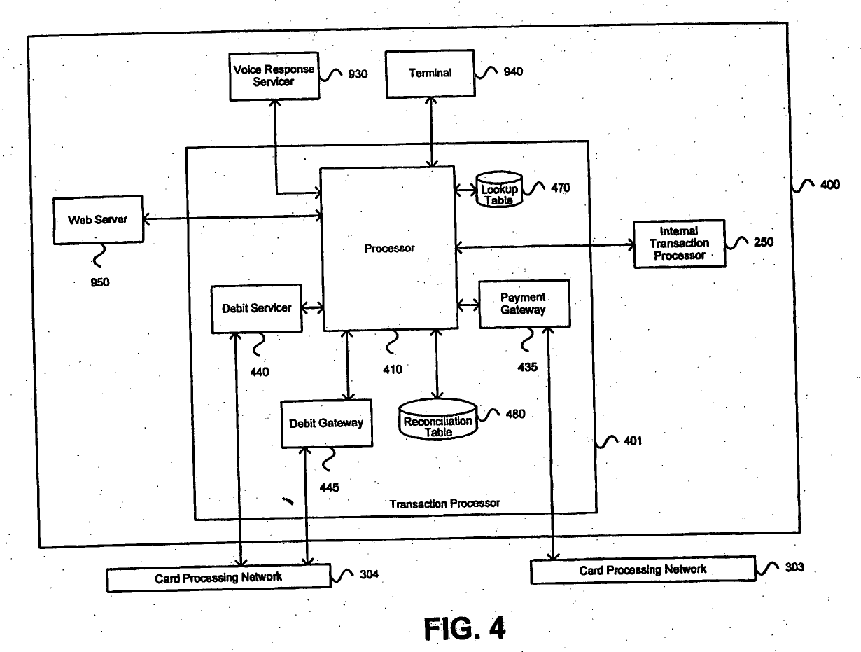

If the mechanism involves a cardholder service representative, then the cardholder service representative enters information into terminal 940. Otherwise, cardholder uses telephone 710 or web browser 720. If cardholder uses web browser 720, then web browser 720 interacts with web server 950. It should be appreciated that any number of means may be used to communicate enrollment data to the multiple account transaction processor 401. The enrollment information provided by the cardholder generally includes appropriate identifying information (e.g., name, addresses, social security number, etc.) so that initial fraud screening and credit determination can be performed. Processor 410 (FIG. 4) determines if the cardholder is to be provided a multiple account.

If the cardholder is to be provided a multiple account, then processor 410 initiates card issuance so that the cardholder will be sent the appropriate plastic card containing a magnetic stripe, smart chip, embossed numbers, and/or the like. The plastic card may be considered a debit card, in that it will later operate similarly to a debit card. In an alternative embodiment, as previously noted, the cardholder does not receive a plastic card; rather, the cardholder only receives a number, digital certificate, or other suitable identification indicia, which may be used online, for example, to facilitate an online transaction event.

In one embodiment, as shown in FIG. 4, the system comprises a lookup table 470 which may be pre-loaded with information about associated transaction accounts, wherein this information may have been previously provided during enrollment. The system may also store cardholder specific information that was provided during enrollment, or which was obtained from other sources, such as, for example: name, address, phone number, multiple account number, and activation information, etc. This information may be stored in a cardholder information table. The system may also store transaction details, which would be initialized during enrollment to contain no transaction records. This information is stored in a transaction record table.

After the cardholder receives the multiple account 5, activation may be desired before use of the multiple account 5 is permitted. Activation may be facilitated by any number of suitable means, for example: calling a cardholder service representative, calling a voice or touch-tone response system, accessing a web site, or any other mechanism in order to provide information about the card and/or cardholder so that the multiple account provider 400 has reasonable certainty that the card was received by the intended cardholder. In an exemplary embodiment, the cardholder calls from their home phone number of record, providing an activation code or account number that was delivered with the multiple account in the mail, possibly in combination with other identifying information such as social security number. The activation mechanism may also obtain information not provided directly by the cardholder by utilizing the communication device used by the cardholder for activation. For example, the activation mechanism may obtain further information from a telephone caller ID or Internet TCP/IP routing or address. After activation, the cardholder may proceed to the steps of card use and/or association of accounts.

Cardholders who are provided with a multiple account 5 may also be provided with authentication credentials for identity verification during subsequent processes. In an exemplary system, the enrolled cardholder is given an ID and password to be used upon subsequent access to the multiple account web site in order to gain access to screens that support multiple account processes. In an alternative embodiment, the cardholder may be prompted to select a password, or answer a secret question, where this information can be used during any or all of the mechanisms for providing information and requesting processes.

The cardholder communicates information to the multiple account processor 401 through one or more of a variety of mechanisms such as submission of on-line form, mail of a paper form, telephone conversation with cardholder service representative, or telephone interaction with voice or touch-tone response unit. The cardholder may be required to provide authentication credentials before proceeding with this process. In an exemplary embodiment, if the cardholder accesses and logs-in to a web site, an ID and password may be required, or an ID and password may be provided for subsequent use at the site, for example, in creating associations. The information provided by the cardholder generally includes: the account number of the transaction account to be associated and a PIN or other identification number 15, and may also include other information such as the name, expiration date, billing address, and other identifying information associated with the particular transaction account.

This information is processed by processor 410 (FIG. 4) to ensure validity and support for the desired transaction account. If supported, then processor 410 adds an association record to the lookup table 470. In an exemplary embodiment, lookup table 470 is a relational database such as Oracle, Sybase, IBM DB2, Microsoft SQL Server, etc., however, it may be any suitable storage system that resides in computer memory, magnetic disk storage, etc., and which optionally includes a database application service that is invoked by database access APIs which might comply with an established standard data access protocol such as SQL. The association record includes some or all of the information provided by the cardholder and may optionally include additional information that is obtained from other sources. In an exemplary embodiment, the association record stores the PIN number, selection card number and/or the account number of the associated transaction account.

Transaction Processor Capabilities

A discussion of the capabilities of the transaction processor will center on the varied parameters of the transaction processor. Understand that numerous examples will be presented using specific parameter values, where the values are highly variable, and where the specific values used in the actual examples are somewhat, if not absolutely, arbitrary and represent only a snapshot of a wider range. For example, a parameter value of 50% used in a given example could just as easily be 75%, 33.33%, or even 2%. Furthermore, a given ratio can be expressed and set using any mathematical expression or terminology, such as a percentage (50%), a fraction (½ or one-half), proportion (1 part available balance #1 to 2 parts available balance #2, or 1:2, or 1 to 2), an expression (use all cash balance, meaning 100% cash; or, use all credit balance meaning 100% credit), etc. With regard to threshold amounts, the threshold amounts presented in examples are arbitrary, meaning that, in reality, a threshold amount of $2 can be entered just as easily as a threshold amount of $25, $50, or $100.

Finally, it should be understood that the available account balances used in examples are readily interchangeable. For instance, a given example that illustrates 100% of a given transaction debiting an available cash balance can be easily revised so that the example shows 100% of a given transaction debiting an available credit balance.

RATIO USING TWO AVAILABLE ACCOUNT BALANCES—One such parameter of the transaction processor comprises having at least one ratio, where an end user can elect to have, for instance, 50% (one-half) of the transaction amount debiting an available cash balance, with the remaining 50% (one-half) debiting an available credit balance. While the examples presented have round U.S. dollar amounts, transactions in U.S. dollars certainly do occur in amounts where an odd dollar amount distributed amongst two or more available account balances would result in fractions of a cent. For example, an amount of $10.01 that is split in a 50/50 ratio amongst two accounts would ordinarily result in each account being debited $5 and one-half cent. Any desired workable solution to this situation may be employed, including where either of the two available account balances gets debited the extra cent, account balances alternate as to which account balance gets debited the extra cent, fractional cents are carried and readjusted at the end of the billing cycle, etc. The solution(s) to the fractional situation could be predetermined by the account provider, or could possibly even be selected by the end user. Also, when considering the examples that will be presented, remember that it is possible for embodiments comprising two available account balances to just as easily comprise two available cash balances (where headings could read “Cash #1” and “Cash #2”), or two available credit balances (where headings could read “Credit #1” and “Credit #2”), in place of the provided examples comprising one available cash balance and one available credit balance. A chart example, showing a month's worth of transactions, is as follows:

| Date | Description | Amount | Cash | Credit |
|---|---|---|---|---|
| 01-02 | Restaurant | 48.00 | 24.00 | 24.00 |
| 01-03 | Gasoline | 21.00 | 10.50 | 10.50 |
| 01-05 | Shoe Store | 36.00 | 18.00 | 18.00 |
| 01-06 | Supermarket | 63.00 | 31.50 | 31.50 |
| 01-14 | Gasoline | 15.00 | 7.50 | 7.50 |
| 01-18 | Appliance Store | 750.00 | 375.00 | 375.00 |
| 01-24 | Gasoline | 18.00 | 9.00 | 9.00 |
| 01-30 | Restaurant | 33.00 | 16.50 | 16.50 |
| | TOTAL | 984.00 | 492.00 | 492.00 |

The ratio using two available account balances can be set in any way, ranging anywhere from where 100% of a given transaction debits an available cash balance (all cash), to where 100% of the transaction debits an available credit balance (all credit), and any point between the two extremes.

Examples demonstrating 100% of a given available account balance, with varied circumstances, will now be presented.

RATIO USING TWO AVAILABLE ACCOUNT BALANCES—DEPLETION EXAMPLE—SPLIT TRANSACTIONS PERMITTED—This example shows where the end user uses a ratio of 100% of the available cash balance, but where, upon depletion of the cash balance, the end user not only permits the available credit balance to take over, but also permits a given transaction to be split between the available cash and the available credit balance. In this example, the card not only shifts seamlessly from acting as a debit card to acting as a credit card, but also does so during the transaction dated 01-05.

| | | | | |
|---|---|---|---|---|
| Date | Description | Amount | Cash | Credit |

AVAILABLE CASH BALANCE OF THE DEBIT CARD CASH
ACCOUNT - $100.00

| | | | | |
|---|---|---|---|---|
| 01-02 | Restaurant | 48.00 | 48.00 | -0- |
| 01-03 | Gasoline | 21.00 | 21.00 | -0- |
| 01-05 | Shoe Store | 36.00 | 31.00 | 5.00 |

AVAILABLE CASH DEPLETED - REMAINDER
TAKEN FROM AVAILABLE CREDIT BALANCE

| | | | | |
|---|---|---|---|---|
| 01-06 | Supermarket | 63.00 | -0- | 63.00 |
| 01-14 | Gasoline | 15.00 | -0- | 15.00 |
| 01-18 | Appliance Store | 750.00 | -0- | 750.00 |
| 01-24 | Gasoline | 18.00 | -0- | 18.00 |
| 01-30 | Restaurant | 33.00 | -0- | 33.00 |
| | TOTAL | 984.00 | 100.00 | 884.00 |

RATIO USING TWO AVAILABLE ACCOUNT BALANCES—DEPLETION EXAMPLE—SPLIT TRANSACTIONS NOT PERMITTED—The following example shows where the end user uses a ratio of 100% of the available cash balance, but where, upon depletion of the $100 cash balance, the end user permits the available credit balance to take over. However, in this example, the end user does not permit a given transaction to be split between the available cash and the available credit balance, and desires that the available cash balance is debited only if the amount in the cash account is enough to pay for a given transaction in full. In this example, the debiting of the varied available balances shifts back and forth between using available cash and available credit balances depending on the size of the transaction, as seen in the transaction dated 01-14.

| | | | | |
|---|---|---|---|---|
| Date | Description | Amount | Cash | Credit |

AVAILABLE CASH BALANCE OF THE DEBIT CASH
ACCOUNT PORTION - $100.00

| | | | | |
|---|---|---|---|---|
| 01-02 | Restaurant | 48.00 | 48.00 | -0- |
| 01-03 | Gasoline | 21.00 | 21.00 | -0- |
| 01-05 | Shoe Store | 36.00 | -0- | 36.00 |

AVAILABLE CASH ($31) IS LESS THAN TRANSACTION AMOUNT

| | | | | |
|---|---|---|---|---|
| 01-06 | Supermarket | 63.00 | -0- | 63.00 |
| 01-14 | Gasoline | 15.00 | 15.00 | -0- |
| 01-18 | Appliance Store | 750.00 | -0- | 750.00 |

AVAILABLE CASH ($16) IS LESS THAN TRANSACTION AMOUNT

| | | | | |
|---|---|---|---|---|
| 01-24 | Gasoline | 18.00 | -0- | 18.00 |
| 01-30 | Restaurant | 33.00 | -0- | 33.00 |
| | TOTAL | 984.00 | 84.00 | 900.00 |

RATIO USING TWO AVAILABLE ACCOUNT BALANCES—DEPLETION EXAMPLE MAINTAINING A MINIMUM BALANCE—SPLIT TRANSACTIONS PERMITTED—This example shows where the end user uses a ratio of 100% of the available cash balance, but where, upon depletion of the cash balance, the end user permits the available credit balance to take over, where the end user permits a given transaction to be split between the available cash and the available credit balance. However, in this example, the card shifts from using the available cash balance to using the available credit balance while withholding $20 from being used for purchase transactions. Here, a minimum amount is specified to the transaction processor. The transaction processor enables minimums to be maintained on any available account balance as specified by the end user and/or the card entity. There could be one or more of reasons why maintaining a minimum available balance may be desirable. For instance, the card entity may want a minimum cash balance on hand for whatever internal reasons; the end user may want a minimum cash balance on hand that allows an emergency ATM withdrawal without having to pay a cash advance fee, which would happen if a cash withdrawal was to occur on an account having a zero available cash balance; or, if the account was set up where funds from the cash balance are used to pay the minimum payment due on an outstanding credit balance, the end user may want a minimum cash balance on hand to cover the minimum payment due. Minimum available cash balances are also useful in direct deposit situations. For example, an end user that has a direct deposit that credits an available cash balance for $5000 may wish to have $2000 withheld from being used for purchase transactions, where the $2000 amount that is withheld is earmarked and used for writing a check against the available cash balance to pay a mortgage payment. Furthermore, minimum balances could be useful for available credit balances, whereas an end user that has an available credit balance (or “credit limit”) of, say, $7000 does not really wish to use more than $3000 of the available credit balance during any one billing cycle. Here, the end user would specify that he wants to maintain a minimum available credit balance of $4000. Other ways of stating this is where the end user specifies that he does not want to use the final $4000 of his available credit balance, or that he wants to consume no more than $3000 of his $7000 available credit balance.

| | | | | |
|---|---|---|---|---|
| Date | Description | Amount | Cash | Credit |

AVAILABLE CASH BALANCE - $100.00 CASH BALANCE NOT
PERMITED TO GO BELOW $20.00

| | | | | |
|---|---|---|---|---|
| 01-02 | Restaurant | 48.00 | 48.00 | -0- |
| 01-03 | Gasoline | 21.00 | 21.00 | 21.00 |
| 01-05 | Shoe Store | 36.00 | 11.00 | 25.00 |

$20 MINIMUM THRESHOLD REACHED - REMAINDER
TAKEN FROM AVAILABLE CREDIT BALANCE

| | | | | |
|---|---|---|---|---|
| 01-06 | Supermarket | 63.00 | -0- | 63.00 |
| 01-14 | Gasoline | 15.00 | -0- | 15.00 |
| 01-18 | Appliance Store | 750.00 | -0- | 750.00 |
| 01-24 | Gasoline | 18.00 | -0- | 18.00 |
| 01-30 | Restaurant | 33.00 | -0- | 33.00 |
| | TOTAL | 984.00 | 80.00 | 984.00 |

RATIO USING TWO AVAILABLE ACCOUNT BALANCES—DEPLETION EXAMPLE MAINTAINING A MINIMUM BALANCE—SPLIT TRANSACTIONS NOT PERMITTED—This example shows where the end user uses a ratio of 100% of the available cash balance, where upon depletion of the cash balance, the end user permits the available credit balance to take over; however, the end user does not allow transactions to be split between the available cash and the available credit balance in the event of a depleted account condition. This example also demonstrates $20 being withheld as a minimum cash balance amount that precludes the $20 from being used for purchase transactions. Being that split transactions are not permitted, the $11 cash balance is not used after the transaction dated 01-05 due to the fact that none of the month's remaining transactions are less than or equal to $11.

AVAILABLE CASH BALANCE OF THE DEBIT CASH
ACCOUNT PORTION - $100.00; CASH
BALANCE NOT PERMITTED TO GO BELOW $20.00

| Date | Description | Amount | Cash | Credit |
|---|---|---|---|---|
| 01-02 | Restaurant | 48.00 | 48.00 | -0- |
| 01-03 | Gasoline | 21.00 | 21.00 | -0- |
| 01-05 | Shoe Store | 36.00 | -0- | 36.00 |
| 01-05 | $11 AVAILABLE CASH ($31 minus $20 minimum | | | |
| | threshold) IS LESS THAN TRANSACTION AMOUNT | | | |
| 01-06 | Supermarket | 63.00 | -0- | 63.00 |
| 01-14 | Gasoline | 15.00 | -0- | 15.00 |
| 01-18 | Appliance Store | 750.00 | -0- | 750.00 |
| 01-24 | Gasoline | 18.00 | -0- | 18.00 |
| 01-30 | Restaurant | 33.00 | -0- | 33.00 |
| | TOTAL | 984.00 | 69.00 | 915.00 |

RATIO USING THREE AVAILABLE ACCOUNT BALANCES—More than two accounts can be employed in a given ratio, such as where 33.33% (one-third) of the transaction amount debits an available cash balance, 33.33% debits available credit balance #1, and 33.33% debits available credit balance #2, as will be seen in the following chart example for a month's transaction activity:

| | Description | Amount | Cash | Credit #1 | Credit #2 |
|---|---|---|---|---|---|
| 01-02 | Restaurant | 48.00 | 16.00 | 16.00 | 16.00 |
| 01-03 | Gasoline | 21.00 | 7.00 | 7.00 | 7.00 |
| 01-05 | Shoe Store | 36.00 | 12.00 | 12.00 | 12.00 |
| 01-06 | Supermarket | 63.00 | 21.00 | 21.00 | 21.00 |
| 01-14 | Gasoline | 15.00 | 5.00 | 5.00 | 5.00 |
| 01-18 | Appliance Store | 750.00 | 250.00 | 250.00 | 250.00 |
| 01-24 | Gasoline | 18.00 | 6.00 | 6.00 | 6.00 |
| 01-30 | Restaurant | 33.00 | 11.00 | 11.00 | 11.00 |
| | TOTAL | 984.00 | 328.00 | 328.00 | 328.00 |

Another parameter of the transaction processor comprises having at least one amount threshold, where an end user can elect to have all transactions up to, say, $50 debit an available cash balance, and have all transactions above $50 debit an available credit balance.

AMOUNT THRESHOLD USING TWO AVAILABLE ACCOUNT BALANCES—Transactions up to $50 are debited from the available cash balance using a 100% ratio while transactions above $50 are debited from the available credit balance using a 100% ratio (all credit)—

| Date | Description | Amount | Cash | Credit |
|---|---|---|---|---|
| 01-02 | Restaurant | 48.00 | 48.00 | -0- |
| 01-03 | Gasoline | 21.00 | 21.00 | -0- |
| 01-05 | Shoe Store | 36.00 | 36.00 | -0- |
| 01-06 | Supermarket | 63.00 | -0- | 63.00 |
| 01-14 | Gasoline | 15.00 | 15.00 | -0- |
| 01-18 | Appliance Store | 750.00 | -0- | 750.00 |
| 01-24 | Gasoline | 18.00 | 18.00 | -0- |
| 01-30 | Restaurant | 33.00 | 33.00 | -0- |
| | TOTAL | 984.00 | 171.00 | 813.00 |

In the above example, remember that it is just as easy to set the parameters of the transaction processor to where transactions up to $50 are debited from the available credit balance using a 100% ratio (all credit), while transactions above $50 are debited from the available cash balance using a 100% ratio (all cash).

Taking the example further, more than one amount threshold can be used, using two accounts (one available cash balance, one available credit balance), where the varied thresholds comprise different ratios (hence the term at least one ratio). For example, the transaction processor can be set to where all transactions up to $50 debit the available cash balance using a 100% ratio (all cash); for transactions above $50 and up to $100, 50% is debited from the available cash balance while 50% is debited from the available credit balance; and all transactions above $100 debit the available credit balance using a 100% ratio (all credit).

Using these particular parameters, an individual can go out for lunch, and by swiping the card at a point-of-sale can have the $12 cost of a lunch debited only from his available cash balance; then, by swiping the same card at another point-of-sale can have the $70 cost of a pair of shoes debited in equal amounts from his available cash balance and available credit balance; then, by swiping the same card at yet another point-of-sale can have the $1500 cost of a laptop computer be debited only from his available credit balance. Be reminded that the parameters comprising the transaction processor handled the varied accounts debiting without any account selection or purchase payment division taking place or being necessary at any of the points-of-sale. Also, in the case of the 50/50 available cash balance/available credit balance transaction, two separate account balances were debited using only one swipe of the card, and with no special instructions needing to be entered at the point-of-sale terminal. Also notable is the fact that the nature of the actual varied accounts being debited (available cash balance versus available credit balance) in each of the three transactions was absolutely invisible to each of the point-of-sale merchants. For the purposes of disclosure, it should be mentioned that while it is highly advantageous and preferable for no special instructions needing to be entered at the point-of-sale terminal, it is nonetheless possible for embodiments to exist, although less preferable, where point-of-sale terminals enable end user to make parameter adjustments or changes, and/or enable account balance selection, with regard to the present invention.

MORE THAN ONE AMOUNT THRESHOLD USING VARIED RATIOS AND TWO AVAILABLE ACCOUNT BALANCES—For transactions up to and including $50, 100% of the transaction is debited from the available cash balance (all cash). For transactions above $50 up to $100, 50% of the transaction is debited from the available cash balance while 50% is debited from the available credit balance. For transactions above $100, 100% of the transaction is debited from the available credit balance (all credit).

| Date | Description | Amount | Cash | Credit |
|---|---|---|---|---|
| 01-02 | Restaurant | 48.00 | 48.00 | -0- |
| 01-03 | Gasoline | 21.00 | 21.00 | -0- |
| 01-05 | Shoe Store | 36.00 | 36.00 | -0- |
| 01-06 | Supermarket | 63.00 | 31.50 | 31.50 |
| 01-14 | Gasoline | 15.00 | 15.00 | -0- |
| 01-18 | Appliance Store | 750.00 | -0- | 750.00 |
| 01-24 | Gasoline | 18.00 | 18.00 | -0- |
| 01-30 | Restaurant | 33.00 | 33.00 | -0- |
| | TOTAL | 984.00 | 202.50 | 781.50 |

A slightly more complex example is where transactions up to and including $50 have 50% of the transaction debited from the available cash balance while 50% is debited from the available credit balance. For transactions above $50, 25% (one-quarter) is debited from the available cash balance while 75% (three-quarters) is debited from the available credit balance.

| Date | Description | Amount | Cash | Credit |
|---|---|---|---|---|
| 01-02 | Restaurant | 48.00 | 24.00 | 24.00 |
| 01-03 | Gasoline | 21.00 | 10.50 | 10.50 |
| 01-05 | Shoe Store | 36.00 | 18.00 | 18.00 |
| 01-06 | Supermarket | 63.00 | 15.75 | 47.25 |
| 01-14 | Gasoline | 15.00 | 7.50 | 7.50 |
| 01-18 | Appliance Store | 750.00 | 187.50 | 562.50 |
| 01-24 | Gasoline | 18.00 | 9.00 | 9.00 |
| 01-30 | Restaurant | 33.00 | 16.50 | 16.50 |
| | TOTAL | 984.00 | 288.75 | 695.25 |

Another system component of debiting available account balances is by using what will be known as the remainder threshold. An example will be presented using two accounts (one available cash balance, one available credit balance). In a simple example, all transactions up to $50 debit the available cash balance using a 100% ratio (all cash); for transactions above $50, the first $50 is debited from the available cash balance, while 100% the remainder amount above the first $50 (the total amount minus the first $50) is debited from the available credit balance. Taking the example further, an additional remainder threshold can be placed resulting where the first $50 of a transaction is debited from the available cash balance, while the remainder amount above the first $50 but below, say, the first $100 (the total amount minus the first $50) uses a ratio where 50% of the remainder debited from the available cash balance, and 50% of the remainder debited from the available credit balance; while any remainder above the first $100 debits the available credit balance using a 100% ratio (all credit).

Reiterating the earlier example using these particular parameters, the individual swiping the card at a point-of-sale at lunch can have the $12 cost of the lunch debited only from his available cash balance; then, when swiping the same card at another point-of-sale, the $70 cost of a pair of shoes has the first $50 debited from the available cash balance, and the remainder of $20 debited in equal amounts from his available cash balance and available credit balance ($10 each account), with the end result being that the $70 transaction has $60 (the first $50 plus half of the remainder amount above $50, which is $10; $50+$10=$60) debited from the available cash balance, with the remaining $10 being debited from the available credit balance; then, by swiping the same card at yet another point-of-sale for the $1500 laptop computer purchase, the first $50 is debited from the available cash balance, whereas the remainder amount after the first $50 up to the first $100 has a 50/50 available cash/available credit account debit, whereas the $1400 remainder amount above the first $100 debits only the available credit balance. The end result for the laptop purchase has the transaction debiting $75 of the available cash balance (the first $50, plus half of the remainder amount above $50 up to $100, which is $25; $50+$25=$75), and $1425 debiting the available credit balance (half of the remainder amount above $50 up to $100, which is $25, and all of the remainder amount above $100, which is $1400; $25+$1400=$1425).

REMAINDER THRESHOLD USING TWO AVAILABLE BALANCES—Transaction amounts up to $30 are debited from the available cash balance while remainder amounts above $30 are debited from the available credit balance—

| Date | Description | Amount | Cash | Credit |
|---|---|---|---|---|
| 01-02 | Restaurant | 48.00 | 30.00 | 18.00 |
| 01-03 | Gasoline | 21.00 | 21.00 | -0- |
| 01-05 | Shoe Store | 36.00 | 30.00 | 6.00 |
| 01-06 | Supermarket | 63.00 | 30.00 | 33.00 |
| 01-14 | Gasoline | 15.00 | 15.00 | -0- |
| 01-18 | Appliance Store | 750.00 | 30.00 | 720.00 |
| 01-24 | Gasoline | 18.00 | 18.00 | -0- |
| 01-30 | Restaurant | 33.00 | 30.00 | 3.00 |
| | TOTAL | 984.00 | 204.00 | 780.00 |

As analogous to earlier examples, the transaction processor can just as easily be set to where transaction amounts up to $30 are debited from the available credit balance while remainder amounts above $30 are debited from the available cash balance.

It could be desirable to combine aspects of amount threshold and remainder threshold. For instance, using an available cash balance and an available credit balance, the transaction processor could be set up where transactions up to and including $100 have, say, the first $30 of the transaction debited from the available cash balance, and have any remainder amount above $30 debited from the available credit balance, whereas transactions over $100 have the total amount debited entirely from the available credit balance, with no part of the transaction amount being debited from the available cash balance.

COMBINATION AMOUNT THRESHOLD AND REMAINDER THRESHOLD USING TWO AVAILABLE BALANCES—Transaction amounts up to $30 are debited from the available cash balance while remainder amounts above $30 up to $100 are debited from the available credit balance, while transactions over $100 have the entire amount debited from only the available credit balance—

| Date | Description | Amount | Cash | Credit |
|---|---|---|---|---|
| 01-02 | Restaurant | 48.00 | 30.00 | 18.00 |
| 01-03 | Gasoline | 21.00 | 21.00 | -0- |
| 01-05 | Shoe Store | 36.00 | 30.00 | 6.00 |
| 01-06 | Supermarket | 63.00 | 30.00 | 33.00 |
| 01-14 | Gasoline | 15.00 | 15.00 | -0- |
| 01-18 | Appliance Store | 750.00 | -0- | 750.00 |
| 01-24 | Gasoline | 18.00 | 18.00 | -0- |
| 01-30 | Restaurant | 33.00 | 30.00 | 3.00 |
| | TOTAL | 984.00 | 174.00 | 810.00 |

Amount threshold and remainder threshold features of the transaction processor may each be used in terms of more than two available account balances.

MORE THAN ONE AMOUNT THRESHOLD USING THREE AVAILABLE ACCOUNT BALANCES—Transactions up to and including $50 are debited from the available cash balance, while transactions above $50 and up to $100 are debited from available credit balance #1, while transactions over $100 are debited from available credit balance #2—

| Date | Description | Amount | Cash | Credit #1 | Credit #2 |
|---|---|---|---|---|---|
| 01-02 | Restaurant | 48.00 | 48.00 | -0- | -0- |
| 01-03 | Gasoline | 21.00 | 21.00 | -0- | -0- |
| 01-05 | Shoe Store | 36.00 | 36.00 | -0- | -0- |
| 01-06 | Supermarket | 63.00 | -0- | 63.00 | -0- |
| 01-14 | Gasoline | 15.00 | 15.00 | -0- | -0- |
| 01-18 | Appliance Store | 750.00 | -0- | -0- | 750.00 |
| 01-24 | Gasoline | 18.00 | 18.00 | -0- | -0- |
| 01-30 | Restaurant | 33.00 | 33.00 | -0- | -0- |
| | TOTAL | 984.00 | 171.00 | 63.00 | 750.00 |

MORE THAN ONE REMAINDER THRESHOLD USING THREE AVAILABLE ACCOUNT BALANCES—An example using remainder thresholds for three available account balances is where all transaction amounts up to $50 debit an available cash balance, any remainder amounts above $50 up to $100 debit available credit balance #1, and any remainder amounts above $100 debit available credit balance #2. Using these particular parameters, a single transaction for $150 would be spread across three separate available balances, with the first $50 portion of the transaction debiting the available cash balance, the second $50 portion debiting available credit balance #1, and the final $50 portion debiting available credit balance #2. Analogous use of any abovementioned parameters may be adapted for embodiments employing any number and kind of available account balances.

| Date | Description | Amount | Cash | Credit #1 | Credit #2 |
|---|---|---|---|---|---|
| 01-02 | Restaurant | 48.00 | 48.00 | -0- | -0- |
| 01-03 | Gasoline | 21.00 | 21.00 | -0- | -0- |
| 01-05 | Shoe Store | 36.00 | 36.00 | -0- | -0- |
| 01-06 | Supermarket | 63.00 | 50.00 | 13.00 | -0- |
| 01-14 | Gasoline | 15.00 | 15.00 | -0- | -0- |
| 01-18 | Appliance Store | 750.00 | 50.00 | 50.00 | 650.00 |
| 01-24 | Gasoline | 18.00 | 18.00 | -0- | -0- |
| 01-30 | Restaurant | 33.00 | 33.00 | -0- | -0- |
| | TOTAL | 984.00 | 271.00 | 63.00 | 650.00 |

Note that the transaction dated 01-06 made use of two available account balances while the transaction dated 01-18 made use of all three available account balances.

AMOUNT THRESHOLD AND RATIO ILLUSTRATION USING FOUR AVAILABLE ACCOUNT BALANCES—This example is provided to demonstrate that the transaction processor can manage basically one or more available account balances and blending of parameters. For transactions up to $50, 50% of the transaction is debited from available cash balance #1, while 50% is debited from available credit balance #1; however, transactions above $50 have 25% of the transaction debited from available cash balance #2, while the remaining 75% is debited from the available credit balance #2—

| | | | | | Credit | Credit |
|---|---|---|---|---|---|---|
| Date | Description | Amount | Cash#1 | Cash#2 | #1 | #2 |
| 01-02 | Restaurant | 48.00 | 24.00 | -0- | 24.00 | -0- |
| 01-03 | Gasoline | 21.00 | 10.50 | -0- | 10.50 | -0- |
| 01-05 | Shoe Store | 36.00 | 18.00 | -0- | 18.00 | -0- |
| 01-06 | Supermarket | 63.00 | -0- | 15.75 | -0- | 47.25 |
| 01-14 | Gasoline | 15.00 | 7.50 | -0- | 7.50 | -0- |
| 01-18 | Appliance Store | 750.00 | -0- | 187.50 | -0- | 562.50 |
| 01-24 | Gasoline | 18.00 | 9.00 | -0- | 9.00 | -0- |
| 01-30 | Restaurant | 33.00 | 16.50 | -0- | 16.50 | -0- |
| | TOTAL | 984.00 | 85.50 | 203.25 | 85.50 | 609.75 |

Debiting Criteria Based on Available Account Balance Threshold Amount and/or Account Usage/Consumption Threshold Amount

AVAILABLE ACCOUNT BALANCE THRESHOLD ILLUSTRATION TO DETERMINE ACCOUNT DEBITING USING AN AVAILABLE CASH BALANCE AND AN AVAILABLE CREDIT BALANCE—Unlike the above examples that utilize the transaction amount threshold to determine account-debiting parameters, this example uses an available account balance threshold illustrating the use of amount threshold criteria on an available cash balance to determine account-debiting parameters. If the available cash balance prior to the transaction is greater than or equal to $400.00, then the available cash balance is debited; should the available cash balance fall below $400.00, but is greater than or equal to $100.00, then the transaction will debit 50% of the available cash balance and 50% of the available credit balance; finally, should the available cash balance fall below $100.00, then transactions will debit the available credit balance only. Keep in mind that all amount parameters are revisable at will.

| | | | | | |
|---|---|---|---|---|---|
| | | | Avail. | Cash | Credit |
| Date | Description | Amount | Cash Bal. | Debited | Debited |

Prior to Transaction

| | | | | | |
|---|---|---|---|---|---|
| 01-02 | Restaurant | 48.00 | 500.00 | 48.00 | -0- |
| 01-03 | Gasoline | 21.00 | 452.00 | 21.00 | -0- |
| 01-05 | Shoe Store | 36.00 | 431.00 | 36.00 | -0- |
| 01-06 | Supermarket | 63.00 | 395.00 | 31.50 | 31.50 |
| 01-14 | Gasoline | 15.00 | 363.50 | 7.50 | 7.50 |
| 01-18 | Appliance Store | 650.00 | 356.00 | 325.00 | 325.00 |
| 01-24 | Gasoline | 18.00 | 31.00 | -0- | 18.00 |
| 01-30 | Restaurant | 33.00 | 31.00 | -0- | 33.00 |
| | TOTAL | 884.00 | — | 469.00 | 415.00 |

Note that all transactions debited only the available cash balance until the balance dropped below the $400.00 threshold after the 01-05 transaction. From there the transactions debited 50% available cash balance and 50% available credit balance until the available cash balance dipped below the $100.00 threshold after the 01-18 transaction, which resulted in having subsequent transactions debit only the available credit balance. In situations where deposits increase the available cash balance, the transaction processor will debit the accounts in accordance with the parameters in place; so, in this case, should a cash deposit be restored to $400.00 or more, then the transactions will debit the available cash balance only, until the cash balance drops below the $400.00 threshold. As the available cash balance decreases, the reliance on the available credit balance increases. Although in the above example what determines account-debiting parameters is the available cash balance, at least one of any available balance comprising the global account may be used as a determinant. Furthermore, more than one account can have such a condition tied to it, so a given transaction could trigger multiple conditions affecting account debiting in more that one available account balance, which would affect how the available account balances are debited. For example, if the transaction processor is instructed where an available cash balance is below a certain level, and available credit balance #1 is below a certain level, then the transaction will debit available credit balance #2; or, if the available cash balance is above “X” amount, and the available credit balance is below “Y” amount, then one set of account debiting parameters come into play, such as a ratio per the above examples, where if the available cash balance falls below “X” amount and the available credit balance rises above “Y” amount due to a payment, then a totally different parameter set is effected.

AVAILABLE ACCOUNT BALANCE USAGE OR CONSUMPTION THRESHOLD AMOUNT TO DETERMINE ACCOUNT DEBITING USING AN AVAILABLE CASH BALANCE AND AN AVAILABLE CREDIT BALANCE—Another dynamic is based on usage or consumption of one or more available balance(s), where such usage thresholds (which may be during a specified period, or even cumulatively), trigger a change in account debiting parameters. For example, once the available credit balance usage reaches $1,000.00, one set of account debiting parameters can be used, whereas once the available credit balance usage reaches $3,000.00, another set of account debiting parameters can be used. Such a capability may also be used in tandem with available account balance threshold criteria as well. The following example illustrates where an end user wants transactions to debit the available cash balance for a maximum of $150 every calendar month, then debit the available credit balance for the remainder of the month once the $150 usage or consumption of the available cash balance has occurred.

| Date | Description | Amount | Cash | Credit |
|---|---|---|---|---|
| 01-02 | Restaurant | 48.00 | 48.00 | -0- |
| 01-03 | Gasoline | 21.00 | 21.00 | -0- |
| 01-05 | Shoe Store | 36.00 | 36.00 | -0- |
| 01-06 | Supermarket | 45.00 | 45.00 | -0- |

USER SPECIFIED $150 CASH BALANCE CONSUMPTION LIMIT
IS REACHED

| | | | | |
|---|---|---|---|---|
| 01-14 | Gasoline | 15.00 | -0- | 15.00 |
| 01-18 | Appliance Store | 750.00 | -0- | 750.00 |
| 01-24 | Gasoline | 24.00 | -0- | 24.00 |
| 01-30 | Restaurant | 45.00 | -0- | 45.00 |
| | TOTAL | 984.00 | 150.00 | 834.00 |

As discussed earlier in the disclosure, and per the above example, it may be desirable to split a transaction between two available balances in order to arrive at the precise $150 cash balance consumption limit. Also, per the earlier discussion, should split transactions be undesirable or otherwise not permitted, the debiting of the varied available balances shifts back and forth between using available cash and available credit balances, depending on the size of the transaction, until the $150 cash balance consumption limit is reached using only full, non-split transactions.

AVAILABLE ACCOUNT BALANCE AMOUNT THRESHOLD ILLUSTRATION TO DETERMINE ACCOUNT DEBITING USING AN AVAILABLE CASH BALANCE AND AN AVAILABLE CREDIT BALANCE, WITH AN ADDITIONAL TRANSACTION AMOUNT THRESHOLD CONDITION—This example uses available cash balance threshold criteria to determine account debiting, with an additional transaction amount threshold condition. What is very important to note here is that multiple account determinant parameters, such as available account balance level, transaction level, etc. may be used simultaneously. In this example, if the available cash balance prior to the transaction is greater than or equal to $400.00, then the available cash balance is debited; should the available cash balance fall below $400.00, but is greater than or equal to $100.00, then the transaction will debit 50% of the available cash balance and 50% of the available credit balance; then, should the available cash balance fall below $100.00, then transactions will debit the available credit balance only; finally, if the transaction amount threshold is $1000.00 or above, the transaction processor is set to debit the available credit balance regardless of the predetermined account balance parameters. Again, all parameters are revisable at will.

| | | | | | |
|---|---|---|---|---|---|
| | | | Avail. | Cash | Credit |
| Date | Description | Amount | Cash Bal. | Debited | Debited |

Prior to Trans.

| | | | | | |
|---|---|---|---|---|---|
| 01-02 | Restaurant | 48.00 | 500.00 | 48.00 | -0- |
| 01-03 | Gasoline | 21.00 | 452.00 | 21.00 | -0- |
| 01-05 | Shoe Store | 36.00 | 431.00 | 36.00 | -0- |
| 01-06 | Supermarket | 63.00 | 395.00 | 31.50 | 31.50 |
| 01-14 | Gasoline | 15.00 | 363.50 | 7.50 | 7.50 |
| 01-18 | Appliance Store | 650.00 | 356.00 | 325.00 | 325.00 |
| 01-20 | Furniture Store | 1,100.00 | 31.00 | -0- | 1,100.00 |
| 01-24 | Gasoline | 18.00 | 31.00 | -0- | 18.00 |
| 01-30 | Restaurant | 33.00 | 31.00 | -0- | 33.00 |
| | TOTAL | 1,984.00 | — | 469.00 | 1,515.00 |

Note that all transactions debited only the available cash balance until the balance dropped below the $400.00 threshold after the 01-05 transaction. From there the transactions debited 50% available cash balance and 50% available credit balance until after the 01-18 transaction, where the available cash balance fell below the $100.00 threshold, causing the subsequent transactions to be debited from only the available credit balance. The 01-20 transaction for $1100.00 exceeded the transaction amount threshold of $1000.00 (amount thresholds were discussed in earlier examples), so, in this instance, the debiting parameters based on available cash balance were overridden by the amount threshold parameter. As with all examples herein, “Best Fit” and “Rescue or Reject” criteria as disclosed in the above examples may be employed. For example, if a transaction exceeds its allotted ratio of the available cash balance and attempts to debit an inadequate available credit balance, the transaction processor can attempt to rescue the transaction by using the available cash balance for the entire transaction amount, or for only the amount of the available credit balance's shortfall. Although in the above example the ratio is tied to the available cash balance, such a ratio may be tied to any available balance comprising the global account.

Debiting Criteria Based on Pre-Transaction or Post-Transaction Available Balance

In earlier examples regarding available balance criteria for transaction debiting, criteria for debiting available balances were based on the amount of the available balance prior to the newly presented transaction, meaning that the transaction processor looked at the pre-transaction available balance(s) in question to determine how the transaction would debit the available balance(s). This is referred to as pre-transaction available balance criteria, as in prior to the newly presented transaction at a point-of-sale the account balance(s) criteria dictate to the transaction processor that certain account debiting parameters are used to debit the newly presented transaction.

The transaction processor may be set to recognize post-transaction available balance criteria as well. In such instances, a current set of parameters is in place. Based on those current parameters, if a newly presented transaction causes the available balance(s) to fall below a threshold, then a different set of account debiting parameters or criteria are to be used, as may be seen in the following examples.

In this first example of post-transaction available balance criteria, if the debit amount of a newly presented transaction at a point-of-sale will allow the available cash balance to remain above the $400.00 threshold, then the available cash balance is debited; if the debit amount of a newly presented transaction will cause the available cash balance fall below the $400.00 threshold, then the transaction will debit the available credit balance only. Such a condition can apply to any kind of available account balance, and not just the available cash balance used herein as an example. Also, per the transaction processor, one or more condition(s) may apply to one or more available account balance(s).

| | | | Post-Trans. | | |
|---|---|---|---|---|---|
| | | | Available | Cash | Credit |
| Date | Description | Amount | Cash Bal. | Debited | Debited |
| 01-02 | Restaurant | 48.00 | 500.00 | 48.00 | -0- |
| 01-03 | Gasoline | 21.00 | 479.00 | 21.00 | -0- |
| 01-05 | Shoe Store | 36.00 | 443.00 | 36.00 | -0- |
| 01-06 | Supermarket | 63.00 | 443.00*** | -0- | 63.00 |
| 01-14 | Gasoline | 15.00 | 428.00 | 15.00 | -0- |
| 01-18 | Appliance Store | 650.00 | 428.00*** | -0- | 650.00 |
| 01-24 | Gasoline | 18.00 | 410.00 | 18.00 | -0- |
| 01-30 | Restaurant | 33.00 | 410.00*** | -0- | 33.00 |
| | TOTAL | 884.00 | — | 138.00 | 746.00 |

***Transaction amount will cause the available cash balance to fall below the $400.00 threshold; therefore, the transaction amount is debited from the available credit balance instead.

The transactions of 01-06, 01-18, and 01-30 debited only the available credit balance due to the fact that an attempt to debit the amounts from the available cash balance caused the available cash balance to dip below the $400.00 threshold, which was the established condition for debiting the available credit balance.

Another post-transaction available balance criteria example involves a 50/50 ratio where if the 50% of the debit amount of a newly presented transaction at a point-of-sale will allow the available cash balance to remain above the $400.00 threshold, then the transaction will debit 50% available cash balance and debit 50% available credit balance; if the debit amount of a newly presented transaction will cause the available cash balance fall below the $400.00 threshold, then the transaction will debit the available credit balance only.

| | | | Post-Trans. | | |
|---|---|---|---|---|---|
| | | | Available | Cash | Credit |
| Date | Description | Amount | Cash Bal. | Debited | Debited |
| 01-02 | Restaurant | 48.00 | 500.00 | 24.00 | 24.00 |
| 01-03 | Gasoline | 21.00 | 489.50 | 10.50 | 10.50 |
| 01-05 | Shoe Store | 36.00 | 471.50 | 18.00 | 18.00 |
| 01-06 | Supermarket | 63.00 | 440.00 | 31.50 | 31.50 |
| 01-14 | Gasoline | 15.00 | 432.50 | 7.50 | 7.50 |
| 01-18 | Appliance Store | 650.00 | 432.50*** | -0- | 650.00 |
| 01-24 | Gasoline | 18.00 | 423.50 | 9.00 | 9.00 |
| 01-30 | Restaurant | 60.00 | 423.50*** | -0- | 60.00 |
| | TOTAL | 911.00 | — | 100.50 | 810.50 |

***Transaction amount will cause the available cash balance to dip below the $400.00 threshold; therefore, the transaction amount is debited from the available credit balance only.

All transactions debited 50% of their amounts from the available credit balance and 50% of their amounts from the available cash balance except for the 01-18 transaction, where 50% of the $650.00 transaction amount ($325.00) would have caused the available cash balance to fall below $400.00; and the 01-30 transaction, where 50% of the $60.00 transaction amount ($30.00) would have also caused the available cash balance to fall below $400.00. As a result per the established condition, both the 01-18 and 01-30 transaction amounts were debited from the available credit balance only.

As a clarification, pre-transaction available balance criteria looks at the available balance(s) to which conditions are attached to determine the parameters the transaction processor will use to debit the available account balance(s); whereas post-transaction available balance criteria first looks at how the presented transaction will affect the available balance(s) to which conditions are attached, and then decides how the transaction processor will debit the available account balance(s). Furthermore, available balance criteria per the transaction processor can comprise conditions using both pre-transaction and post-transaction available balance criteria, with or without additional criteria for the transaction processor such as transaction amount.

Transaction processor available balance debiting criteria may be based on any aspect of one or more available balances, and/or on consumption or usage of one or more available balances. Although available cash and available credit balances are cited specifically in the following examples, examples may be retrofitted using any nature of available balances, ratio (percentage) criteria, conditions, etc.

Debiting Criteria Based on Percentage (Ratio) of Available Balance Criteria and/or Usage/Consumption Criteria in Relation to Transaction Amount

Transaction amount in relation to a ratio (percentage) of one or more available balance level(s). Example: If a transaction amount is less than or equal to 10% of the available cash balance, then debit the transaction amount from the available cash balance; if a transaction amount is greater than 10% of the available cash balance, then debit the transaction amount from the available credit balance.

Transaction amount in relation to a ratio (percentage) of the total available balance of all available account balances. Example: If a transaction amount is less than or equal to 10% of the total available balances of all available account balances, then debit the transaction amount from the available cash balance; if a transaction amount is greater than 10% of the total available balances of all available account balances, then debit the transaction amount from the available credit balance.

Transaction amount in relation to a ratio (percentage) of one or more average available balances(s) over any time interval (such as the average monthly available cash balance). During a given time period such as a month, the average monthly available balance is a static amount figure that does not fluctuate with a given transaction the same way that an ordinary available balance does. Example: If a transaction amount is less than or equal to 15% of the average monthly available cash balance, then debit the transaction amount from the available cash balance; if a transaction amount is greater than 15% of the average monthly available cash balance, then debit the transaction amount from the available credit balance.

Transaction amount in relation to a ratio (percentage) of a “high water” mark (highest level) of one or more available balances. During a given time period, a “high water” mark may be static, or may fluctuate if there is an instance of a cash deposit (affecting the “high water” mark of an available cash balance) or an increase in a credit balance's credit limit (affecting the “high water” mark of an available credit balance). Such a “high water” mark is not affected per se by a transaction debiting an available balance. Example: If a transaction amount is less than or equal to 20% of the “high water” mark for the month of the available cash balance, then debit the transaction amount from the available cash balance; if a transaction amount is greater than 20% of the “high water” mark for the month of the available cash balance, then debit the transaction amount from the available credit balance.

Transaction amount in relation to a ratio (percentage) of total usage or consumption, or total average usage or consumption (in terms of credit balances, sometimes referred to as an “average revolving balance”) of one or more available balance(s) over any time interval (such as average monthly consumption of an available cash balance). Total usage or consumption will tend to fluctuate whereas average total usage or consumption will tend to be a static average, and will not be affected per se by a given transaction debiting an available balance. Example: If a transaction amount is less than or equal to 20% of the total monthly average consumption or usage of the available cash balance, then debit the transaction amount from the available cash balance; If a transaction amount is greater than 20% of the total monthly average consumption or usage of the available cash balance, then debit the transaction amount from the available credit balance.

Transaction amount in relation to a ratio (percentage) of total usage or consumption (or total average usage or consumption) of all available balances over any time interval (such as average monthly consumption of all available balances). Example: If a transaction amount is less than or equal to 20% of the total monthly average consumption or usage of all available balances, then debit the transaction amount from the available cash balance; If a transaction amount is greater than 20% of the total monthly average consumption or usage of all available balances, then debit the transaction amount from the available credit balance.

Transaction amount in relation to a ratio (percentage) of any balance criteria and/or usage/consumption criteria using additional remainder criteria (per the above examples) where if the transaction amount exceeds a ratio (percentage) of the above criteria, then any of the transaction amount up to the ratio (percentage) debits the available balance(s) according to a primary criteria, whereas the remainder that exceeds the ratio (percentage) debits the available balances according to a secondary criteria. Example: If a transaction amount is less than or equal to 20% of the total monthly average consumption or usage of the available cash balance (or 20% of the available balance, “high water” mark, etc.), then debit the transaction amount from the available cash balance; If a transaction amount is greater than 20% of the total monthly average consumption or usage of the available cash balance, then debit the transaction amount equal to 20% of the total monthly average consumption or usage of the available cash balance from the available cash balance, and debit the excess or remainder of the transaction amount from the available credit balance.

Debiting Criteria Based on Percentage (Ratio) of Available Balance Criteria and/or Usage/Consumption Criteria in Relation to Amount of Available Balance(s), and/or Debiting Criteria Based on Ratio Between Two or More Available Account Balances and/or Usage/Consumption Amounts

Available balance amount in relation to a ratio (percentage) of the average available balance over any time interval (such as the average monthly available cash balance). Example: If an available cash balance exceeds 50% of its average monthly available cash balance, then debit the transaction amount from the available cash balance; If an available cash balance drops below 50% of its average monthly available cash balance, then debit 50% of the transaction amount from the available cash balance and 50% of the transaction amount from the available credit balance.

Available balance amount in relation to a ratio (percentage) of a “high water” mark (highest level) of the available balance. Example: If an available cash balance exceeds 50% of the “high water” mark for the month of the available cash balance, then debit the transaction amount from the available cash balance; If an available cash balance drops below 50% of the “high water” mark for the month of the available cash balance, then debit 50% of the transaction amount from the available cash balance and 50% of the transaction amount from the available credit balance.

Available balance amount in relation to a ratio (percentage) of total usage or consumption (or total average usage or consumption) of the available balance over any time interval (such as average monthly consumption of an available cash balance). Example: If an available cash balance exceeds 50% of the total monthly average consumption or usage of the available cash balance, then debit the transaction amount from the available cash balance; If an available cash balance drops below 50% of the total monthly average consumption or usage of the available cash balance, then debit 50% of the transaction amount from the available cash balance and 50% of the transaction amount from the available credit balance.

Available balance amount in relation to a ratio (percentage) of total usage or consumption (or total average usage or consumption) of all available balances over any time interval (such as average monthly consumption of all available balances). Example: If the total of all available balances exceed 50% of the total monthly average consumption or usage of all available balances, then debit the transaction amount from the available cash balance; if the total of all available balance drops below 50% of the total monthly average consumption or usage of the available cash balance, then debit 50% of the transaction amount from the available cash balance and 50% of the transaction amount from the available credit balance.

Available balance amount in relation to a ratio (percentage) of any balance criteria and/or usage/consumption criteria using additional remainder criteria (per the above examples) where if the available balance amount exceeds a ratio (percentage) of the above criteria, then any of the transaction amount less that or equal to the exceeding balance amount debits the available balance(s) according to a primary criteria; whereas if the transaction amount is greater than the exceeding balance amount, then the transaction amount debits the exceeding balance amount according to the primary criteria, and the remainder that the exceeding balance amount does not cover debits the available balances according to a secondary criteria. Example: If an available balance post-transaction amount is greater than or equal to 20% of the total monthly average consumption or usage of the available cash balance, then debit the transaction amount from the available cash balance; if an available balance post-transaction amount is less than 20% of the total monthly average consumption or usage of the available cash balance, then debit the transaction amount portion above the 20% of the total monthly average consumption or usage of the available cash balance (if any) from the available cash balance, and debit the deficit portion or remainder of the transaction amount below the 20% figure from the available credit balance.

Ratio of available balance amounts and/or usage/consumption amounts. Here, the transaction processor keeps track of the ratio between two or more available account balances, and/or the ratio of the usage/consumption amounts, and adjusts parameters accordingly. For example, if an available cash balance has a $1,000.00 available balance, and an available credit balance has a $3,000.00 available balance, then a transaction may be debited in a 1 to 3 ratio between the two accounts, with the ratio automatically adjusting as the balances are used. Another use is where if the ratio stays at 1 to 3 or above (available cash balance to available credit balance), then one set of debiting parameters is in force, (such as debiting the available credit balance) whereas if the ratio decreases, such as in the case of the ratio falling below 1 to 3, either due to an increase in the available cash balance, or a decrease in the available credit balance, then a different set of debiting parameters would come into use, (such as debiting the available cash balance). Ratios of usage/consumption amounts between two or more balances may also be considered in a commensurate manner.

It is possible to construct complex transaction balance debiting situations by combining aspects of available balance criteria with total average usage/consumption criteria, such as transaction amounts and/or balance amounts in relation to a ratio (percentage) of an available balance's “high water” “and/or” a ratio (percentage) of the average monthly consumption. Example: If a transaction amount is less than or equal to 20% of the available cash balance's “high water” mark, and the available balance amount is less than or equal to 10% of the average monthly consumption, then debit the available cash balance; otherwise, debit the available credit balance.

Extended examples of some of the simpler ratio (percentage) concepts are as follows.

RATIO (PERCENTAGE) OF AN AVAILABLE ACCOUNT BALANCE ILLUSTRATION TO DETERMINE ACCOUNT DEBITING USING AN AVAILABLE CASH BALANCE AND AN AVAILABLE CREDIT BALANCE—This example uses a ratio (percentage) of an available balance to determine account debiting. Here, if the transaction amount is equal to or less than ten percent (10%) the available cash balance prior to the transaction, then the available cash balance is debited, whereas the available credit balance is debited should the transaction amount be greater than ten percent of the available cash balance. As in the above examples, any numerical expression of any quantity may be used to express the proportion (“50%”, “½”, “1 to 1 ratio”, etc.), and transaction processor parameters are revisable at will.

| | | | | | |
|---|---|---|---|---|---|
| | | | Avail. | Cash | |
| Date | Description | Amount | Cash Bal. | Debited | Credit Debited |

Prior to Trans.

| | | | | | |
|---|---|---|---|---|---|
| 01-02 | Restaurant | 48.00 | 500.00 | 48.00 | -0- |
| 01-03 | Gasoline | 21.00 | 452.00 | 21.00 | -0- |
| 01-05 | Shoe Store | 36.00 | 431.00 | 36.00 | -0- |
| 01-06 | Supermarket | 63.00 | 395.00 | -0- | 63.00 |
| 01-14 | Gasoline | 15.00 | 395.00 | 15.00 | -0- |
| 01-18 | Appliance Store | 650.00 | 380.00 | -0- | 650.00 |
| 01-24 | Gasoline | 18.00 | 380.00 | 18.00 | -0- |
| 01-30 | Restaurant | 33.00 | 362.00 | 33.00 | -0- |
| | TOTAL | 884.00 | — | 171.00 | 713.00 |

Note that in the transaction dated 01-06, the $63.00 exceeded 10% of the available cash balance ($39.50), so the available credit balance was debited instead; likewise occurred on 01-18, whereas the $650.00 not only exceeded 10% of the available cash balance ($38.00), but exceeded the entire available cash balance as well, thus resulting in the $650.00 amount being debited from the available credit balance. As the available cash balance decreases, so does the level of allowed cash deduction per the 10% ratio. As depositing cash increases the available cash balance, the allowed debit amounts per the 10% ratio increases as well. Also, as the available cash balance decreases, the reliance on the available credit balance increases. As with all examples, “Best Fit” and “Rescue or Reject” criteria as disclosed in the above examples may be employed. For example, if a transaction exceeds its allotted ratio of the available cash balance and attempts to debit an inadequate available credit balance, the transaction processor can attempt to rescue the transaction by using the available cash balance for the entire transaction amount, or for only the amount of the available credit balance's shortfall. Although in the above example the ratio is tied to the available cash balance, such a ratio may be tied to any available balance comprising the global account. Furthermore, more than one account can have such a ratio tied to it, so while a certain transaction won't trigger one ratio condition, it can very well trigger another ratio situation. For example, if the transaction processor is instructed where a transaction exceeds 10% of the available cash balance, and exceeds 5% of the available credit balance #1, then the transaction will debit available credit balance #2.

RATIO (PERCENTAGE) OF A RECENT “HIGH WATER MARK” AVAILABLE ACCOUNT BALANCE ILLUSTRATION TO DETERMINE ACCOUNT DEBITING USING AN AVAILABLE CASH BALANCE AND AN AVAILABLE CREDIT BALANCE—This example uses a ratio of a “high water mark” available account balance. Here, the historic highest available balance, most likely using a specified timeframe or interval, is used as a benchmark in a calculation (such as a percentage) that determines how a transaction is debited from one or more available account balances. In an example of the high water mark being used in conjunction with an available cash balance, the most recent high water mark is used until (or unless) a cash deposit resets the high water mark upwards. In an example of the high water mark being used in conjunction with the available credit balance, the high water mark is reset with an increase of credit limit. In this example, the transaction processor is set so that if a transaction is equal to or less than 10% of the cash balance high water mark, then the transaction will debit the available cash balance; if the transaction amount exceeds 10% of the cash balance high water amount, then the transaction amount will debit the available credit balance.

| | | | Cash Balance | Cash | Credit |
|---|---|---|---|---|---|
| Date | Description | Amount | “High Water Mark” | Debited | Debited |
| 01-02 | Restaurant | 48.00 | 500.00 | 48.00 | -0- |
| 01-03 | Gasoline | 21.00 | 500.00 | 21.00 | -0- |
| 01-05 | Shoe Store | 36.00 | 500.00 | 36.00 | -0- |
| 01-06 | Supermarket | 63.00 | 500.00 | -0- | 63.00 |
| 01-14 | Gasoline | 15.00 | 500.00 | 15.00 | -0- |
| 01-18 | Appliance | 650.00 | 500.00 | -0- | 650.00 |
| | Store | | | | |
| 01-24 | Gasoline | 18.00 | 500.00 | 18.00 | -0- |
| 01-30 | Restaurant | 33.00 | 500.00 | 33.00 | -0- |
| | TOTAL | 884.00 | — | 171.00 | 713.00 |

Note that in the transaction dated 01-06, the $63.00 exceeded 10% of the cash balance high water mark, so the available credit balance was debited instead; likewise occurred on 01-18, where the $650.00 not only exceeded 10% of the cash balance high water mark, but exceeded the entire available cash balance as well, thus resulting in the $650.00 amount being debited from the available credit balance. Commensurate examples may be gleaned using different static criteria that the ratio (percentage) comparison may be based upon, such as average monthly account balance, average monthly balance usage or consumption, etc.

AVAILABLE BALANCE AMOUNT IN RELATION TO A RATIO (PERCENTAGE) OF TOTAL AVERAGE USAGE OR CONSUMPTION ILLUSTRATION USING AN AVAILABLE CASH BALANCE AND AN AVAILABLE CREDIT BALANCE—This example uses a comparison of an available cash balance amount in relation to a ratio (percentage) of total average usage or consumption of both available balances combined over a time period of a month to determine transaction account debiting criteria. This example will use post transaction debiting criteria discussed earlier, so if the available cash balance, after figuring in (debiting) the transaction amount in question, exceeds 50% of the average monthly usage or consumption of both available balances combined, then the transaction will debit the available cash balance. If, after figuring in the transaction amount in question, the available cash balance falls below 50% of the average monthly usage or consumption of both available balances combined, then the transaction will debit the available credit balance. In this instance, the average monthly combined balance usage is $700.00, so the 50% criterion creates a $350.00 threshold.

Average Monthly Cash Balance Usage - $700.00 × 50% = $350.00

| | | | Post Trans. | Cash | Credit |
|---|---|---|---|---|---|
| Date | Description | Amount | Avail. Cash Bal. | Debited | Debited |
| 01-02 | Restaurant | 48.00 | 452.00 | 48.00 | -0- |
| 01-03 | Gasoline | 21.00 | 431.00 | 21.00 | -0- |
| 01-05 | Shoe Store | 36.00 | 395.00 | 36.00 | -0- |
| 01-06 | Supermarket | 63.00 | 332.00*** | -0- | 63.00 |
| 01-14 | Gasoline | 15.00 | 380.00 | 15.00 | -0- |
| 01-18 | Appliance Store | 650.00 | (270.00)*** | -0- | 650.00 |
| 01-24 | Gasoline | 18.00 | 362.00 | 18.00 | -0- |
| 01-30 | Restaurant | 33.00 | 329.00*** | -0- | 33.00 |

| | | | | |
|---|---|---|---|---|
| TOTAL | 884.00 | — | 138.00 | 746.00 |

***Transaction amount will cause the available cash balance to dip below $350.00 threshold; therefore, the transaction amount is debited from the available credit balance only.

The 01-06 transaction and 01-30 transaction would have caused the available cash balance to fall below the $350.00 average monthly combined balance usage threshold; therefore, the transactions debited the available credit balance. The 01-18 transaction not only would have caused the available cash balance to fall below $350.00, but would have caused in the available cash balance to go negative as well. As a result, such a condition caused the 01-18 transaction to debit the available credit balance.

Debiting Transactions Based on Merchant Identification Information

Up until this point, transactions have been debited among at least two account balances based on amount parameters. An additional system component of debiting transactions among at least two account balances, which can be employed in addition to, or in place of amount parameters, is by using any merchant identification information to debit transactions among at least two account balances.

In a typical financial card transaction, an account end user presents a financial card to a merchant, who records transaction data by using either an electronic terminal or a manual draft. This transaction data includes the amount of the purchase, the end user's account number, the card's expiration date, the merchant identification number, and the date of the transaction. In the later part of the transaction process, the card issuer posts the transaction to the end user's account. The transaction data posted to the cardholder's account includes merchant identification information, which comprises the name of the merchant, and in many cases an additional identifier, such as a number or actual address, that identifies a particular location of a merchant, where said merchant comprises perhaps a store chain that has numerous locations.

As can be reasonably assumed in many cases, a given end user can become a creature of habit when it comes to frequenting a given merchant. As a result, it may be useful to enable the transaction processor to allow the end user to debit available account balances in a consistent manner for transactions involving said given merchant. For example, an end user may have the transaction processor in his global account set so that transactions up to $50 are debited 100% from an available cash balance (all cash), and transactions over $50 are debited 100% from an available credit balance (all credit). However, when the end user goes food shopping at a particular store, he may prefer that the all transactions at the particular store debit only his available cash balance, regardless of the transaction size. His current parameters would allow the account to perform as wished for food purchases from the merchant up to $50, but not for food purchases over $50.

To solve the dilemma, the end user could perform file maintenance on a special instructions file in the transaction processor that enables any system component or type of merchant identifier information, or any merchant identifier information contained in the merchant identifier text string that appears on the end-user's statement, to be associated with its own set of available account balance debiting parameters. Such information comprises the merchant name, the merchant location such as store number, city, state or country, and in certain cases, the merchant classification code, which classifies a merchant according to the type of business. Upon the transaction being posted to the account, the transaction processor looks for any merchant identifier information that matches information contained in the special instructions file. Upon finding a match, the transaction processor debits the available account balances for the amount of the transaction in accordance with the desired available account balance debiting parameters.

For example, if the end user sets up the merchant name Excellent Grocers into the special instructions file, and sets available account balance debiting parameters for Excellent Grocers, then any transaction postings matching Excellent Grocers will be debited according to said parameters, regardless of store location. If the end user sets up the merchant name Excellent Grocers—First Town, VA, then only those transaction postings originating from the Excellent Grocers store in First Town, Virginia will be debited according to the parameters in the special instruction file, whereas transaction postings originating from the Excellent Grocers store in Second City, Virginia will be debited according to the standard parameters outside of the special instructions file.

The end user can make a special entry for a merchant in the special instructions file, or can simply click on an already posted transaction and have that information transfer to the special instructions file, where the end user can make adjustments with regards to merchant identifier matching parameters, such as specifying that match parameters are to include more than one, or any location of a given merchant, and not just the location listed on the clicked-on transaction, and also where the end user can specify the pertinent available account balance debiting parameters for transactions with that particular merchant or merchant location.

Such flexibility would enable an end user, whose typical transactions up to $50 are set up to debit an available cash balance, to set up an entry in the special instructions file that would allow even a mere $12 transaction with Amazon.com to automatically debit an available credit balance. The special instructions file can be set up so that a list of merchants can share a specific set of account debiting instructions, or one or more of merchants can each have a specific set of account debiting instructions. Such a feature could also prove very useful to end users that enable merchants or service providers to have periodic payments automatically debited from the end user's global account.

Merchant identification information often, if not always, includes two letter state codes (VA for Virginia, NJ for New Jersey, etc.), where the two letter state code tends to appear at the end of the merchant identifier text string, for example ABC BOOKSELLERS LOS ANGELES CA. In this instance, the special instructions file is set up to recognize state codes, so, for example, transactions comprising out of the area state codes, such as this transaction from California (CA), could be set up to debit the available account balances using specific end-user criteria. State codes are particularly good criteria for geographic sorting, especially since cities from which charges originate from are not always listed in the merchant identifier text string; nonetheless, any system component or type of merchant identifier information, or any information contained in a merchant identifier text string can be associated with its own set of account debiting parameters. For example, states outside of an end user's given tri-state area could be set up for credit only, so in the case of out-of-area fraud, credit protection would help to limit end-user losses. Such could be an attractive feature for individuals that ordinarily only do transactions that debit available cash balances, such as debit card transactions, because while some debit card issuers currently offer fraud protection that limits end-user liability with regard to debit card purchases, many debit card issuers do not. With regard to geographic listings, it would be helpful to have an option to structure a listing on the special instructions file where an end user can make a choice to list states, or even countries for that matter, where the special out-of-state or out-of-country account debiting parameters do not apply, which in many cases could be a much shorter list, and save the end user from having to make entries excluding maybe 47 or 48 state codes, and who knows how many country codes.

Transaction Authorization

The next section covering a critical aspect of the transaction processor is how an incoming transaction or incoming transaction authorization request is handled. In this regard, the transaction processor may handle an incoming transaction/authorization request using two distinct methods. Depending on the embodiment, a card issuer may choose one method over the other, where the end user is left with no option, or a card issuer may offer both methods, and allow the end user to make an election, where the choice is stored in the transaction processor, and can be changed at will. In fact, it could be possible for a global account to offer both methods, where an end user can assign different methods to, say, different amount thresholds.

The first method is where a request for a transaction authorization comes in, and the transaction processor looks at the total available balances of the at least two the available account balances. If the total of the available account balances is inadequate for a given transaction, then the transaction authorization request is rejected. If the total is adequate for a given transaction, then the transaction request is authorized, and then the accounts are debited using Best Fit criteria, either in real time if the transaction is performed on line via ACH and/or EFT networks, or on a non real-time basis once the transaction posts using any off-line network. For example, if a given transaction's total is authorized for $100 based on the total of two available balances (one being an available cash balance, the other being an available credit balance), and the parameters in the transaction processor instruct that half of the amount ($50) is to debit the available cash balance and the other half is to debit the available credit balance, and each of the two available balances is adequate, then the transaction is debited equally from the two accounts. However, if, the available cash balance is only $30, then the available credit balance must have at least $70 left on it because the total $100 transaction was authorized based on the total of the available balances. At this point, using Best Fit criteria, the available cash balance is debited $30 (instead of the $50 the parameters called for), and the available credit balance is debited $70 (the $50 the parameters called for, plus the $20 that the available cash balance couldn't cover).

The second method is where, say, a $100 transaction authorization request comes in, where the global account comprises an available cash balance and an available credit balance. The transaction processor is set up to debit 50% available cash balance and 50% available credit balance. Using the second method, the transaction processor looks at the two account balances individually, so if the available cash balance has at least $50, and the available credit balance has at least $50, the $100 transaction will be authorized. If one of the accounts is inadequate, a user-selectable parameter comes into play called Rescue or Reject, where the end user can pre-select, in the case of where one of the assigned account balances is inadequate, to either have the transaction processor try to rescue the transaction by having the transaction processor attempt to compensate for a deficiency in the inadequate account using the unused available account balance of the other account, or to reject the transaction based on the one account balance's shortfall. Should the end user choose the rescue function, and another available account balance is able to make up the shortfall, then the transaction request will be authorized (or in the case of a real-time ACH and/or EFT embodiment, the transaction itself will be consummated); however, if the end user chooses the rescue function, and there isn't enough of another available account balance to make up for the shortfall of the inadequate account balance, then the transaction will be rejected.

Either or both methods may be employed for end user accounts comprising two, or more than two, available account balances. As suggested earlier, each of the two methods may be used in the global account for different parameter sets.

Additional Parameters

Other optional parameters of the transaction processor are geared for convenience, user spending discipline, and/or security measures. One is where an end user can specify to transfer funds from any available cash balance(s) to make any payment(s) due, such as the minimum payment due, a specified amount, the entire amount due, etc., on transaction amounts were charged against any available credit balance(s). The transfer may be set up to occur automatically, or the end user may perform each transfer individually.

Another is where an end user can specify minimum and/or maximum transaction amounts, for a particular transaction. A minimum transaction amount of, say, $10 could help discipline an end user to not use the global financial account for every little impulse purchase, so the transaction processor is set up to reject transactions under $10. A maximum transaction amount could also enable discipline, or may be employed purely as a security measure, especially for global accounts that have multiple users. For example, if an end user sets up a maximum transaction amount for a single transaction of $499, then transactions above $499 will be rejected.

Maximums can be set up for total debiting of all of the available account balances comprising the global account within a specified time frame, so any transaction that would push the total amount above, say, $1000 before the last day of the billing cycle would get rejected. Here, the end user specifies amounts and timeframe. The timeframe may comprise any time specification, so the timeframe can be a specific date, a specific day within the billing cycle (by the date the billing cycle ends), a rolling time period (as in do not exceed $1000 usage within the 7 days prior to and including today's date), etc.

Maximums for any of the individual available account balances comprising the global account also are useful for end users trying to control spending. Keeping this in mind, the transaction processor enable limits to be set over any specified timeframe on the maximum allowable available account balance usage for at least one available account balance comprising the global account. For instance, in an example comprising an available cash balance and an available credit balance, the transaction processor is set to use a threshold parameter where transactions over $100 automatically debit the available credit balance. However, an end user may not wish to use any more than $500 of his available credit balance within a given billing cycle. Therefore, the end user would place a $500 limit for the entire current billing cycle timeframe on usage of his available credit balance. In such an instance, the end user can choose, or the card issuer/account provider can provide, parameter options such as Best Fit and/or Rescue or Reject criteria to deal with transactions that conflict with an available account balance that has already reached its maximum allowable available account balance usage. In this case, after the $500 available credit balance usage limit is reached, any new transaction(s) over $100 using Best Fit criteria would automatically debit the available cash balance until depletion, whereas with any new transaction(s) over $100 using Rescue or Reject criteria, the end user could choose to either rescue the new transaction by using the available cash balance, or reject the transaction based on the fact that the specified maximized usage limit of the available credit balance had already been reached.

Specified timeframes may be as long as or even longer than a billing cycle, or may be much shorter. For example, timeframes may be short enough to be expressed in terms of hours. Such creates a very interesting possibility where an end user can specify, say, a 24 hour period starting at 5:00 AM Eastern Standard Time, where, using amount and timeframe parameters, the end user limits the accessing of the available cash balance to $100 per 24 hour period starting at 5:00 AM EST, to where anything above $100 debits an available credit balance. In the case of the sample parameter, once 5:00 AM EST rolls around (a new 24 hour period), the ability to access the available cash balance resets, and the end user can again debit the available cash balance up to $100 before the available credit balance kicks in. The time at which an account is accessed corresponds to either the time a transaction is authorized (in the case of a transaction that posts at a time separate from authorization), or the time a transaction actually clears in a real-time situation, such as transactions done using the ACH.

Specified timeframes are not only useful for limiting account balance maximum usage; they are also useful as criteria for adjusting account-debiting parameters. For example, the end user can adjust parameters on the transaction processor so that purchases made from 5 AM EST until 11 AM EST debit the available cash balance using a 100% ratio; purchases made from 11 AM EST until 4 AM EST debit an available cash balance and an available credit balance in a 50%-50% ratio; while purchases made from 4 AM EST until 5 AM EST the next morning debit the available credit balance using a 100% ratio. This way, an end user pays for his $3.50 morning latte using an available cash balance; a $20 dry cleaning bill is paid at lunchtime using a 50%-50% ratio of available cash/available credit; and a night on the town is covered using his available credit balance. All of the varied account debiting at each point-of-sale is performed automatically when swiping the card, and not by performing any manipulations at any of the points-of-sale. In these situations, and as mentioned in prior examples, Best Fit and/or Rescue or Reject criteria may be used to help the end user avoid embarrassment at any of the points-of-sale.

Another parameter comprises the capability to disengage at least one given available account balance. For example, an end user may wish to disengage an available cash balance as a security measure when going on vacation.

However, should the end user find himself in a bind while on vacation, access to the transaction processor, via a phone call to a customer service representative, via the Internet, etc., will enable him to turn back on the available cash balance.

Another parameter for security is quite simple, and comprises where the transaction processor sends E-mail to the end user every time the available account balances are used. This way, an end user not only has a running record on account balances usage; better yet, the end user has a basis for detecting unauthorized account balances usage.

Many of the transaction processor's available account balance debiting capabilities can be adapted to facilitate cash withdrawals, electronic payments or wires, and/or checks (drafts). For example, an end user could set up the transaction processor parameters comprising ratio, threshold, remainder, etc., with a threshold parameter so that cash withdrawals up to $200 debit an available cash balance, while cash withdrawals above $200 debit only an available credit balance, thus behaving like a cash advance against an available credit balance. Remainder thresholds can be employed, so for a cash withdrawal of $400, the first $200 debits an available cash balance, while the $200 remainder debits an available credit balance. Ratio parameters can also be used, so a cash withdrawal can debit 100% of an available cash balance, and, upon depletion of the available cash balance, can make use, along with various threshold and remainder amount parameters, of the Best Fit or Rescue or Reject criteria disclosed earlier. It certainly helps an end user that needs cash fast to be able to rely on more than one available balance, especially when the balances work seamlessly and invisibly thanks to the transaction processor. Also, among the at least two available account balances may optionally be a separate cash balance that is used only for cash withdrawals, and not for purchases. The cash withdrawal parameters comprising ratio, threshold, remainder, etc., can comprise the non-purchase available cash balance along with other available balances that enable the employment of the Best Fit or Rescue or Reject criteria as well, thereby enabling the end user to easily withdraw cash even upon the depletion of the non-purchase available cash balance.

Electronic and wire payments can be sent using finds that debit the at least two accounts automatically in manners similar to cash withdrawals using parameters such as ratio, threshold, remainder threshold, etc. In fact, the transaction processor can set up repeating electronic and wire payment instructions so that a given set of electronic and wire payment instructions has its own set of available balance debiting parameters with regard to ratio, threshold, remainder threshold, etc.

Checks (drafts) drawn on the global account can receive similar treatment with regard to parameters comprising ratio, threshold, remainder, etc., such as where parameters on the transaction processor can be set up using a threshold parameter so check amounts up to a certain amount, such as $500, debit an available cash balance, and checks over the amount debit an available credit balance, and act like the cash advance checks that some credit card companies send out occasionally with monthly billing statements. The Best Fit or Rescue or Reject criteria disclosed earlier may be also adapted for drafts so at least two available account balances can help ensure that the chances of a given check bouncing are significantly reduced. As with the cash withdrawal embodiment, the global account may optionally comprise a separate available cash balance that is available only for clearing checks, where the check account debiting parameters comprising ratio, threshold, remainder, etc., can comprise the check clearing available cash balance along with other available balances that enable the employment of the Best Fit or Rescue or Reject criteria.

Free or Reduced Fee Checking Based on Fee Generating Activity

Another aspect that is widely discussed in consumer arenas is free or reduced fee checking. Some checking account customers receive free or reduced fee checking services based on maintaining a minimum balance in the account that enables the checking account provider to earn revenue, thus making up for the costs of offering a checking account. Other checking account providers allow free checking with direct deposit of the end user's wages, pensions, or government benefits. The present invention presents an interesting opportunity for embodiments that comprise a checking feature. Using available credit balances and/or available cash balances in an off-line transaction (a transaction not using the ACH or an EFT system) results in interchange fees for the card issuer/account provider. Card issuers absolutely love revenue from interchange fees, as revenues over time are quite substantial. To encourage end user loyalty, the card issuer can offer free or reduced fee checking based on a specified amount of off line interchange fee generating activity, where basically if the end user performs a specified amount total and/or number of transactions within a specified period using at least one available credit and/or available cash balance, where the transactions use system component that generate interchange fees, then the end user will receive free or reduced fee checking services. Also, the method may be modified to where the end user receives free or reduced fee checking services based on the amount of on line transaction fee generating activity (using the ACH or an EFT system) within a specified period, either in addition to, or in place of, off line interchange fee generating activity. Such an offer may be used in place of a minimum deposit or direct deposit requirement; or the checking services provider can choose instead to offer the end user free or reduced fee checking services if the end user either performs a given amount of transactions within a specified period that generates interchange fees, maintains a minimum deposit, or sets up direct deposit (Three ways to get free checking!).

Readjustments

A powerful feature of the transaction processor is where a given transaction that is already posted may be switched from one already debited balance to another available balance. An instance is where an end user desires that a given transaction debits at least one available account balance in a different manner than what the transaction processor, per preset parameters, did initially; e.g., where an end user wishes to revise or readjust, say, a given $35 transaction so the transaction debits an available cash balance that credits or restores the initial debiting of an available credit balance. This feature can be accomplished manually by the end user, preset by the end-user or automatically use preset parameters, between cash and/or credit accounts, e.g., where a ratio and/or threshold amount is specified between one or more available cash balances and available credit balances, or where cash debit card users can use one or more available credit balances for overdraft protection.

The following example shows a list of posted transactions where 50% of the transaction amount debited an available cash balance, while the remaining 50% debited an available credit balance.

| Date | Description | Amount | Cash | Credit |
|---|---|---|---|---|
| 01-02 | Restaurant | 48.00 | 24.00 | 24.00 |
| 01-03 | Gasoline | 21.00 | 10.50 | 10.50 |
| 01-05 | Shoe Store | 36.00 | 18.00 | 18.00 |
| 01-06 | Supermarket | 63.00 | 31.50 | 31.50 |
| 01-14 | Gasoline | 15.00 | 7.50 | 7.50 |
| 01-18 | Appliance Store | 750.00 | 375.00 | 375.00 |

When viewing the postings on 01-26, the end user determines that he would like to have more available cash in his global account, and in making the determination feels that he would like to revise the 01-18 Appliance Store purchase so that the entire $750 debits the available credit balance, which will return the $375 cash that was previously debited from his available cash balance.

To perform this operation, the end user clicks on, or otherwise identifies using any method, the 01-18 Appliance Store transaction, highlights by clicking on the $375 cash in the cash debit column, and enters zero. The transaction processor checks the available credit balance, sees that the available credit balance can adequately handle an additional $375 debit, and automatically readjusts the debit on the available credit balance to read $750. In essence, the end user can enter an amount greater than zero, which would still leave some residual amount debiting the available cash balance for the 01-18 transaction, and would readjust the debit to the available credit balance accordingly. While in most cases it is desirable for the transaction processor to make the amount readjustments automatically in response to a revision entered by the end user, there could be embodiments where more than one adjustment amount could be entered manually, with the transaction processor then verifying that the total correctly adds up and then checking the available account balance(s) to see if the account balance(s) have the resources to allow the change before the readjustment is permitted. While such embodiments comprising manual entries can be used for global accounts comprising only two available account balances, such manual entry capabilities are especially useful for embodiments comprising three or more available account balances, where a readjustment to one account balance by the end user requires a non-obvious offset using at least one of the two or more remaining accounts. For example, if an end user wishes to make a readjustment that frees up $100 in one available account balance, and has a choice of using two other available account balances to offset the $100 amount, how that $100 is taken from the two remaining account balances is non-obvious, and thus requires the end user to actually specify the desired amount change(s) to either or both of the two remaining available account balances. The example mentioned earlier in the paragraph is as follows:

| Date | Description | Amount | Cash | Credit |
|---|---|---|---|---|
| 01-18 | Appliance Store | 750.00 | -0- | 750.00 |

The end result is where the end user now has an extra available $375 cash balance thanks to the readjustment. It is very important to keep in mind that the $375 is not a cash advance; rather, it is merely a restoration of a prior cash balance. There are no real implications here with regard to back interest. Assuming a grace period is in place, there is a chance that the extra $375 debit to the available credit balance will be paid off before interest is assessed. In the event that the grace period does not apply, then the card issuer can charge interest on the extra $375 from the date that the available credit balance is debited by the extra $375. Whether or not a feature fee, a per-use fee, or a percentage of the readjustment amount is charged for this end user readjustment feature is basically up to the card issuer/account provider. Keep in mind that while a singular transaction was highlighted and readjusted in the above example, it is possible to perform such a function on more than one transaction, either one at a time, or simultaneously. Also, an important aspect of this disclosure is where transactions that are readjusted from debiting, say, an available cash balance to an available credit balance, thus increasing the amount of the available cash balance, can theoretically be readjusted or switched back and forth (from available credit back to available cash and vice-versa, or switched back and forth between any of the available balances in global account embodiments comprising more than two available balances) any number of times without limit, using full and/or partial amounts. However, in practice, a global account provider could ultimately seek to place limits on its end users with regards to the number or nature of such readjustments or switches. In illustrating a residual, or partial, amount transfer mentioned earlier, if the end user prefers to free up only an additional $200 of the consumed cash balance instead of the full $375 cash amount used for the 01-18 transaction, the end user may do so. As a result, referring to the prior example, the 01-18 $750 appliance store purchase debits the available cash balance for a revised amount of $175, thus freeing up $200 cash from the original $375 debit to the available cash balance, and the debit to the available credit balance is increased by the $200 amount, so now the readjustment debits the available credit balance for $575 instead of the original $375 amount. Furthermore, if an end user subsequently chooses to free up all or part of the remaining $175 debit to the available cash balance, it is certainly within the scope of this disclosure to permit such additional readjustment.

| Date | Description | Amount | Cash | Credit |
|---|---|---|---|---|
| 01-18 | Appliance Store | 750.00 | 175.00 | 575.00 |

What happens if the opposite were to occur, where the end user wants to free up more of the available credit balance? On 01-26, the end user clicks on the 01-18 Appliance Store transaction, highlights by clicking on the $375 credit debit column, and enters zero. The transaction processor checks the available cash balance, sees that the available cash balance can adequately handle an additional $375 debit, and automatically readjusts the debit on the available cash balance to read $750, while at the same time is crediting the available credit balance by $375.

| Date | Description | Amount | Cash | Credit |
|---|---|---|---|---|
| 01-18 | Appliance Store | 750.00 | 750.00 | -0- |

In this situation, there could be implications here with regards to back interest. If a grace period applies, then no back interest should be due; however, if a grace period does not apply, then there are 8 days of back interest that could still be due. Being that the transaction posted back on 01-18, and the change was made on 01-26, the customer could be charged 8 days interim interest on the $375 that was borrowed from the available credit balance and paid to the appliance store merchant. In such a case it could be anyone's guess on how a card issuer/account provider would view such a situation, especially if the card issuer/account provider is earning revenue all along on a long-standing and sizable available cash balance belonging to the customer that was the source of the $375 used to credit the customer's available credit balance.

It is also possible with the transaction processor to highlight a grouping of posted transactions, and reset any of the global parameters such as ratio, amount threshold, remainder threshold, etc., and have all the posted transactions readjust.

For instance, instead of the transactions debiting the available cash and available credit balances 50%-50%, as the example below, the end user can highlight, say, the last four transactions . . .

| Date | Description | Amount | Cash | Credit |
|---|---|---|---|---|
| 01-02 | Restaurant | 48.00 | 24.00 | 24.00 |
| 01-03 | Gasoline | 21.00 | 10.50 | 10.50 |
| 01-05 | Shoe Store | 36.00 | 18.00 | 18.00 |
| 01-06 | Supermarket | 63.00 | 31.50 | 31.50 |
| 01-14 | Gasoline | 15.00 | 7.50 | 7.50 |
| 01-18 | Appliance Store | 750.00 | 375.00 | 375.00 |

Then reset the global parameters so the highlighted transactions are readjusted to where the 50%-50% ratio is replaced with, say, a remainder threshold where transaction amounts up to $20 debit the available cash balance, and remainder amounts above $20 debit the available credit balance. The resulting account debiting of the posted transactions, assuming adequate available account balances, are as follows:

| Date | Description | Amount | Cash | Credit |
|---|---|---|---|---|
| 01-05 | Shoe Store | 36.00 | 20.00 | 16.00 |
| 01-06 | Supermarket | 63.00 | 20.00 | 43.00 |
| 01-14 | Gasoline | 15.00 | 15.00 | -0- |
| 01-18 | Appliance Store | 750.00 | 20.00 | 730.00 |

The net change to the two account balances is where the available cash balance is credited $357, while the available credit balance is debited $357. As mentioned earlier, the credited cash is a restoration of what was in the available cash balance, which is good for the card issuer/account provider, being that the card issuer/account provider makes money on both the cash parked in the account, and on the increased credit usage. Resetting the parameters globally may comprise any of the parameters, such as ratio, amount threshold, remainder threshold, etc.

Furthermore, it is possible with the transaction processor to specify a transaction readjustment using a specific amount, so specific transactions will automatically readjust according to, say, a desired dollar amount. An automatic readjustment may use any method in order to effect the readjustment such as FIFO (first in, first out), LIFO (last in, first out), lowest value transaction first, highest transaction value first, partial amounts of several transactions, etc. In the following example, an end user paid a total of $933.00 debiting only the available cash balance as follows:

| Date | Description | Amount | Cash | Credit |
|---|---|---|---|---|
| 01-02 | Restaurant | 48.00 | 48.00 | -0- |
| 01-03 | Gasoline | 21.00 | 21.00 | -0- |
| 01-05 | Shoe Store | 36.00 | 36.00 | -0- |
| 01-06 | Supermarket | 63.00 | 63.00 | -0- |
| 01-14 | Gasoline | 15.00 | 15.00 | -0- |
| 01-18 | Appliance Store | 750.00 | 750.00 | -0- |
| | TOTAL | 933.00 | 933.00 | -0- |

Subsequently, the end user lets the transaction processor know that the end user wants $300.00 of the $933.00 back in cash, where the readjustment debits the available credit balance and credits the available cash balance. In this instance, the end user really doesn't care which transactions are affected by the readjustment; rather, the end user is solely interested in the net effect of having an additional $300.00 credit the available cash balance. As mentioned above, the transaction processor may select which transactions are affected by any method. To illustrate the following example, FIFO (first in, first out) will be used, so of the six transactions listed below, all of the first five and part of the sixth transaction will be readjusted, where the total readjustments yield the $300 credit to the available cash balance, and a total debit amount of $300 to the available credit balance.

| Date | Description | Amount | Cash | Credit |
|---|---|---|---|---|
| 01-02 | Restaurant | 48.00 | -0- | 48.00 |
| 01-03 | Gasoline | 21.00 | -0- | 21.00 |
| 01-05 | Shoe Store | 36.00 | -0- | 36.00 |
| 01-06 | Supermarket | 63.00 | -0- | 63.00 |
| 01-14 | Gasoline | 15.00 | -0- | 15.00 |
| 01-18 | Appliance Store | 750.00 | 633.00 | 117.00 |
| | TOTAL | 933.00 | 633.00 | 300.00 |

In this next embodiment, it is possible to make a readjustment that is not transaction specific, that is, where one or more specific transactions are readjusted, but rather where the readjustment is amount specific. In the example below, the end user made a total of $933.00 of purchases using the available cash balance. Here, the account issuer can enable the end user to credit the end user's available cash balance (restoring cash to the available cash balance while debiting the available credit balance) without having to involve any specific transactions whatsoever. In this instance, the transaction processor sees that $933.00 of purchases were made by debiting the available cash balance, and so allows the end user to readjust up to $933.00, resulting in a credit to the available cash balance, and a debit to the available credit balance. The up to $933.00 debit to the available credit balance could simply be acknowledged as a lump-sum amount, and not as a listing of readjusted transactions, although the issuer can display the lump-sum amount eligible for readjustment (and/or the amount that has already been readjusted), as well as maintaining the option of listing the specific transactions that were affected by the readjustment.

| Date | Description | Amount | Cash | Credit |
|---|---|---|---|---|
| 01-02 | Restaurant | 48.00 | 48.00 | -0- |
| 01-03 | Gasoline | 21.00 | 21.00 | -0- |
| 01-05 | Shoe Store | 36.00 | 36.00 | -0- |
| 01-06 | Supermarket | 63.00 | 63.00 | -0- |
| 01-14 | Gasoline | 15.00 | 15.00 | -0- |
| 01-18 | Appliance Store | 750.00 | 750.00 | -0- |
| | TOTAL | 933.00 | 933.00 | -0- |

“End User Has $933.00 of Cash Balance Purchases that are Available for Readjustment onto the Available Credit Balance”

Per the above, should the end user choose to make an amount specific readjustment of $400.00 of the $933.00 cash balance purchases, where the readjustment credits the available cash balance and debits the available credit balance for the $400.00 amount, and the end user has a $533.00 remainder that can still be readjusted, text may be modified as follows:

“End User Has $533.00 of Cash Balance Purchases that are Available for Readjustment onto the Available Credit Balance—End User Has a $400.00 Total Miscellaneous Debit to the Available Credit Balance as a Result of Prior Readjustment(s)”

It is especially important to be reminded that any readjustments, comprising readjustments such as transaction specific readjustments or amount specific readjustments, where the end result thereof enables the end user to basically pull cash out of the end user's transaction activity, is not the same as a “cash advance” against an available credit balance, because the cash that the end user pulls out is cash that originally belonged to the end user anyway. In the same way that an end user may theoretically make any number of transaction specific readjustments without limit (as mentioned earlier), the end user may make any number of amount specific readjustments back and forth between any of the available balances comprising the at least two available balances of the global account. It is conceivable that an end user could wish to actually withdraw more cash than the amount available via a readjustment. Pertaining to the above example, if an end user wished to have a cash withdrawal totaling $1000.00, and wished to readjust the entire $933.00 transaction activity to free up the cash that the end user used for the prior purchases, then the $1000.00 cash withdrawal could be realized by readjusting the $933.00 purchases, and then taking out the additional $67.00 in the form of a “cash advance” against the available credit balance. The desired cash withdrawal would still show a total debiting of the available credit balance(s) for $1000.00; however, only $67.00 of the $1,000.00 debit against the available credit balance(s) would be due to an actual “cash advance”. As mentioned earlier, the transaction processor functions with any type of security/verification and/or system routing, such as PIN-based ACH or EFT environments. In embodiments using ACH and/or EFT access, transaction specific readjustments, and/or an amount specific readjustments can comprise where said readjustments include crediting an available cash balance by debiting a line of credit, or debiting an available credit balance, where the issuer considers the readjustment that pulls cash out as a debit to the line of credit, or as a “cash advance” against the available credit balance, and charge the customer interest relating to the line of credit, or additional “cash advance” fees and higher interest rates relating to debiting the available credit balance. Note that it is possible for an account provider to allow use of the available credit balance in such embodiments in exchange for more traditional credit balance use terms (sans additional “cash advance” fees and higher interest rates), for whatever reason(s) or considerations.

Whether by using a transaction specific readjustment, and/or an amount specific readjustment, the ability to reclaim cash from purchase transactions already made (where the purchase transactions originally debited an available cash balance, and are readjusted to debit an available credit balance, thereby crediting or restoring funds back to an available cash balance) offers an unexpected result and potentially very lucrative benefit for issuers of the global account by greatly increasing the risk of default for the entire global account by the end user, which in turn enables the issuer to justify and charge higher fees, especially in relation to those fees earned that are associated with purchase transactions, such as interchange fees. Financial card account issuers charge relatively higher fees for transactions performed with their credit cards (which debit an available credit balance) than for transactions performed with their debit cards (which debit an available cash balance). This is due to the fact that credit card accounts carry the risk of the end user defaulting on payment to the card issuer for charges made by the end user. An example is where an end user charges $10,000 on his credit card account, and then skips town without paying any of the principal or interest due on the account, thereby leaving the card issuer “holding the bag”. A typical debit card does not carry this risk due to the fact that the end user uses his own cash instead of an available credit balance, so the risks that debit card issuers tend to have is in having to make restitution to an end user that was the victim of debit card fraud or theft, which tends to be a much smaller risk in dollar terms (and thus carries a smaller risk premium) than credit card account default risk. Thanks to this readjustment concept of the present disclosure, an end user of a global account can make purchase transactions using $10,000 of an available cash balance in the global account, which is the end user's own money (and which, in a typical debit card account, carries no default risk to the card issuer); then, the end user can readjust the $10,000 in purchase transactions so the transactions debit an available credit balance in the global account for the $10,000 amount, resulting where the available cash balance that was originally used for the purchases is (re)credited for the $10,000 amount; then, the end user can withdraw the (re)credited $10,000 amount from the global account, and then default on the $10,000 debit to the available credit balance, where the debit to the available credit balance was created by the readjustment. It is in this way that an end user that uses only his own available cash balance for a given purchase transaction can still present a default risk for the entire transaction amount to the provider of the global account. While the potential for higher fee revenue affects the merchants in a negative way, there are also unexpected results that benefit merchants as well. First, if an end user has a tendency to favor available cash balances for purchases, the end user is likely to be less watchful of cash balance levels, and is therefore likely to spend more with a given merchant, if the end user has a readjustment mechanism or “safety valve” readily in place that enables transactions to be readjusted from an available cash balance to an available credit balance, being that the readjustment mechanism provides a remedy to potential available cash balance shortfalls. Second, an end user that has a tendency to favor available cash balances for purchases, but has an unexpected cash balance shortfall, now has the option of using the readjustment mechanism, rather than returning the purchased item to the merchant, resulting in fewer returned items for the merchant, and less running around for the end user.

As mentioned earlier, it is possible for at least one of the available account balances comprising the global account to have its own account number that enables access via credit card, debit card, ATM card, draft, etc. that is distinct from the account numbers used to access the global account. Regardless of how the varied accounts are accessed, readjustments comprising transaction specific readjustments and/or amount specific readjustments may be performed among the varied available account balances.

Furthermore, and very importantly, the ability to perform readjustments comprising transaction specific readjustments, and/or an amount specific readjustments in order to reclaim cash from purchase transactions already made, with or without the capability to make any number of readjustments back and forth between any of the available balances, is disclosed as being highly and especially advantageous as an additional enhancement to old and well known embodiments of accounts that use a singular available balance, such as debit card accounts, ATM card accounts, checking accounts, and the like that comprise a singular available cash balance; and, credit card accounts, lines of credit, and the like that comprise a singular available credit balance.

As discussed earlier, if the user has made a number of purchases debiting the available cash balance, and does not have enough cash balance on hand to cover a demand draft (personal check that debits the cash balance), or an ATM cash withdrawal for that matter, an available credit balance that is a part of the global account can issue a cash advance to cover the cash balance deficit (using “Rescue or Reject” or “Best Fit” criteria to access an available credit balance obtain a cash advance for cash withdrawals). Such cash advances carry fees that end users may not like, so a cash overdraft due to a personal check, a desired ATM withdrawal, and the like can be remedied using a readjustment mechanism comprising transaction specific readjustments or amount specific readjustment described above. Here, an appropriate setting on the transaction processor can detect an overdraft condition, and perform a readjustment comprising a transaction specific readjustment or amount specific readjustment that converts debits to the cash balance into debits to the credit balance, thus producing cash in the amount necessary to cover the overdraft. While it is possible for a readjustment that addresses an overdraft condition to comprise a manual entry by the end user, a preferred embodiment is where the transaction processor, upon detection of the overdraft condition, performs the readjustment automatically. Readjustments correcting overdraft conditions can be seen in the following examples.

Here is an illustration of transaction activity where only the available cash balance was used. For the purpose of these examples, let's assume that there is a zero available cash balance remaining after these $933.00 of transactions have taken place, that the entire $933.00 amount is available for readjustment onto the available credit balance, freeing up to $933.00 of the available cash balance for whatever purposes, and that there is an adequate available credit balance to handle any readjustments that are to take place.

| Date | Description | Amount | Cash | Credit |
|---|---|---|---|---|
| 01-02 | Restaurant | 48.00 | 48.00 | -0- |
| 01-03 | Gasoline | 21.00 | 21.00 | -0- |
| 01-05 | Shoe Store | 36.00 | 36.00 | -0- |
| 01-06 | Supermarket | 63.00 | 63.00 | -0- |
| 01-14 | Gasoline | 15.00 | 15.00 | -0- |
| 01-18 | Appliance Store | 750.00 | 750.00 | -0- |
| | TOTAL | 933.00 | 933.00 | -0- |

To the above transaction activity, a $40.00 debit to the available cash balance is attempted. Remember that there is zero available cash balance that is available for debiting. The $40.00 debit can be anything from a check hitting a checking account (where the available cash balance is also used for check clearance as part of a checking account), an ATM cash withdrawal, etc. Rather than having the $40.00 check bounce, or the $40.00 ATM withdrawal be denied, and rather than having to rely on lines of credit or cash advances, a readjustment can be used to satisfy the overdraft condition as follows. Using a transaction specific readjustment on a FIFO basis (first in-first out, although any other basis or selection method may be used), the 01-02 restaurant entry, being the first transaction per the FIFO basis, is partially readjusted from the available cash balance to the available credit balance, where the available cash balance is credited for $40.00 and the credit balance is debited for $40.00, which the end user will have to pay back at a future time. This $40.00 addition to the available cash balance is used to satisfy the $40.00 overdraft condition in the available cash balance.

| Date | Description | Amount | Cash | Credit |
|---|---|---|---|---|
| 01-02 | Restaurant | 48.00 | 8.00 | 40.00 |

The 01-02 Transaction was Partially Readjusted to Satisfy a $40.00 Overdraft Condition to the Available Cash Balance

Now, an account issuer may choose to allow partial transaction readjustments for overdraft conditions, or could require that the entire transaction be readjusted. In an instance where the entire 01-02 transaction amount of $48.00 is required to be adjusted, the available credit balance will be debited for $48.00, and the available cash balance will be credited $48.00, which not only enables the $40.00 overdraft to be covered, but also leaves a remainder of $8.00 to be credited to the available cash balance.

Keeping in mind that, per the above transaction activity, $933.00 is available for readjustment onto the available credit balance, use of an amount specific readjustment to satisfy the same $40.00 overdraft condition can be seen by the following notation:

“End User Has a $40.00 Debit to the Available Credit Balance as a Result of Readjustment(s) to Satisfy Overdraft(s) to the Available Cash Balance—End User Has $893.00 Remaining of Cash Balance Purchases that are Available for Readjustment onto the Available Credit Balance”.

Again, the $40.00 that was readjusted onto the available credit balance will have to be repaid by the end user at a future time.

Readjustments to satisfy overdraft conditions per this disclosure have the capability to be quite flexible. Any available credit balance(s) may be readjusted to satisfy overdraft conditions in any available cash balance(s), and/or any other available credit balance(s), whereas any available cash balance(s) may be readjusted to satisfy overdraft conditions in any available credit balance(s), and/or any other available cash balance(s). It should be thoroughly understood that readjustments as a remedy for overdraft conditions is a very different method than merely using an unused portion of an available balance for the same purpose (such as the “Best Fit” and “Rescue and Reject” methods disclosed earlier), in that readjustments comprising transaction specific readjustments (where at least one transaction is readjusted), and/or amount specific readjustments (where a transaction amount is readjusted), require an extra step or operation, that being the readjustment itself, before the resultant unused portion of an available balance can be used to satisfy the overdraft condition.

Finally, a question here is whether the end user can make these readjustments after the billing cycle closes. It is certainly possible for the transaction processor to enable posted transactions to remain accessible for readjustment after the billing cycle closes, but it is not without difficulties. One consideration includes system capabilities. Another consideration involves where end users that carry a large credit balance due can become especially confused by the shear number of past transactions presented, which could tax customer services resources considerably. While there is certain value to being able to make readjustments to transactions up to the close of the billing cycle, the value of offering such accommodations after the close of the billing cycle certainly diminish, while the difficulties in offering such post-billing cycle readjustments certainly increase. Nonetheless, it is disclosed that an end user can make post-billing cycle readjustments, should the offering card entity/account provider choose to allow it

Interface

Controlling all of this capability is the interface. In most cases, it is desirable for the actual end user to be able to use the interface directly; however, it is possible for an embodiment to comprise where the end user uses the interface indirectly, such as where the end user calls up a customer service representative, and the customer service representative, acting as an intermediary, makes the actual changes to the global account or transaction processor using an interface on behalf of the end user.

Whatever the situation, the interface may comprise the usage of any communicative system component, format or technology, from any location. For example, the end user can access the interface via the Internet, by calling a customer service representative, by using use a menu driven phone system where the changing of parameters such as account debiting parameters is enabled by punching numbers on a phone (a tele-account system), via an intranet at the branch of the card-issuing bank, by fax, mail, etc.

It is foreseeable that such changes could be performed at a point-of-sale terminal; however, such an embodiment requires special equipment and programming, and could be difficult due to the expense and the level of cooperation needed to become widespread. Besides, having an end user toil with parameters at a point-of-sale terminal goes against the spirit of the present invention, which is basically to swipe and go, where having the transaction processor automatically perform specialized functions eliminates having to go through various rituals at a point-of-sale terminal. Nonetheless, it is disclosed that such an end user interface for the transaction processor could very well comprise a point-of-sale terminal, or an accessory terminal, or any type of access, at or near an actual point-of-sale.

An end user that wishes to make changes to the transaction processor regarding the debiting of the at least two available account balances and other parameters in a purchase environment can simply use a cell phone to either call up a customer service representative or access a tele-account system, or use a handheld personal assistant that enables wireless Internet access, and make the desired changes to the transaction processor in real-time before his purchases are tallied. Such capability saves time at the actual point-of-sale, is less taxing on the cashier, and is much more considerate of the other customers standing in line. The fact that the facilitating of capabilities with regard to account debiting and other parameters requires absolutely no special point-of-sale manipulations or equipment is viewed as advantageous.

Smart Data Card Embodiment

As mentioned earlier, the second embodiment of the transaction processor comprises the use of a smart data card embodiment. Smart data card embodiments used in point-of-sale environments require special point-of-sale equipment to take full advantage of the varied capabilities. For this application, the type of smart data card needed is a microprocessor card, which contains a microprocessor semiconductor chip. The smart data card links together and controls at least two available account balances, and enables a given transaction to be debited from the at least two available account balances from a point-of-sale terminal according to parameters discussed in the global account embodiment, such as at least one ratio, at least one amount threshold, at least one remainder threshold, and where parameters in the smart data card enable at least one given available account balance to be disengaged, minimum available balance parameters to be set, and maximum allowable transaction amounts to be set.

The smart data card embodiment of the transaction processor can be used with any combination of accounts, regardless of whether they are in-house or out-of-house to the entity that issues the smart data card. In fact, it is entirely possible for the provider of the smart data card to be a third-party entity that is in no way responsible for any of the available account balances accessible via the smart data card. In such an embodiment, the smart data card is programmed to access the available account balances using the various account numbers of the available account balances. For example, the microprocessor on the smart data card can be programmed to analyze an incoming transaction amount at a point of sale, and using a 50%-50% ratio debit the available cash account balance at institution #1 for half of the transaction amount while debiting an available credit balance at institution #2 for the remaining half of the transaction. Using a threshold example, the microprocessor on the smart data card can be programmed to automatically debit an available cash balance at institution #1 for transactions up to $50, and to debit an available credit balance at institution #2 for transactions above $50.

Also, the microprocessor on the smart data card can be programmed to debit available account balances according to Best Fit or Rescue or Reject criteria discussed earlier.

As is known in the art, a smart data card may be programmed, and parameters can be selected and/or modified using a smart data card interface. The smart data card interface may be part of, at the site of, or away from the site of the actual point-of-sale terminal.

While the transaction processor is envisioned to provided the end user great flexibility with regard to how a given transaction is debited from different available account balances, the it is possible that the entity that offers and administers the disclosed financial card account, or that offers the smart data card embodiment described herein, could elect to give an end user numerous options and choices, or could choose to pare down the capabilities available to the end user considerably. Also, said entity could choose to have certain parameters pre-established, where such parameters either possess or lack the capability to be changed or otherwise modified by the end user. As a result, embodiments and features of this invention can vary a great deal in the real world, depending on which capabilities a given offering entity chooses to provide and/or allow.

Transaction Debiting Via One or More Initial Available Account Balance(s)

Prior examples included where a transaction amount debited one or more available cash balances and/or one or more available credit balances depending on parameters per the transaction processor. Another method is where all transaction amounts debit an initial singular available account balance, where, depending on parameters per the transaction processor, either 1) a given transaction amount remains wholly as a debit to the initial singular available balance, 2) a given transaction amount remains as a partial debit to the initial singular available balance, whereby the balance of the partial debit is automatically moved from the initial singular available balance to at least one different available balance; or, 3) a given transaction amount, in its entirety, is automatically moved from the initial singular available balance to at least one different available balance.

While an initial purchase transaction debits an initial singular available balance, automatically moving, or transferring, a transaction amount from the initial singular available balance to at least one different available balance may be visualized as where the debit to the initial singular available balance is credited, and the at least one different available balance is debited, for the transaction amount that is being moved. Timeframe is another aspect that needs to be considered with regard to the automated movement, or transfer, of the transaction amount from the initial singular available balance to the at least one different available balance. While one may assume that, per the transaction processor making the transfer, that the desired transfer itself occurs immediately upon or after the debit to the initial singular available balance occurs, such may or may not necessarily be the case. The entity that offers the global account/transaction processor to the end user may choose any timeframe for when such transfers occur, such as immediately upon or after the debit to the initial singular available balance occurs; or, two minutes, two hours, two days, etc., after the debit to the initial singular available balance occurs. While such a cornerstone decision regarding timeframe is most likely best left to the entity that offers the global account/transaction processor to the end user, it is not impossible for the end user to have some, or much, say with regard to such timeframe parameters.

In the following example, all transactions debit an initial singular available credit balance. However, in this case, the transaction processor has a threshold parameter where the end user wants all transaction amounts up to $25 to debit his available cash balance, and all transaction amounts above $25 to debit the available credit balance. Therefore, while all amounts initially debit the available credit balance, for transaction amounts up to $25, the amount, within any specified timeframe, will be debited from the available cash balance, and credited to the available credit balance, resulting in a zero net balance to the initial credit balance for those transaction amounts of $25 and below. Due to concepts discussed earlier, such as Rescue and Reject and Best Fit, should there not be an adequate available cash balance to enable the transfer from the initial singular available credit balance debit to a debit to the available cash balance for those transaction amounts of $25 and below, the capability exists for those transaction amounts to remain as a debit to the initial singular available credit balance.

| | | | Initial | Amt Debited | Net Effect |
|---|---|---|---|---|---|
| | | Transaction | Credit | From | Initial |
| Date | Description | Amount | Bal Debit | Cash Bal | Credit |
| 01-02 | Restaurant | 48.00 | 48.00 | -0- | 48.00 |
| 01-03 | Gasoline | 21.00 | 21.00 | 21.00 | -0- |
| 01-05 | Shoe Store | 36.00 | 36.00 | -0- | 36.00 |
| 01-06 | Supermarket | 63.00 | 63.00 | -0- | 63.00 |
| 01-14 | Gasoline | 15.00 | 15.00 | 15.00 | -0- |
| 01-18 | Appliance | 750.00 | 750.00 | -0- | 750.00 |
| | Store | | | | |
| 01-24 | Gasoline | 18.00 | 18.00 | 18.00 | -0- |
| 01-30 | Restaurant | 33.00 | 33.00 | -0- | 33.00 |

| | | | | |
|---|---|---|---|---|
| TOTAL | 984.00 | 984.00 | 54.00 | 930.00 |

What is interesting is that by setting the transaction processor so that all transaction amounts which debit the initial singular available credit balance are automatically zeroed out (within any specified timeframe) by an available cash balance, the global account behaves similarly to a standard debit card account, but with the irony of employing an available credit balance.

In the example that follows, again, all transactions debit an initial singular available credit balance. However, in this case, the transaction processor has a threshold parameter where the end user desires that amounts up to and including the first $20 of all transaction amounts will debit his available cash balance, and that all remainder amounts above $20 will debit the available credit balance. Therefore, while all amounts initially debit the available credit balance, amounts up to and including the first $20 of each transaction, within any specified timeframe, will be debited from the available cash balance, and credited to the available credit balance, resulting in a zero net balance to the initial credit balance for those transaction amounts of $25 and below.

| | | | Initial | Amt Debited | Net Effect |
|---|---|---|---|---|---|
| | | Transaction | Credit | From | Initial |
| Date | Description | Amount | Bal Debit | Cash Bal | Credit |
| 01-02 | Restaurant | 48.00 | 48.00 | 20.00 | 28.00 |
| 01-03 | Gasoline | 21.00 | 21.00 | 20.00 | 1.00 |
| 01-05 | Shoe Store | 36.00 | 36.00 | 20.00 | 16.00 |
| 01-06 | Supermarket | 63.00 | 63.00 | 20.00 | 43.00 |
| 01-14 | Gasoline | 15.00 | 15.00 | 15.00 | -0- |
| 01-18 | Appliance | 750.00 | 750.00 | 20.00 | 730.00 |
| | Store | | | | |
| 01-24 | Gasoline | 18.00 | 18.00 | 18.00 | -0- |
| 01-30 | Restaurant | 33.00 | 33.00 | 20.00 | 13.00 |

| | | | | |
|---|---|---|---|---|
| TOTAL | 984.00 | 984.00 | 153.00 | 831.00 |

While it is perceived as preferable that having an initial singular available balance from which all transactions are debited be a credit balance as opposed to a cash balance, it is possible to have the initial singular available balance be a cash balance. In the following example, all transactions are debited from an initial singular available cash balance. In this case, the end user wants all transaction amounts above $50 to debit the available credit balance and credit the available cash balance, while transactions up to and including $50 remain as a debit to the available cash balance.

| | | | Initial | Amt Debited | Net Effect |
|---|---|---|---|---|---|
| | | Transaction | Cash | From | Initial |
| Date | Description | Amount | Bal Debit | Credit Bal | Cash |
| 01-02 | Restaurant | 48.00 | 48.00 | -0- | 48.00 |
| 01-03 | Gasoline | 21.00 | 21.00 | -0- | 21.00 |
| 01-05 | Shoe Store | 36.00 | 36.00 | -0- | 36.00 |
| 01-06 | Supermarket | 63.00 | 63.00 | 63.00 | -0- |
| 01-14 | Gasoline | 15.00 | 15.00 | -0- | 15.00 |
| 01-18 | Appliance | 750.00 | 750.00 | 750.00 | -0- |
| | Store | | | | |
| 01-24 | Gasoline | 18.00 | 18.00 | -0- | 18.00 |
| 01-30 | Restaurant | 33.00 | 33.00 | -0- | 33.00 |

| | | | | |
|---|---|---|---|---|
| TOTAL | 984.00 | 984.00 | 813.00 | 171.00 |

A subtle variation is where all transactions debit an initial singular available balance (whether credit or cash balance), but then a given transaction amount, in its entirety, is automatically transfer or moved from the initial singular available balance to at least one different available balance, where the net effect on the initial credit balance always zeroes out. As discussed earlier, in the case where the initial singular available balance is a credit balance, the given transaction amounts that the transaction processor assigns to debit the available cash balance(s) are used in order to credit (and zero out) the initial credit balance. The variation is illustrated with an example comprising at least one additional or “sub” available credit account balance. In this example, transaction amounts up to and including $25 have the available cash balance crediting the debit to the initial singular available credit balance that was created by the transaction, which results in a debit to the available cash balance; whereas transaction amounts above $25 have the “sub” available credit balance crediting the debit to the initial singular available credit balance created by the transaction, which results in a debit to the “sub” available credit balance. This gives rise to where one available credit balance (the initial singular available credit balance) is zeroed out (credited) by debiting a different available credit balance (the “sub” available credit account balance). As mentioned before, any desired timeframe for this transfer, or “zeroing out” is possible. It is this debit to the “sub” available credit account balance that the end user ultimately pays.

| | | | | Amt | Sub | Net |
|---|---|---|---|---|---|---|
| | | | | Debited | Credit | Effect |
| | | Trans | Ini Credit | Frm Cash | Bal | Ini |
| Date | Description | Amount | Bal Debit | Bal | debit | Credit |
| 01-02 | Restaurant | 48.00 | 48.00 | -0- | 48.00 | -0- |
| 01-03 | Gasoline | 21.00 | 21.00 | 21.00 | -0- | -0- |
| 01-05 | Shoe Store | 36.00 | 36.00 | -0- | 36.00 | -0- |
| 01-06 | Supermarket | 63.00 | 63.00 | -0- | 63.00 | -0- |
| 01-14 | Gasoline | 15.00 | 15.00 | 15.00 | -0- | -0- |
| 01-18 | Appliance | 750.00 | 750.00 | -0- | 750.00 | -0- |
| | Store | | | | | |
| 01-24 | Gasoline | 18.00 | 18.00 | 18.00 | -0- | -0- |
| 01-30 | Restaurant | 33.00 | 33.00 | -0- | 33.00 | -0- |

| | | | | | |
|---|---|---|---|---|---|
| TOTAL | 984.00 | 984.00 | 54.00 | 930.00 | -0- |

The following example illustrates a more complex embodiment where a transaction amount, instead of debiting an initial singular available balance whereby a given transaction amount may or may not be transferred to at least one different available balance, debits instead an initial plurality of available balances, whereby any or all of the initial plurality of available balances may or may not be transferred to at least one different available balance. Here, transaction amounts above $25 debit the initial credit balance, while transaction amounts up to and including $25 debit the initial cash balance. Within any specified timeframe, the net effect on the initial credit and initial cash balances is where they are “zeroed out” by their respective “sub” credit and “sub” cash accounts. There can be any reason for desiring such levels of complexity. Being that available balances comprising the global account, whether available cash balances or available credit balances, may comprise any combination of in-house or out-of-house accounts, one possible reason for having relatively complex embodiments could be where the initial credit and cash balances are in-house balances, whereas one or more of the “sub” balances are out-of-house balances.

| | | Trans | Ini Credit | Ini Cash | Sub Credit | Sub Cash | Net Effect |
|---|---|---|---|---|---|---|---|
| Date | Description | Amount | Bal Debit | Bal Debit | Bal Debit | Bal Debit | Ini Acct Bal |
| 01-02 | Restaurant | 48.00 | 48.00 | -0- | 48.00 | -0- | -0- |
| 01-03 | Gasoline | 21.00 | -0- | 21.00 | -0- | 21.00 | -0- |
| 01-05 | Shoe Store | 36.00 | 36.00 | -0- | 36.00 | -0- | -0- |
| 01-06 | Supermkt | 63.00 | 63.00 | -0- | 63.00 | -0- | -0- |
| 01-14 | Gasoline | 15.00 | -0- | 15.00 | -0- | 15.00 | -0- |
| 01-18 | Applnce Str | 750.00 | 750.00 | -0- | 750.00 | -0- | -0- |
| 01-24 | Gasoline | 18.00 | -0- | 18.00 | -0- | 18.00 | -0- |
| 01-30 | Restaurant | 33.00 | 33.00 | -0- | 33.00 | -0- | -0- |

| | | | | | | |
|---|---|---|---|---|---|---|
| TOTAL | 984.00 | 930.00 | 54.00 | 930.00 | 54.00 | -0- |

Debiting Criteria Based on Timeframe Used to Alternate Two or More Available Credit Balances with Staggered Billing Cycles

The transaction processor can enable account-debiting parameters to be adjusted according to specified timeframes. A specified timeframe may be as short as a 24-hour cycle (or even shorter) or as long as a billing cycle (or longer). Per the present invention, a timeframe may be expressed in any manner, such as clock time (5:00 AM), date (January 1), in terms of the billing cycle (half way through cycle, at the start of a new cycle, 15 days after the start of the billing cycle, 15 days before the end of the billing cycle, etc.), and so on. Also in the above examples and description were account-debiting examples illustrating two available credit balances, where some could question the usefulness of having two available credit balances.

To review, the global account used in conjunction with the transaction processor may comprise any number and combination of in-house and/or out-of-house available account balances. While many examples illustrated one available cash balance and one available credit balance, the includes global accounts comprising only a plurality of available cash balances, or only a plurality of available credit balances.

There are certain end users that use two or more credit cards during the course of a given timeframe, with the reason being that the end users would prefer to not make a purchase with a credit card whose billing cycle is about to close, and they would rather make the purchase using the credit card that has the most time left before the close of the billing cycle so there is more time before the actual payment for the purchase has to be dealt with. Also, with all other things being equal, the credit card whose billing cycle ends sooner most likely has the highest balance due, so certain users that don't want to see the balance due get too high would use another card instead that has the close of the billing cycle further out that would likely have a lower balance due.

Using a global account comprising, say, two available credit balances, and the available account balance debit capabilities of the transaction processor with regards to timeframe, the billing cycles of each of the two available credit balances may be staggered so that one available account balance's billing cycle ends in the middle of a given month, whereas the second available account balance's billing cycle ends at the end of the same month. The transaction processor may be instructed to do this, or may offer such an option to the end user, in any expressed way, such as “debit the available credit balance with the longest remaining billing cycle”, “debit the available credit balance with the newest billing cycle”, “debit the available credit balance with the furthest billing cycle closing date”, “debit available credit balance #1 from the first day of the month to the fifteenth day of the month, then debit available credit balance #2 from the sixteenth day of the month to the last day of the month”, where the billing cycles are coincident with the dates. In the case of the first available account balance starting a new billing cycle, debiting can occur for half of the billing cycle until the second available credit balance starts its new billing cycle, to which the second available credit balance automatically takes over. Under this condition, the end user never has a purchase occur during the last half of a billing cycle; however, due to “Best Fit” and “Rescue or Reject” criteria, the unused available credit balance (as well as an available cash balance, should the particular global account embodiment have one) may be used to save a transaction at a point-of-sale, which also saves the end user from an embarrassing situation. Such a use of the transaction processor will enable the two (or more) available credit balances to leapfrog each other seamlessly and automatically, while the end user uses the same card and global account, without needing to perform any extraordinary point-of-sale procedures. This is a superior advantage for a given card issuer in those situations where the end user normally uses a competitor's card because the given card issuer's card is getting “too close” to the end of its billing cycle. Such an embodiment is useful for accounts used by businesses, where any legitimate means of delaying payment on a purchase buys time for accounts receivables to trickle in.

The following example shows the current month's activity for two available credit balances, Credit #1 and Credit #2. Credit #1's billing cycle starts at, and is the “freshest” or “newest” at the beginning of the current month. Credit #1's billing cycle closes at the end of the current illustrated month; however, no transactions are debited from Credit #1's available balance after 01-15, even though there are two weeks before the close of Credit #1's billing cycle, due to the fact that on 01-15, Credit #2's billing cycle became the “freshest” or “newest” billing cycle, with transactions after 01-15 being debited from Credit #2's available balance, which will close on the 15^{th} day of next month. As per the transaction processor's settings, on the first day of next month, Credit #1's billing cycle will then become the freshest billing cycle, and will be used for debiting transaction amounts.

| Date | Description | Amount | Credit #1 | Credit #2 |
|---|---|---|---|---|
| 01-02 | Restaurant | 48.00 | 48.00 | -0- |
| 01-03 | Gasoline | 21.00 | 21.00 | -0- |
| 01-05 | Shoe Store | 36.00 | 36.00 | -0- |
| 01-06 | Supermarket | 63.00 | 63.00 | -0- |
| 01-14 | Gasoline | 15.00 | 15.00 | -0- |
| 01-18 | Appliance Store | 750.00 | -0- | 750.00 |
| 01-24 | Gasoline | 18.00 | -0- | 18.00 |
| 01-30 | Restaurant | 33.00 | -0- | 33.00 |
| | TOTAL | 984.00 | 183.00 | 801.00 |

What should be noted is that having two available credit balances requires twice the amount of work regarding making payments; however, one must remember that individuals using more than one credit card are already accustomed to the extra work required in maintaining separate card accounts.

In the global account, the transaction processor may comprise two or more available credit balances that enables the end user to have the options of offsetting billing cycles and available balance debiting criteria, and other parameter related criteria as well, such as percentage/ratio and/or threshold of transaction amounts and/or available balances as criteria for debiting among a plurality of available credit balances.

This particular embodiment of at least two available credit balances that switch with one another according to billing cycle/date parameter is not only a useful option selectable by the end user, but also has the potential to be its own freestanding credit card “product” offering by an issuer. In such an embodiment, a card/account issuer could purposely limit the myriad possibilities of the transaction processor to merely offer the end user a global account comprising at least two available credit balances with staggered billing cycles (say, one billing cycle that starts and ends midmonth, and another that starts and ends at the end of the month), where the transaction processor assigns transactions to each of the available credit balances in a way that optimizes the length of time between when the purchase is made and how soon the customer has to pay for it. On the other hand, a card/account issuer could choose to offer an embodiment where the issuer minimizes the amount of time a customer has to pay for transactions by assigning transactions to the available credit balance whose billing cycle closes the soonest; however, customers could very well rebel.

Singular Account Balance that May be Split into Two or More Available Account Balances, and May Optionally be Recombined Back to a Singular Account Balance

A global account may also take the guise of an account that has only one singular account balance, such as a singular available credit balance with a singular billing cycle, where the transaction processor has the capability to split a singular account balance into two or more available balances, with (or even without) offsetting billing cycles. Such a global account may allow any or all capabilities disclosed in this and the above examples such as percentage/ratio functions, transaction amount/available balance thresholds, etc. In the case of a singular credit balance that can be split, credit limit amounts may be established for each of the available credit balances individually, or a total global credit limit amount may be established that encompasses all of the available credit balances. Conversely, thanks to the transaction processor, the account user or issuer can optionally have the capability to undo the split by recombining the plurality of available credit balances back into a singular balance, which is especially useful should, say, an end user decide that maintaining more than one available credit balance is unwieldy. An issuer's existing user accounts comprising an available credit balance (as in a standard credit card account) that do not have such capability may even be modified with the transaction processor described herein. Such account-splitting capabilities lend themselves not only to global accounts with one available account balance, but may be adapted to work with a global account comprising at least two available account balances, where one or more of the available account balances may be split and (optionally) recombined.

Here's an example illustrating where two available credit balances with staggered billing cycles are used in conjunction with an available cash balance as a sample of the myriad combinations that the transaction processor enables. The transaction processor is set up to where transactions up to $50.00 debit the available cash balance; transactions above $50.00 and up to $100.00 debit the available credit balance with the nearest billing cycle close (“Credit #1”); and transactions above $100.00 debit the available credit balance with the furthest billing cycle close (“Credit #2”). Such a setup assures that while relatively smaller purchases debit the available credit balance closer to the billing cycle close, relatively larger purchases will always debit the available balance that has a billing cycle close that is further out.

| Date | Description | Amount | Cash | Credit #1 | Credit #2 |
|---|---|---|---|---|---|
| 01-02 | Restaurant | 48.00 | 48.00 | -0- | -0- |
| 01-03 | Gasoline | 21.00 | 21.00 | -0- | -0- |
| 01-05 | Shoe Store | 36.00 | 36.00 | -0- | -0- |
| 01-06 | Supermarket | 63.00 | -0- | 63.00 | -0- |
| 01-14 | Gasoline | 15.00 | 15.00 | -0- | -0- |
| 01-18 | Appliance Store | 750.00 | -0- | -0- | 750.00 |
| 01-24 | Gasoline | 18.00 | 18.00 | -0- | -0- |
| 01-30 | Restaurant | 33.00 | 33.00 | -0- | -0- |

| | | | | |
|---|---|---|---|---|
| TOTAL | 984.00 | 171.00 | 63.00 | 750.00 |

Before the next discussion commences, what needs to be understood is that parameters such as ratio, threshold, minimum balance, etc. can be continually changed at will. For example, at the beginning of a new billing cycle, an end user can elect to have transactions debit 50% available cash and 50% available credit, while in the middle of the billing cycle the end user can introduce a new threshold parameter, while near the end of the billing cycle, the end user changes a ratio to debit account balances for transactions using 20% available cash and 80% available credit.

Splitting an Available Balance

Possible ways by which to achieve the desired end of splitting an available account balance comprise:

Enable the original, non-split, available account balance to be split, or converted, into two or more like-kind available balances by a) using a transaction processor instruction change that changes the debiting timeframe of the original available balance; and, b) switching on at least one additional available balance, where the transaction processor coordinates the debiting timeframe(s) of the at least one additional available balance with the timeframe change of the available original balance.

Enable the original, non-split, available account balance to be replaced by two or more like-kind available balances by a) switching off the original available balance; and, b) switching on at least two additional available balances, where the transaction processor coordinates the debiting timeframes among the at least two additional available balances.

The switching on and off of available balances may be realized in any manor. For example, an available balance may have a “toggle” that switches it on or off, similar to where the transaction processor enables an end user the capability to turn on or off an available balance at will. Other means of switching on and off available balances include using an available balance debiting instruction change, such as where the transaction processor can change an account debiting ratio or percentage parameter for a given available balance from 100% (debit the full transaction amount from a given available balance) to 0% (debit none of the transaction amount from a given available balance).

While the capability is envisioned to be especially useful for credit balances, it is nonetheless adaptable for cash balances as well.

This first example illustrates transactions debiting only the original available credit balance, whereby the end user has not elected the option splitting the original available balance into two available balances. If we visualize this in terms of a singular billing cycle that ends on 1/31, when the account issuer closes the cycle and sends out the billing statement, the end user then has to make some form of reconcilement to the account issuer such as payment, interest due, etc. This 1/31 end of billing cycle gives the end user very little “breathing room” on the purchase made immediately before the close of the billing cycle.

| | | Transaction | Debit to Orig | Debit to Split |
|---|---|---|---|---|
| Date | Description | Amount | Credit Bal | Credit Bal |
| 01-02 | Restaurant | 48.00 | 48.00 | -0- |
| 01-03 | Gasoline | 21.00 | 21.00 | -0- |
| 01-05 | Shoe Store | 36.00 | 36.00 | -0- |
| 01-06 | Supermarket | 63.00 | 63.00 | -0- |
| 01-14 | Gasoline | 15.00 | 15.00 | -0- |
| 01-18 | Appliance Store | 750.00 | 750.00 | -0- |
| 01-24 | Gasoline | 18.00 | 18.00 | -0- |
| 01-30 | Restaurant | 33.00 | 33.00 | -0- |
| | TOTAL | 984.00 | 984.00 | -0- |

In the following example, the original singular available credit balance is split. Here, the original available credit balance is debited until 1/15. At that point, it basically becomes dormant with regard to debiting until the after end of the month (where it would become active again at the start of the next month). The split balance originates (or begins anew) and is debited from 1/16 until the end of the month (1/31), then it becomes dormant with regard to debiting until after 2/15, when it restarts debiting. The account issuer can arrange for reconcilement (bill payment, interest accumulation, etc.) of the first billing cycle, which is now a half debiting cycle (1/1 to 1/15) to not be due until after 1/31, and reconcilement for the second half billing cycle (1/16 to 1/31) to not be due until after 2/15. This way, an end user can make a large purchase on the last day of the month, which, under the old system was the last day of the billing cycle, and have at least two weeks before reconcilement is due.

| | | Transaction | Debit to Orig | Debit to Split |
|---|---|---|---|---|
| Date | Description | Amount | Credit Bal | Credit Bal |
| 01-02 | Restaurant | 48.00 | 48.00 | -0- |
| 01-03 | Gasoline | 21.00 | 21.00 | -0- |
| 01-05 | Shoe Store | 36.00 | 36.00 | -0- |
| 01-06 | Supermarket | 63.00 | 63.00 | -0- |
| 01-14 | Gasoline | 15.00 | 15.00 | -0- |
| 01-18 | Appliance Store | 750.00 | -0- | 750.00 |
| 01-24 | Gasoline | 18.00 | -0- | 18.00 |
| 01-30 | Restaurant | 33.00 | -0- | 33.00 |
| | TOTAL | 984.00 | 183.00 | 801.00 |

The following embodiment shows a variation, which achieves a similar result to the above, where the end user decides to use split balances instead of the original full billing cycle balance. In this instance, the original full-cycle credit balance is rendered dormant by the transaction processor, with subsequent activity taking place between split available credit balance #1, and split available credit balance #2. As an aside, in reference to any of these examples, the question of credit limit comes into play. Any one available balance, regardless of whether it is the original balance, or a split balance, may have has its own available credit limit; or, any two or more available balances within a plurality of available balances may share a total credit limit.

| | | | | Debit to | Debit to |
|---|---|---|---|---|---|
| | | | Debit to | Split | Split |
| | | Transaction | Orig | Credit | Credit |
| Date | Description | Amount | Credit Bal | Bal #1 | Bal #2 |
| 01-02 | Restaurant | 48.00 | -0- | 48.00 | -0- |
| 01-03 | Gasoline | 21.00 | -0- | 21.00 | -0- |
| 01-05 | Shoe Store | 36.00 | -0- | 36.00 | -0- |
| 01-06 | Supermarket | 63.00 | -0- | 63.00 | -0- |
| 01-14 | Gasoline | 15.00 | -0- | 15.00 | -0- |
| 01-18 | Appliance Store | 750.00 | -0- | -0- | 750.00 |
| 01-24 | Gasoline | 18.00 | -0- | -0- | 18.00 |
| 01-30 | Restaurant | 33.00 | -0- | -0- | 33.00 |

| | | | | |
|---|---|---|---|---|
| TOTAL | 984.00 | -0- | 183.00 | 801.00 |

Billing Cycles Created/Triggered by End User

Up until this point, enabling one split balance cuts the standard billing cycle in half, where each of the two balances are debited for half a billing cycle. It is certainly possible, and within the scope of this disclosure, for more than two balances to be effected (where three balances would each be debited for a third of a billing cycle, four balances would each be debited for a quarter of a billing cycle, etc), although the end result could become unwieldy. What is also within the scope is where the end user could wish to initiate a splitting of a singular available balance, or an additional splitting of an already existing plurality of balances, at a random point in the billing cycle that does not coincide with the half-point, third-point, quarter-point, etc., of the billing cycle. Say an end user wishes to place an especially large charge on his available credit balance, and wishes to maximize the amount of time before the bill becomes due. He can create the start of a new billing cycle, either by originating the new billing cycle “at-will” when desired (where the end user simply starts or otherwise specifies the start of a new billing cycle in real-time), or by using a date parameter to schedule the start time of the new billing cycle, either pre-dating or scheduling ahead of time (specifying on a Monday the start of a new billing cycle two days later on a Wednesday), or even post-dating after the fact (where the end user specifies on say, a Wednesday, that a new billing cycle was to start two days prior, on the previous Monday). While the ability to pre-date the start billing cycle has certain organizational advantages, being able post-date the start of a billing cycle is very useful whereby if the end user made a large purchase on a Monday, and decided two days later on a Wednesday that he wanted the Monday purchase on a new billing cycle, he would be able to create on Wednesday a new billing cycle that started two days earlier on the prior Monday. In any event, once the new cycle is originated, new purchase transaction debits on the current billing cycle can discontinue (where the prior billing cycle would be rendered dormant for new charges, but not for repayment) and new purchase transaction debits can take place on the newly originated cycle.

| | | Transaction | Debit to Orig | Debit to New |
|---|---|---|---|---|
| Date | Description | Amount | Credit Bal | Credit Bal |
| 01-02 | Restaurant | 48.00 | 48.00 | -0- |
| 01-03 | Gasoline | 21.00 | 21.00 | -0- |
| 01-05 | Shoe Store | 36.00 | 36.00 | -0- |
| 01-06 | Supermarket | 63.00 | 63.00 | -0- |
| 01-14 | Gasoline | 15.00 | 15.00 | -0- |
| 01-18 | USER CREATES NEW BILLING CYCLE FOR APPLIANCE | | | |
| | STORE PURCHASE | | | |
| 01-18 | Appliance Store | 750.00 | -0- | 750.00 |
| 01-19 | USER REVERTS BACK TO OLD BILLING CYCLE FOR | | | |
| | REMAINDER OF MONTH | | | |
| 01-24 | Gasoline | 18.00 | 18.00 | -0- |
| 01-30 | Restaurant | 33.00 | 33.00 | -0- |
| | TOTAL | 984.00 | 234.00 | 750.00 |

In this example, the original available credit balance is in force. The end user, realizing that he has a large $750 purchase to make, wants to optimize the length of time that he has to pay for it, creates a new billing cycle “at-will” just prior to making the desired purchase. To him, this is absolutely superior to using another credit card account, because the other account's billing cycle could be closing sooner than desired, wherein with the present disclosure, the user is assured the maximum time on the “at-will” created billing cycle.

It is conceivable that an end user could want the option of reverting back to debiting his preexisting billing cycle. In the above example, on 01-19, the end user, via the transaction processor, reverts back to his old billing cycle, while the newly created billing cycle carrying the $750 appliance store debit is rendered dormant. Of course, the additional purchases subsequent to the 01-18 $750 appliance store purchase can very well remain on the same billing cycle as the 01-18 appliance purchase, should such be desired.

When considering the creation of a new billing cycle, any parameter(s), which also comprise those that have been mentioned earlier with regard to transaction processor debiting, may be used as a trigger. For example, in addition to the earlier mentioned date parameter where the user can schedule the start of the newly created cycle to coincide with a given date, on a pre-dated or post-dated basis, another parameter could be consumption of an available balance, so when, say, at least $1000 of the original balance is consumed, a new billing cycle begins for subsequent purchases. Even more interestingly, a given trigger could be a transaction threshold amount, so the end user in the above example, instead of creating a new billing cycle “at-will” on 01-18, could just as easily set an amount threshold where transactions above $500 will trigger the start of a new billing cycle, where, per the above example, the 01-18 $750 appliance store purchase would automatically trigger a new billing cycle. Limits on the number of billing cycles that may be created are purely optional, in that theoretically an account issuer could possibly even allow an end user to create an unlimited number of billing cycles, either created “at-will”, or triggered by any such parameter.

The following is a somewhat exaggerated and complex example of the capabilities of billing cycles triggered/created by an end user, using a range of parameters for triggering or creating new credit balance billing cycles. The end user starts off with a zero balance on an original credit balance. Upon consuming at least $2000 of the original billing cycle balance (debiting an available balance for at least $2000 using a consumption of an available balance parameter), he wants a new billing cycle to begin.

Should a single transaction (using a transaction threshold parameter) be greater than or equal to $3000, he wants yet another new billing cycle to begin, but only for the large single transaction. On the 15′ day of the month, he wants yet another new billing cycle to begin (using a date parameter for a predated billing cycle scheduling, although he can have a post-dated billing cycle scheduling should he so choose as well).

| | | Transaction | Debit to 1^{st} | Debit to 2^{nd} | Debit to 3^{rd} | Debit to 4^{th} | Debit to 5^{th} |
|---|---|---|---|---|---|---|---|
| Date | Description | Amount | Credit Bal | Credit Bal | Credit Bal | Credit Bal | Credit Bal |
| 01-02 | Airfare | 800.00 | 800.00 | — | — | — | — |
| 01-03 | Hotel | 800.00 | 800.00 | — | — | — | — |
| 01-04 | Shopping | 500.00 | 500.00 | — | — | — | — |
| 01-04 | AT LEAST $2000 HAS BEEN CONSUMED ON THIS BILLING | | | | | | |
| | CYCLE - NEW BILLING CYCLE WILL BEGIN | | | | | | |
| 01-09 | Supermarket | 100.00 | — | 100.00 | — | — | — |
| 01-10 | Gasoline | 50.00 | — | 50.00 | — | — | — |
| 01-11 | Jewelry Store | 3,000.00 | — | — | 3,000.00 | — | — |
| 01-11 | NEW BILLING CYCLE FOR LARGE SINGLE TRANSACTION | | | | | | |
| 01-12 | Appliance Store | 750.00 | — | 750.00 | — | — | — |
| 01-15 | NEW USER SCHEDULED BILLING CYCLE BEGINS | | | | | | |
| 01-16 | Gasoline | 45.00 | — | — | — | 45.00 | — |
| 01-16 | Restaurant | 60.00 | — | — | — | 60.00 | — |
| 01-17 | Supermarket | 120.00 | — | — | — | 120.00 | — |
| 01-18 | Mechanic | 350.00 | — | — | — | 350.00 | — |
| 01-20 | Mechanic | 750.00 | — | — | — | 750.00 | — |
| 01-21 | Gasoline | 50.00 | — | — | — | 50.00 | — |
| 01-23 | Mechanic | 475.00 | — | — | — | 475.00 | — |
| 01-26 | Supermarket | 100.00 | — | — | — | 100.00 | — |
| 01-28 | Car Dealer | 45,000.00 | — | — | — | — | 45,000.00 |

| | |
|---|---|
| 01-28 | NEW BILLING CYCLE FOR LARGE SINGLE TRANSACTION |

| | | | | | | |
|---|---|---|---|---|---|---|
| TOTAL | 52,950.00 | 2,100.00 | 900.00 | 3,000.00 | 1,950.00 | 45,000.00 |

The first billing cycle begins (debiting the 1^{st} credit balance), and continues until 01-04, when at least $2000 of the cycle's available credit balance is consumed, and is replaced by a new, second billing cycle (2^{nd} credit balance). The second billing cycle continues, but is temporary interrupted by a $3000 jewelry store purchase, where the $3000 purchase receives its own billing cycle (3^{rd} credit balance), triggered by a $3000.00 transaction threshold parameter pertaining to the amount of the purchase. Meanwhile, the 01-12 $750.00 Appliance Store purchase reverts back to the second billing cycle. On the 15^{th} of the month, the end user has scheduled a new billing cycle to begin (4^{th} credit balance) and continue, whereas on 01-28, the $3,000.00 transaction threshold parameter triggers yet another a new billing cycle (5^{th} credit balance) for a rather sizable $45,000.00 purchase (being a new car), which was probably purchased to put an end to the recent mechanic bills, at least for the time being. Of course, in place of a transaction threshold parameter, when an end user realizes that a large purchase is going to occur, or has recently occurred, it is within the scope of the transaction processor to allow the end user to set up a separate billing cycle for a purchase, or a group of purchases, before or after the purchases are made via pre-dated or post-dated billing cycle scheduling parameters. In fact, setting up a separate billing cycle for a purchase or group of purchases doesn't merely need to pertain to large transactions, but to any transactions desired by the end user. In the above example, there are five billing cycles illustrated, most likely more than what is practical. Nonetheless, it is within the capability of the transaction processor for a given transaction or group of transactions to be readjusted amongst any one, or more than one, of the available balances comprising the five billing cycles. Furthermore, should the end user find any of the five billing cycles be less than suitable for readjustment purposes, there exists the capability for the user to create one or more additional billing cycles, either by using a triggering parameter such as date or amount, or simply creating an additional billing cycle “at-will” in real-time.

The following is where the end user in the above example decided to readjust everything from the first four available credit balances/billing cycle over to the fifth available credit balance/billing cycle.

| | | Transaction | Debit to 1^{st} | Debit to 2^{nd} | Debit to 3^{rd} | Debit to 4^{th} | Debit to 5^{th} |
|---|---|---|---|---|---|---|---|
| Date | Description | Amount | Credit Bal | Credit Bal | Credit Bal | Credit Bal | Credit Bal |
| 01-02 | Airfare | 800.00 | (800.00) | — | — | — | 800.00 |
| 01-03 | Hotel | 800.00 | (800.00) | — | — | — | 800.00 |
| 01-04 | Shopping | 500.00 | (500.00) | — | — | — | 500.00 |
| 01-09 | Supermarket | 100.00 | — | (100.00) | — | — | 100.00 |
| 01-10 | Gasoline | 50.00 | — | (50.00) | — | — | 50.00 |
| 01-11 | Jewelry Store | 3,000.00 | — | — | (3,000.00) | — | 3,000.00 |
| 01-12 | Appliance Store | 750.00 | — | (750.00) | — | — | 750.00 |
| 01-16 | Gasoline | 45.00 | — | — | — | (45.00) | 45.00 |
| 01-16 | Restaurant | 60.00 | — | — | — | (60.00) | 60.00 |
| 01-17 | Supermarket | 120.00 | — | — | — | (120.00) | 120.00 |
| 01-18 | Mechanic | 350.00 | — | — | — | (350.00) | 350.00 |
| 01-20 | Mechanic | 750.00 | — | — | — | (750.00) | 750.00 |
| 01-21 | Gasoline | 50.00 | — | — | — | (50.00) | 50.00 |
| 01-23 | Mechanic | 475.00 | — | — | — | (475.00) | 475.00 |
| 01-26 | Supermarket | 100.00 | — | — | — | (100.00) | 100.00 |
| 01-28 | Car Dealer | 45,000.00 | — | — | — | — | 45,000.00 |

| | |
|---|---|
| 01-29 | TOTAL OF $7,950.00 READJUSTED TO FIFTH AVAILABLE CREDIT |
| | BALANCE/BILLING CYCLE |

| | | | | | | |
|---|---|---|---|---|---|---|
| TOTAL | 52,950.00 | (2,100.00) | (900.00) | (3,000.00) | (1,950.00) | 52,950.00 |

On 01-29, a total of $7,950.00 is readjusted to the fifth available credit balance, which as a result totals $52,950.00. At first glance, it seems that such a readjustment could take great advantage of the global account provider. Such could be true, to the point where the global account provider could choose to limit the considerable capabilities provided by the transaction processor to the end user. On the other hand, the global account provider could offer vast capabilities to those end users willing to pay for them. Per the above example, the global account provider could provide everything the end user wants to do in this example, in exchange for being able to charge accrued interest and/or related fees that could be considerably advantageous to the global account provider.

Recombining Split Balances

An end user, after splitting available account balances, could desire to recombine everything back into a single balance. Such recombination may be realized in any myriad of ways. One way is for the end user to either turn off, or eliminate entirely, one or more available balances until there is at least one balance remaining; or, turning off or eliminating all balances entirely, until the end user chooses to continue an existing billing cycle, or even chooses to newly create a billing cycle, where the new billing cycle is created based on any trigger, such as a user selected date, or a purchase transaction. This is especially easy if the balances that are to be turned off or eliminated are zeroed out (either have been unused for whatever reason, or have been paid off). As an option, it is possible to have the transaction processor eliminate an added or created billing cycle/account balance once it is paid off. This is potentially useful in terms of the user created billing cycles, wherein once the user created billing cycle is paid off, it is eliminated, and purchase transactions debit the default billing cycle or cycles.

Available account balances that have debits on them (such as those with purchase amounts outstanding) but have different billing cycles, may be recombined, although chances favor that the account issuer could want the recombined single balance to have the nearest closing billing cycle, rather than having purchases made using the nearest closing billing cycle be transferred to a further closing billing cycle.

Other possible ways of recombining all or some of the at least two-like kind available account balances back to an original, non-split, available account balance comprise:
1) By a) using an instruction change to the transaction processor that reverses, or otherwise modifies, the original changes to the debiting parameter(s) of the original, non-split, available account balance; and, b) switching off at least one of the at least one additional like-kind available account balance.
2) By a) switching off at least one of the at least two like-kind additional available account balances; and, b) switching on the original, non-split, available account balance.

Differing Point-Of-Sale Identifiers Triggering Differing Transaction Processor Account-Debiting Instructions

The transaction processor can enable a plurality of differing point-of-sale identifiers to trigger, or otherwise access, differing transaction parameter account-debiting instructions on a given global account. A simple example of this is where a point-of-sale identifier that is a first magnetic transaction card with a given account number at a point-of-sale triggers one set of account debiting instructions, such as where all transactions using the first magnetic transaction card debit an available cash balance, on a given global account; whereas a second magnetic card with a different account number triggers a different set of account debiting instructions, such as where all transactions using the second magnetic card debit an available credit balance. In this embodiment, the first card behaves as a cash debit card, while the second card behaves as a standard credit card. Myriad possibilities allow for a third, fourth, fifth, etc. magnetic transaction card, where each of the magnetic transaction cards comprise their own set of account debiting instructions that may be preset by the issuer, and/or be preset and/or be fully revisable by the end user, where the end user resets the account debiting parameters for any or all of the magnetic transaction cards.

Point-of-sale identifiers are unlimited with regard to potential embodiments. From a plurality of account numbers as accessed by multiple magnetic cards, to a point-of-sale prompt accessed by a singular card where the end user enters a selection comprising perhaps a menu choice or one of a plurality of PIN numbers, to biometrics, etc., any type of identifier source that allows for differentiation can be adapted and used. Using biometrics as an example, a fingerprint from an index finger can trigger one set of account debiting instructions, while a fingerprint from a thumb can trigger another set. Left eye, right eye, similar capabilities. Furthermore, point-of-sale identifiers for a given global account do not have to be like kind, so it is possible for an end user to have access to one set of transaction processor parameters using a magnetic card, and a different set of transaction processor parameters using a thumbprint. Furthermore, being that the transaction processor parameters can be continually selected or modified by the end user, it is possible for two or more non-like kind identifiers to trigger or access identical transaction processor parameters.

Any one or more of the plurality of differing point-of-sale identifiers may be turned on or off, either with a toggle, or by setting debiting parameters to “off”, or “zero”, where the “rescue” function may optionally be disengaged.

The following example illustrates a template of varied transaction processor settings for a plurality of magnetic cards, where, in this case, each of the plurality of magnetic cards comprises a different identifier, such as a different account number, and where each account number identifier corresponds to its own set of transaction processor settings for a given global account.

Card 1—#0000-0000-1234-1234

CARD ACCESS STATUS: ON

100% (ALL) OF TRANSACTION AMOUNTS DEBIT AVAILABLE CASH BALANCE #1 STATUS OF RESCUE FUNCTION FOR TRANSACTIONS IN CASE OF OVERDRAFT CONDITION: ON

Card 2—#0000-0000-2345-2345

CARD ACCESS STATUS: ON

100% (ALL) OF TRANSACTION AMOUNTS DEBIT AVAILABLE CREDIT BALANCE #1 STATUS OF RESCUE FUNCTION FOR TRANSACTIONS IN CASE OF OVERDRAFT CONDITION: ON

Card 3—#0000-0000-3456-3456

CARD ACCESS STATUS: ON

100% (ALL) OF TRANSACTION AMOUNTS UP TO $20 DEBIT AVAILABLE CASH BALANCE #1 TRANSACTION AMOUNTS BETWEEN $20 AND $50 DEBIT 50% (HALF) OF TRANSACTION AMOUNT FROM AVAILABLE CASH BALANCE #1, AND 50% (HALF) OF TRANSACTION AMOUNT FROM AVAILABLE CREDIT BALANCE #1

100% (ALL) OF TRANSACTION AMOUNTS ABOVE $50 DEBIT AVAILABLE CREDIT BALANCE #1 STATUS OF RESCUE FUNCTION FOR TRANSACTIONS IN CASE OF OVERDRAFT CONDITION: ON

Card 4—#0000-0000-45674567

CARD ACCESS STATUS: ON

100% (ALL) OF TRANSACTION AMOUNTS DEBIT AVAILABLE CASH BALANCE #2 MAXIMUM USE OF AVAILABLE BALANCE IN ONE CALENDAR MONTH BY THIS CARD—$200.00 STATUS OF RESCUE FUNCTION FOR TRANSACTIONS IN CASE OF OVERDRAFT CONDITION: OFF

Per the above example, Card 1 accesses transaction processor parameters set to act like a standard debit card; Card 2 accesses transaction processor parameters set to act like a standard credit card; Card 3 accesses transaction processor parameters set for two thresholds employing both an available cash balance and an available credit balance; and, Card 4 accesses transaction processor parameters set to act like a limited use debit card. In the above, Card 4 illustrates an interesting adaptation. Say that a family has the above global account, and the parents have a son that is going off to college. The parents want the son to have spending power, but they also want to have controls, so for Card 4, the parents set the (earlier disclosed) maximum allowable available account balance usage parameter to allow only a maximum $200.00 consumption of available cash balance #2 to be used in one calendar month. This example could be easily modified to illustrate use of an available credit balance in place of the available cash balance. Nonetheless, the maximum allowable available account balance usage parameter ensures that the son does not use more of the $200 available cash balance #2, and the turning off on the “RESCUE” function ensures that once the $200 limit is reached, that no other available balance(s) can rescue whatever additional transactions the son may consider. Should the son be in a situation requiring an amount increase, and he successfully pleads his case, the parents can alter the maximum allowable available account balance usage parameter to allow an increase; or, the parents can even revise the debiting parameters of Card 4 to debit an available credit balance instead of cash balance #2. Should the son demonstrate particular irresponsibility, the parents can reduce the maximum allowable available account balance usage parameter to a lower amount, or cut off the son entirely by switching the toggle (in this case, the “Card Access Status” parameter of Card 4) to “OFF”, which disables Card 4 and basically renders it useless.

Per the above, and in general, funding or replenishing any of a plurality of available cash balances may be done in myriad ways. For instance, should the parents wish to add money to available cash balance #2, the funds may be deposited directly into available cash balance #2, or transferred from at least one other available cash balance(s) comprising and/or not comprising the global account, either manually or automatically, using any criteria for deposit amount and/or balance level restoration. An example of balance level restoration is where, say, should an account balance fall to a predetermined amount, a set amount is added, or an amount is added that restores the balance level to a desired amount; whereas, another example is where, at the beginning or end of a period, or at any interim period point(s), a set amount is added, or an amount is added that restores the balance level to a desired amount. Additionally, cash balances may be replenished using readjustment mechanisms mentioned earlier, or by taking cash advances against any available credit balances, lines of credit, and the like.

The capability of turning/toggling on and off any of a plurality of differing point-of-sale identifiers tied to the global account provides a quick remedy for limiting global account access in the event that one or more said identifiers is lost or stolen. In the above embodiment using a plurality of magnetic cards where the identifier is an account number, upon realization that a card comprising the plurality has been lost or stolen, the end user can access the global account, and switch the lost or stolen card's access status to “OFF”, which disables the card, but still enables the remaining cards comprising said plurality to be used for accessing the global account by the end user, while the end user waits for a replacement of said lost or stolen card. Such is useful for a traveler whose wallet containing one of his global account cards is stolen. The traveler can access a spare or backup card that he keeps in his money belt, and/or luggage, and disable the stolen card by switching the stolen card's card access status to “OFF”, while enabling the spare card by switching spare card's card access status to “ON”, and perhaps revising any account debiting parameters pertaining to the spare card if necessary or desired. This is superior to keeping an activated credit card for an entirely different account in luggage, being that luggage does get lost and, if found by unauthorized individuals, the activated card can readily be fraudulently used. This feature offers an advantage over conventional credit card and debit card embodiments, where when the end user reports a stolen card, the attached account/available account balance is basically unusable until replacement cards are expedited to and activated by the end user.

simple vs. Advanced, Complex, Compounded, or Multi-Conditional Debiting Parameters

In understanding transaction processor functionality in relation to how available account balances are affected, examples of account balance debiting contained herein are based mainly using “IF/THEN” statements. Many presented examples are simple in nature, such as: “IF the transaction amount is equal to or less than $20, THEN debit the available cash balance; whereas, IF the transaction amount is greater than $20, THEN debit the available credit balance.”

Using any terminology that is contrary to “Simple”, such as “Advanced”, “Complex”, “Compounded”, or “Multi-Conditional”, it is within the range and scope of this disclosure that account balance debiting parameters can become quite involved.

Such an instance comprises where a simple “IF” condition results in a complex “THEN” result, such as: “IF the transaction amount is equal to or less than 10% of the available cash balance, THEN debit the first $50 of the transaction amount from the available cash balance, and debit any remainder of the transaction amount above $50 from the available credit balance; whereas, IF the transaction amount is greater than 10% of the available cash balance, THEN debit the first $25 of the transaction amount from the available cash balance, and debit any remainder of the transaction amount above $25 from the available credit balance.”

Another instance comprises where a complex “IF” condition results in a simple “THEN” result, such as: “IF the transaction amount is less than or equal to $100, AND the transaction is less than or equal to 10% of the available cash balance, AND the available cash balance is greater than the average monthly cash balance, THEN debit the transaction amount from the available cash balance; whereas, IF the transaction amount is greater than $100, OR IF the transaction is greater than 10% of the available cash balance, OR IF the available cash balance is less than the average monthly cash balance, THEN debit the transaction amount from the available credit balance.

Yet another instance comprises where a complex “IF” condition results in a complex “THEN” result, such as: “IF the transaction amount is less than or equal to $500, AND the transaction is less than or equal to 25% of the available cash balance, AND the available cash balance is greater than 50% the average monthly “high water” mark cash balance, THEN debit the first $250 of the transaction amount from the available cash balance, and debit any remainder of the transaction amount from the available credit balance with the nearest closing billing cycle; whereas, IF the transaction amount is greater than $500, OR IF the transaction is greater than 10% of the available cash balance, OR IF the available cash balance is less than the average monthly cash balance, THEN debit the first $100 of the transaction amount from the available cash balance, and debit any remainder of the transaction amount from the available credit balance with the furthest closing billing cycle.

Complexities and capabilities within the scope of this disclosure regarding transaction processor debiting parameters are limited only by what the provider of the transaction processor is willing to offer end users. It is foreseeable, given the myriad possibilities and permutations, that a given provider can offer end users capabilities that differ considerably from other providers' offered capabilities.

Miscellaneous Advantages

The present invention presents advantages regarding privacy for the end user in varied point-of-sale environments. Being that, in most cases, the transaction processor provides for the debiting of varied available account balances as desired by the end user well away from an actual given point-of-sale, a merchant cannot reliably ascertain whether the transaction at hand is debiting one or more available cash balances, and/or one or more available credit balances. Just as importantly, if not more so, other individuals standing in line with an end user at a given point-of-sale cannot determine whether the end user is using one or more available cash balances, and/or one or more available credit balances, which not only offers an extra measure of security, but safety as well. Such is illustrated by a purchaser that uses a PIN number debit card (which debits an available cash balance) to make a large purchase, whereby the purchaser basically “broadcasts” to surrounding others the possible existence of a large cash balance that can be potentially exploited, whereas the privacy advantages of the present invention thwarts any certainty that an end user has transacted a large purchase using an available cash balance, being that any assumptions by others of the nature of the available account balance(s) used by the end user are purely speculative. Other advantages are related to consolidation of expenditure activity. With the present invention, the end user can observe and control multiple available account balances simultaneously. Furthermore, the consolidation of expenditure activity allows for a singular spending “rewards” program related to the available credit balance(s) and available cash balance(s), where reward points for all of the varied activity by the end user accumulate under one umbrella.

The present invention is described by way of the summary, description and examples presented herein, but is not limited to the specific description, but includes all alternative potential variations of the invention that can be made available to end-users as would be apparent to those skilled in the art.

What is claimed is:

1. A method for providing an end user free or reduced fee financial account services in exchange for fee based account interchange activity conducted, comprising
a. providing using a transaction processor a free or reduced fee financial account services for at least one financial account to said end user when said end user performs a specified amount or total number of fee based inter account financial transactions within a specified period using at least one available credit or available cash balance.

2. A system for managing at least two financial accounts, comprising:
a. a system component for providing at least two financial accounts comprising at least two available account balances that can be accessed for at least one debit for at least one financial transaction using at least one transaction processor; and
b. a system component for accessing at least one said financial accounts to provide selected or modified transaction parameters or account maintenance functions related to at least one of the available account balances of said at least two financial accounts,
wherein said file maintenance functions enable readjustment or revision with regard to how said given transaction is debited among said at least two available account balances on a post real-time basis after a transaction is posted or otherwise consummated, either by readjusting global parameters, by revising actual amounts, or by specifying an amount to be readjusted, where said readjustment comprises a full or partial amount of said given transaction, wherein said readjustment or revision is made using preset thresholds, ratios, or amounts in at least one of said accounts.

3. A system of claim 2, wherein said transaction parameter can be modified by the end user in a real time basis.

4. A system of claim 2, wherein said transaction parameter can be modified by the end user after the transaction has occurred or posted.

5. A system according to claim 4, wherein said transaction parameter is a time period or a later billing cycle.

6. A method for readjustment or revision of the allocation of available balances to cover at least one transaction debited from at least one first financial account, after said debited transaction is posted or otherwise consummated, comprising
a. accessing said at least one first financial account from which said transaction was debited; and
b. readjusting or revising said allocation of available balances to cover said debited transaction using at least one preset parameter or at least one other parameter relating said at least one first financial account to at least one other available account balance from at least one other second financial account by at least one step selected from
c. readjusting at least one parameter relating the amounts in at least one of said first and second financial accounts to cover said debited transaction amount;
d. revising at least one of said actual amounts in at least one of said first and second financial accounts to cover said debited transaction amount; or
e. specifying at least one amount in at least one of said at least one first and second financial accounts to be readjusted to cover said debited transaction amount;
wherein said readjustment or revision comprises at least a partial amount of said transaction debited from said first available financial account.

7. A method of claim 6, wherein said given transaction debiting an initial available credit balance readjusts to debit at least one available cash balance, and/or at least one additional available credit balance, thereby crediting or restoring said initial available credit balance.

8. A method of claim 6, wherein said given transaction debiting an initial available cash balance readjusts to debit at least one available credit balance, and/or at least one additional available cash balance, thereby crediting or restoring said initial available cash balance, whereby said readjustment to said initial available cash balance offers an unexpected result and benefit for the issuer of the global account by increasing the risk of default for said global account by the end user, thus enabling said issuer to justify and charge higher fees.

9. A method for authorizing at least one debit for at least one financial transaction using at least one transaction parameter for relating the debit amount of said debit to the relative account balances in at least two financial accounts, comprising:
a. providing at least two financial accounts comprising at least one available account balance that can be accessed for said debit for said at least one financial transaction; and
b. authorizing said debit amount for said at least one financial transaction from said at least one of said account balances based on at least one of said transaction parameters relating said debit amount to the amounts or ratios of each of said account balances in at least two of said available account balances.

10. A method according to claim 9, wherein said transaction parameter is selected from at least one of a ratio, an amount threshold, a remainder threshold, a minimum available account balance, a maximum available account balance, a minimum debit amount, a range of debit amounts, or a maximum debit amount.

11. A method according to claim 9, wherein said debit for said financial transaction based on said at least one transaction parameter is based on at least one selected from:
a. the total of said at least two available account balances is greater than or equal to said debit amount;
b. at least one selected available account balance is greater than or equal to said assigned portion of said debit amount corresponding to said at least one selected available account balance; or
c. at least one selected available account balance, as determined by said transaction processor, that is able to compensate for a deficiency in at least one other selected available account balance that is less than the assigned portion of said debit amount corresponding to said at least one selected available account balance, where said assigned portion is determined by said transaction processor.
